(19) United States
(12) Patent Application Publication
(10) Pub. No.: US 2021/0199096 A1
(43) Pub. Date: Jul. 1, 2021

(54) World Gravity Motor (WGM)

(71) Applicant: Wisam Khalid Ibrahim, Fethiye (TR)

(72) Inventor: Wisam Khalid Ibrahim, Fethiye (TR)

(21) Appl. No.: 16/732,315

(22) Filed: Jan. 1, 2020

(51) Int. Cl. F03G 3/00; H02K 7/075

(52) U.S. Cl. CPC F03G 3/00; H02K 7/075

(57) ABSTRACT

A gravity motor that has the ability to generate a mechanical power from gravitational force, and maintains any level of generated mechanical power. And generates mechanical power that when connected to electric generator it produces electricity. And it has the ability to maintain any level of generated electrical power. It generates large mechanical power for when connecting the output gear to a larger gear it will provide more larger amount of torque by gravity. It generates the required speed because the gravitational acceleration will increase the generated speed to the required limit. It also maintains any required speed because the speed controller will control the generated speed. It has the ability to remove air friction by two circular shape covers which can fit on each other for the rotor part. It controls the gravity effect on part of the circular motion path because it uses the new law in physics.

### § BACKGROUND OF THE INVENTION

The need for electricity is increasing significantly in the world and the cost to produce electricity is very high, some countries use atomic energy or water dam to produce electricity and they are spending a lot of money for that and some are using coal thermo energy which makes a pollution, some are trying to use solar cells to produce electricity and some are using air wind to produce electricity. Yet it cannot cover the level of demand for power needed.

Therefore, the demand to produce electricity is increasing very high and the world will reach to a point that all resources now used to generate electricity including oil will not be enough, so this is a huge problem that will face all people on earth.

### § BRIEF SUMMARY OF THE INVENTION

A new invention that uses gravity force to produce a continuous rotational force which can be used to generate a renewable energy. By using several masses positioned on a several rotating arms with equal radius for each mass from the center of circular motion. Each mass fixed on rotor arm that rotates in a circular motion, then dividing that circular motion of the mass into two halves to make unbalanced gravity system. The first half contains gravity force which will make the mass to fall down in a circular motion, and the other half of the circular motion does not contain gravity force by using magnets and levers which will remove the gravity force effect on the second half of circular motion, which will return the mass back to the upper position at the start of circular motion. And the process will repeat itself automatically as long as there is gravity force.

### § BREIF DESCRIPTION OF THE SEVERAL VIEWS OF THE DRAWINGS

FIG. (1) shows how the gravity force effect on a mass in a circular motion.

FIG. (2) shows the Torque generated by the mass in a circular motion.

FIG. (3) shows the lift force needed to return back the mass to upper position.

FIG. (4) shows the use of two equal masses to make the system balanced.

FIG. (5) shows how to decrease the distance between mass and center, to use Levers.

FIG. (6) shows at the start, how the gravity force balanced on all masses.

FIG. (7) shows the unbalanced gravity system.

FIG. (8) shows the method used to remove the gravity from the right side.

FIG. (9) explain the use of Levers and the amount of force needed to remove the gravity effect.

FIG. (10) shows the details after rotation by angle theta.

FIG. (11) explain the magnets combination.

FIG. (12) shows the summation of magnetic forces and the amount of summation.

FIG. (13) shows the amount of tangential magnetic force needed to remove the gravity and the details of magnetic calculations.

FIG. (14) explain the tangential forces affecting on the right-side mass.

FIG. (15) shows the design of stator magnets with variable number of turns.

FIG. (16) shows the design of stator magnets with variable current.

FIG. (17) shows the design of rotor magnets with variable current.

FIG. (18) shows the rotor parts and stator parts.

FIG. (19) shows the rotor magnet and stator magnet forces during rotation.

FIG. (20) shows the inner stator nodes and lines of power used to supply rotor magnet and stator magnet with power.

FIG. (21) shows how the rotor magnet gets power, and how the stator magnets coil (start/end) connected to the nodes that has no power.

FIG. (22) shows the wire connection for stator magnets coils (Start/End) and the inner nodes.

FIG. (23) explains more details for stator magnets coil connection with inner stator nodes.

FIG. (24) shows how the stator magnets supplied by electricity and polarity during the motion.

FIG. (25) shows wire connection for stator magnet.

FIG. (26) shows more details for brush connection.

FIG. (27) shows the electric connection for rotor magnet.

FIG. (28) shows the details of rotor brushes.

FIG. (29) shows more details for rotor parts.

FIG. (30) shows the mass added to arms, and also it shows the arm from top view.

FIG. (31) shows the World Gravity Motor front view

FIG. (32) shows the World Gravity Motor with 12 arms of mass.

FIG. (33) shows the WGM connected to Electric generator with a starter switch selector.

FIG. (34) shows the block diagram for (Input/Output) power.

FIG. (35) explain the (Physical location/Theoretical location) of MASS.

FIG. (36) shows how to remove air friction.

FIG. (37) shows the design for brushless motor based on permanent rotor magnet.

FIG. (38) shows more details for brushless motor based on permanent magnet

FIG. (39) shows special electronic circuit for brushless motor based on permanent magnet.

FIG. (40) shows the design for brushless motor based on electric rotor magnet.

FIG. (41) shows the design for increasing the generated torque.

FIG. (42) shows the gears and gear belts used to increase the output torque.

FIG. (43) shows the Mass motion along the arm (toward the center)

FIG. (44) shows the Mass motion along the arm (outward from center)

FIG. (45) shows the Controlling mass motion along the arm

FIG. (46) shows the Controlling all masses motion using one motor

FIG. (47) shows the Controlling mass motion along the arm

FIG. (48) shows the Force and Torque calculations

FIG. (49) shows the Total tangential force for any two points intersects with one vertical line

FIG. (50) shows the Placing of (mass rotating disk) on (magnets rotating disk)

FIG. (51) shows the Rotor magnet (width/depth/height)

FIG. (52) shows the Mass/Screws

FIG. (53) shows the Equivalent magnets

FIG. (54) shows the Equivalent electric circuit

FIG. (55) shows one-dimensional array and two-dimensional array of WGM.

FIG. (56) shows three-dimensional array of WGM.

FIG. (57) explain the new law in physics.

FIG. (58) explain the new theory in physics “Theoretical Equivalence Theory”.

### § DETAILED DESCRIPTION OF THE INVENTION

To generate electricity, it is important to have a continuous force in order to rotate the electric generator armature continuously to get a stable and reliable electricity.

There are several types of energy used to generate a rotational force like (Atomic energy, coal thermal energy, waterfalls, air wind, rivers, dams, etc. . . . ).

All of these forces are costing a lot of money, and some of them are not reliable forces. And cannot be used continuously.

Hence the gravity force can be a good solution to generate a continuous rotational force.

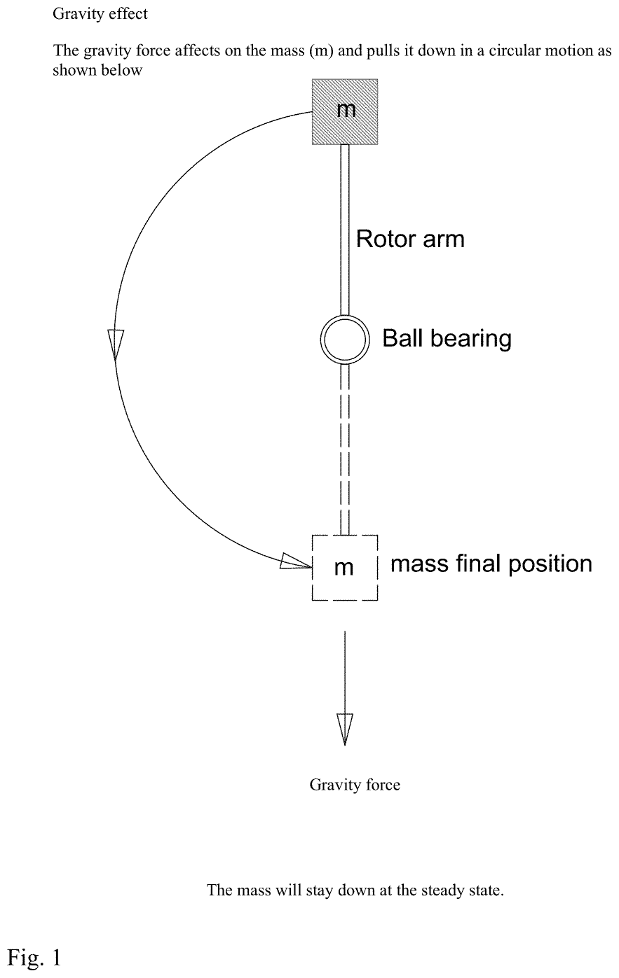

As shown in FIG. 1 If a mass is connected to one end of a rotor arm and a fixed position ball bearing connected to the other end of the rotor arm, the generated force on the mass will rotate the mass in a circular motion, to the lower position.

So, we can use the Torque generated by the gravity force (Fg) and the mass (m) with radius (r)

Fg=mg (1)

Torque=rFg

T=rmg (2)

Where:

g: 9.8

m: mass

Fg: Gravity Force

T: Torque

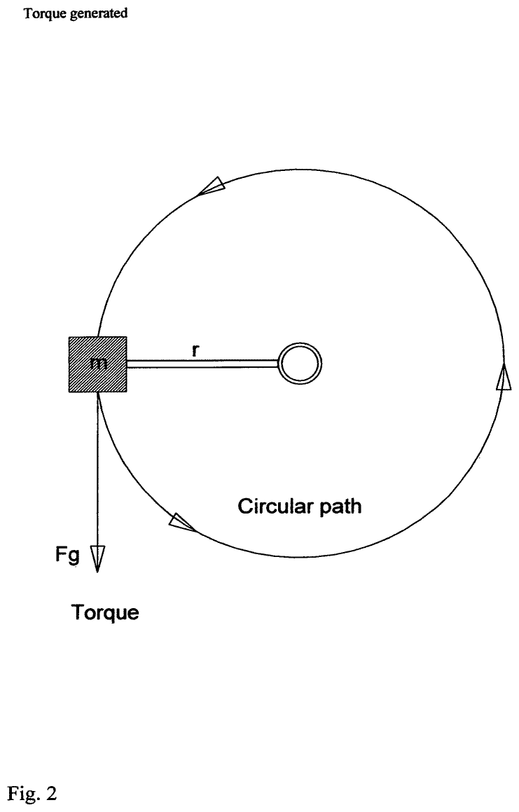

As shown in FIG. 2

the scientific question is how to lift the mass back again to the top position to complete the circular motion without loose of power? Or how to lift the mass back again to the top position using less force against the larger gravity force?

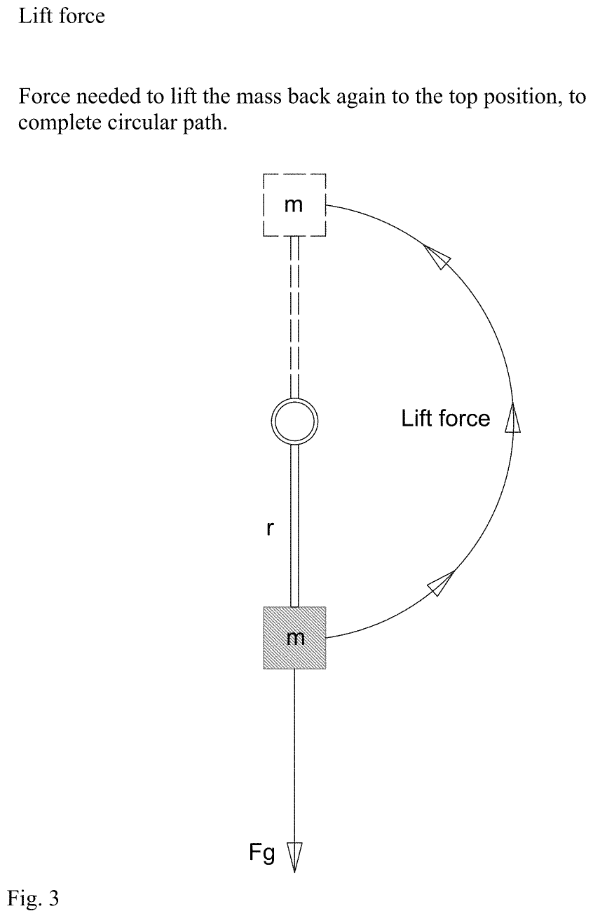

As shown in FIG. 3

The lift force must be equal or greater than gravity force, then in that case only the mass will complete the circular motion and it will return back to the upper position. Neglecting friction force.

But since we have to use less input force than gravity force, therefore it is important to introduce a new law in physics.

The New Law:

“In a field of force affecting on a mass fixed on rotor arm generating a torque, it is possible to change the position of the mass or part of that mass (theoretically) by changing the torque”.

There are 20 steps to generate a continuous force by gravity.

Step 01: (Dividing mass)—page 6

Step 02: (Preparing levers)—page 7

Step 03: (Removing gravity)—page 8

Step 04: (Levers calculations)—page 9

Step 05: (Magnetic force combination)—page 11

Step 06: (Stator magnet—number of coil turns)—page 22

Step 07: (Torque and Acceleration and Speed calculations)—page 24

Step 08: (Inner stator nodes design)—page 42

Step 09: (Inner stator nodes radius—mass radius—rotor arm radius)—page 47

Step 10: (More designs)—page 49

Step 11: (Generating electricity and renewable energy)—page 52

Step 12: (For the block diagram for (input/output) power)—page 53

Step 13: (Physical location/Theoretical location) of MASS—page 54

Step 14: (Removing air friction)—page 56

Step 15: (More calculations)—page 57

Step 16: (Controlling mass motion along the arm)—Page 65

Step 17: (Brushless system)—page 68

Step 18: (Gain and Power calculations)—page 70

Step 19: (Increasing the generated Torque)—page 79

Step 20: (WGM Array)—page 80

Step 01: (Dividing Mass)

Using two equal masses (m) on both rotor arms to balance the gravity force on both sides.

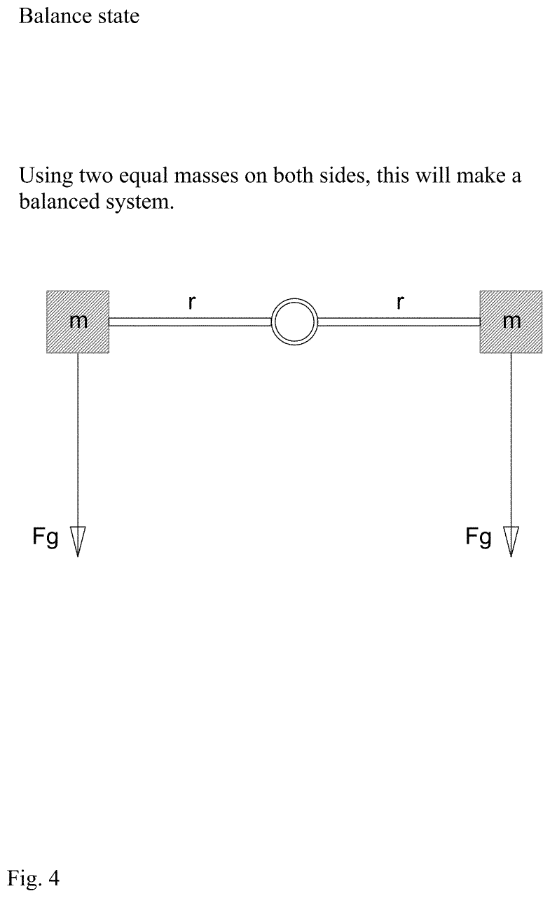

As shown in FIG. 4

Step 02: (Preparing Levers)

Decreasing the distance between Mass and Center of rotation to prepare the use of rotating arms as Levers.

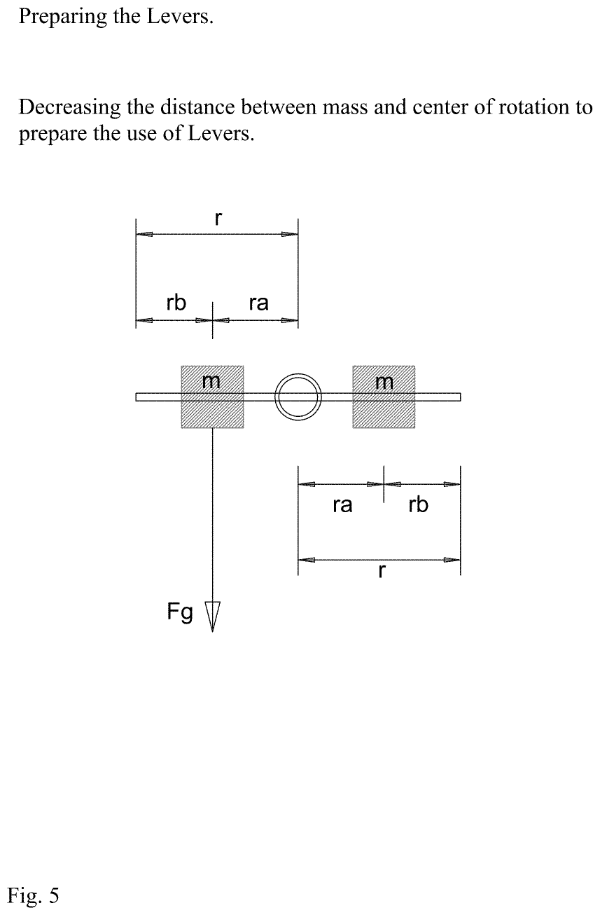

As shown in FIG. 5

It is also possible to use Even number or Odd number of rotor arms, for now we will use Even number of rotor arms with masses fixed on rotor arms and together will rotate as one part. And the gravity motor must be mounted vertically to use the (field of gravity force).

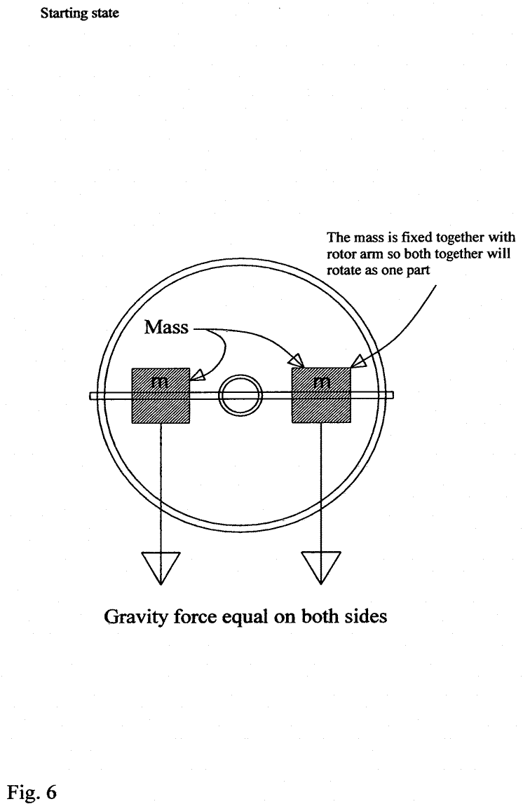

As shown in FIG. 6

Step 03: (Removing Gravity)

Removing the gravity from one side of the circular motion, assuming the circular motion in counter clockwise direction, so we will remove the gravity force from the right side, this is the side that the mass return back again to the upper position and it will complete the circular motion. Removing gravity from one side will make unbalanced gravity system which will keep the rotor arms to rotate and to accelerate in a continuous circular motion.

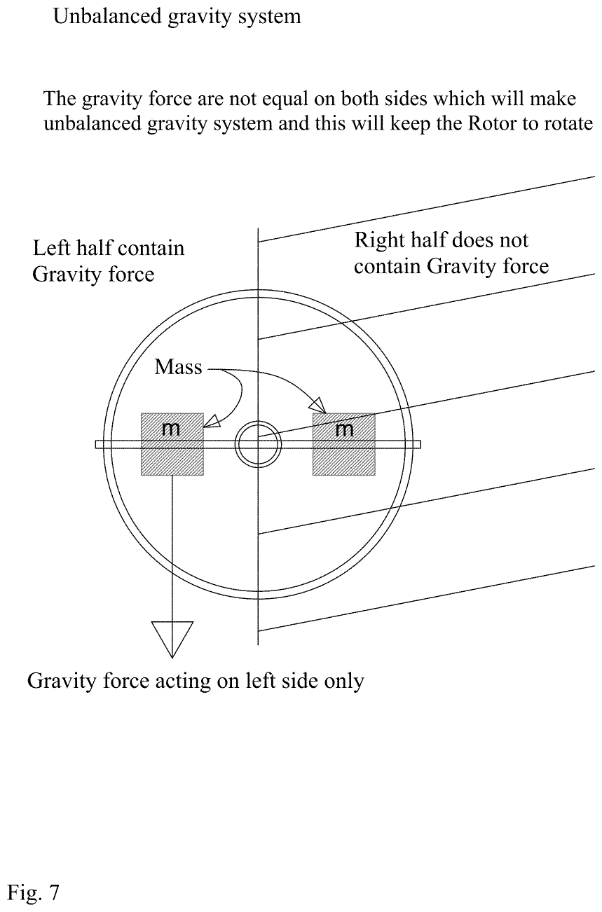

As shown in FIG. 7

To remove gravity force from the right side, it is important to use the new law in physics, this new law will help to shift the position of the mass on the right side to the center of circular motion. Which will remove the gravity effect by changing the torque generated by the field of gravity force on the right side.

So, to change the torque on the right side there must be a force against gravity force equal in magnitude and reverse in direction, and the magnetic force can be used for that with the help of (Levers) where Levers will come in the next step.

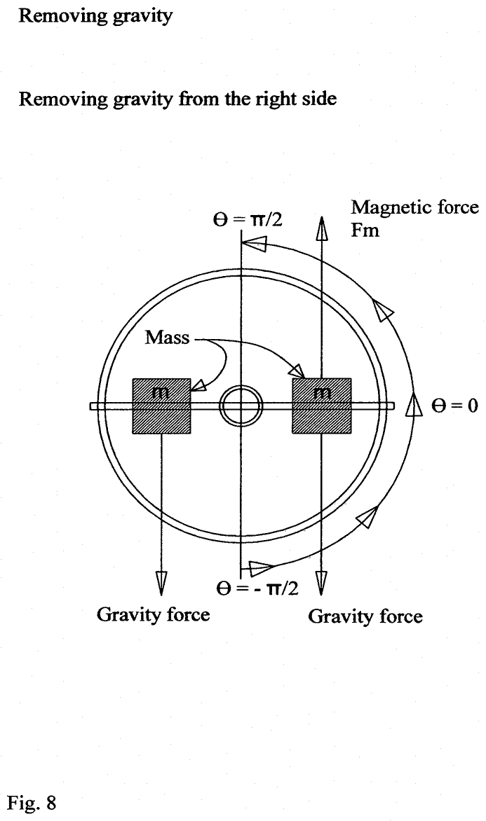

As shown in FIG. 8

Where the left half of circular motion contain gravity force to pull the mass down to lower position, and the right half of circular motion does not contain gravity force which will return the mass back again to the upper position and the circular motion will complete.

And in this case, it is important to note that the rotating force is the tangential force on the mass.

Fg=9.8m cos Θ (3)

### Where

Fg: Tangential gravity force acting on the mass.

m: mass fixed on rotor arm.

Θ: is the angle of rotation and its value from

$$( - \frac{π}{2} ) to ( + \frac{π}{2} )$$

on the right side

And the maximum value for the tangential gravity force is when 0=0, hence Cos(6)=1.

At this point it is important to calculate the forces acting on the right side only just to find the required force to remove the gravity effect.

Hence the magnetic force needed must be equal to gravity force but reverse in direction.

Fm=−Fg (4)

Where Fm is the magnetic force.

Step 04: (Levers Calculations)

To use the new law in physics, where it is important to shift the mass on the right-side to the center of circular motion, and to change the position of the mass (Theoretically) as explained by the new law in physics, therefore the torque must change, and the torque generated on the right-side is by gravitational force, so to change the position of the mass to the center of circular motion a torque that is just equal in magnitude but reverse in direction must be applied along the right-side of the circular motion, so using Levers on the right-side of circular motion to change the torque in order to change the mass position theoretically to the center of circular motion.

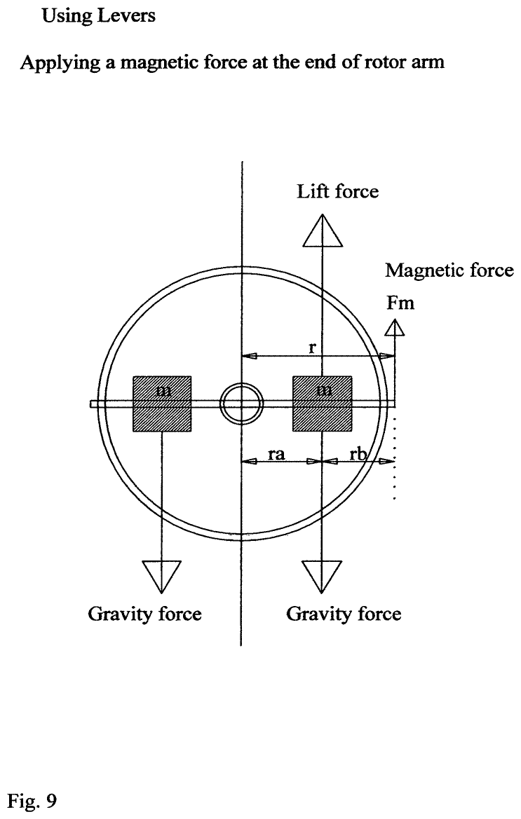

As shown in FIG. 9

Applying a force at the end of rotor arm from the right side of the circular motion, this force is a magnetic force (Fm) with a specific value that will generate a Torque equal to the Torque generated by Gravity force (Fg).

A lifting force (Fl) at the point (ra) is generated by the Magnetic force (Fm) which is equal to the Gravity force (Fg) but it has a reverse direction.

Now since the rotor arm radius (r)

r=ra+rb (5)

where (r) is the radius from the center of circular motion to the end of the magnet fixed at the end of rotor arm and it is denoted as “magnet radius” or “arm radius”, and (ra) is the radius from the center of circular motion to the center of the Mass (m) and it is denoted as “mass radius”, and (rb) is the remaining distance between center of the mass and the end of magnet radius.

Hence,

Torque of magnetic force=Torque of gravity force

$$r Fm = - ra Fg \\ Fm = - \frac{ra}{r} Fg \qquad ( 6 )$$

Torque of lifting force=Torque of magnetic force

$$ra Fl = r Fm \\ Fl = \frac{r}{ra} Fm \qquad ( 7 )$$

Therefore, Fl=−Fg

$$Fl = \frac{r}{ra} Fm = \frac{r}{ra} ( - \frac{ra}{r} Fg ) = - Fg \qquad ( 8 )$$

At this moment the rotor will start to rotate in a counter clockwise direction by angle (0), since there is a mass on the left side that will fall down in a circular motion due to gravity effect on the left side. This will keep the gravity force on the left side only. And it will generate a Torque.

Torque=(mass radius)×(Gravity force cos Θ) (9)

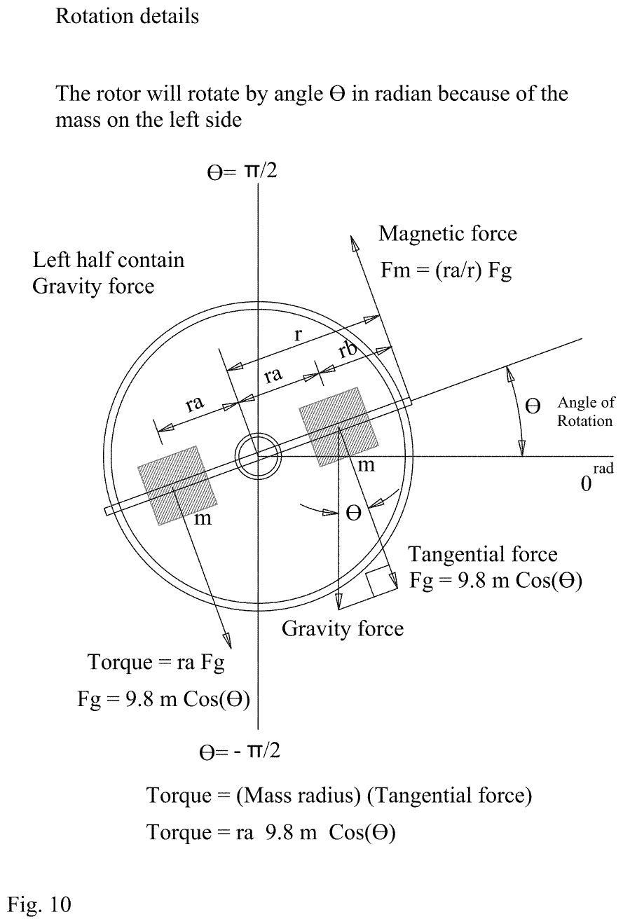

As shown in FIG. 10

Levers or (rotor arms) also can be removed and replaced with a disk on the rotor part, placed at the center of circular motion and it's radius is equal to the Lever arm length, that will provide the same work of Levers, and every mass fixed on the Lever arm can be fixed on the rotating disk and also the rotating magnets can be fixed at the end of the rotor disk (Circumference).

Step 05: (Magnetic Force Combination)

The magnetic force combination used on the right side consist from the rotor magnet and stator magnets together.

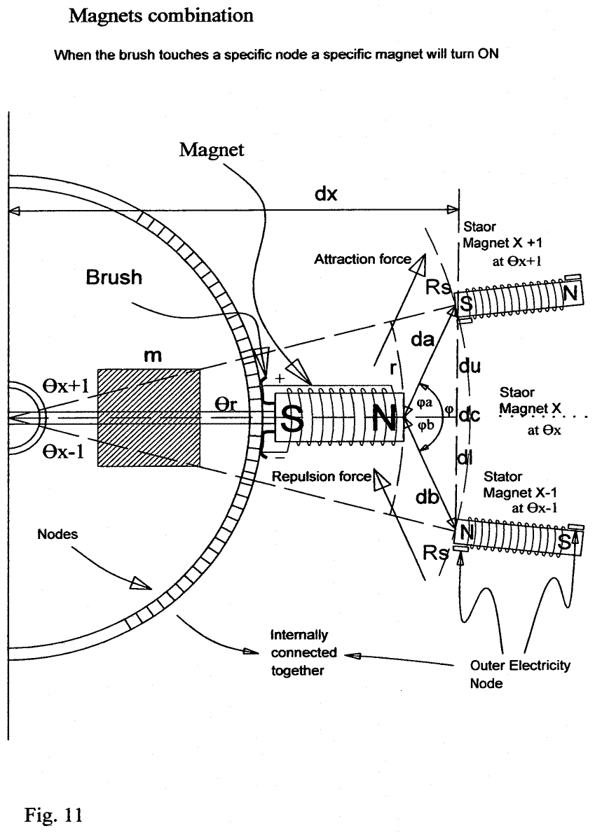

As shown in FIG. 11

A magnet is fixed at the end of every rotor arm, and the coil of that magnet is connected to brushes, the brushes are attached to stator inner electrical nodes or (not moving) electrical nodes which provides input power to rotor magnet and stator magnets as well.

The stator magnets (not moving) magnets and stator nodes and rotor part are described

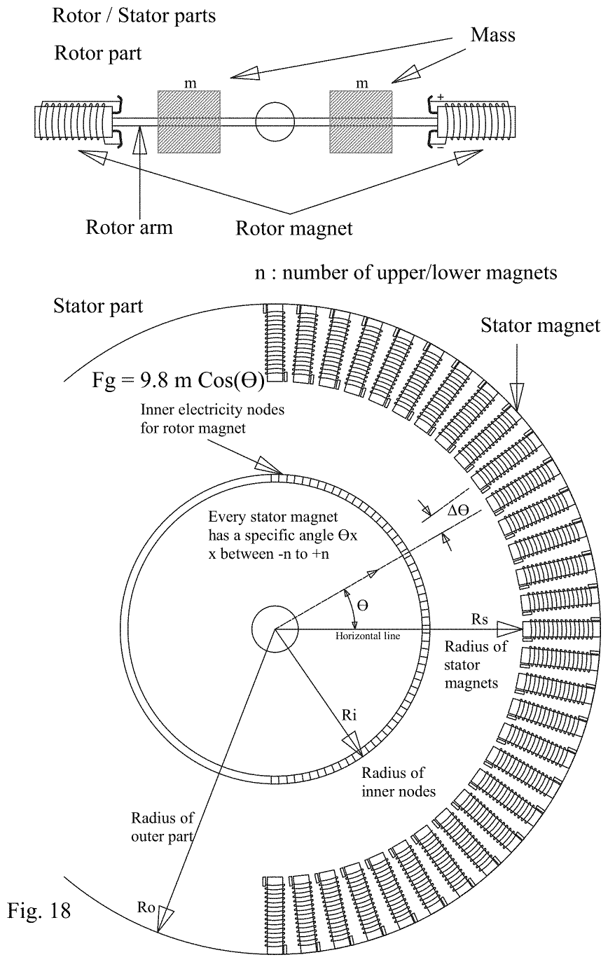

As shown in FIG. 18

Once the rotor magnet brush touches a specific inner node as in FIG. 11, this will turn ON a specific stator magnet, where the stator magnet and inner node are connected internally together. And since there is brushes for upper part and brushes for lower part, this will turn ON two stator magnets, the upper brushes will turn the upper stator magnet ON, and the lower brushes will turn the lower stator magnet ON, and the stator magnet which is in front of rotor magnet will stay OFF, because there is no brush for middle part to touch the front stator node.

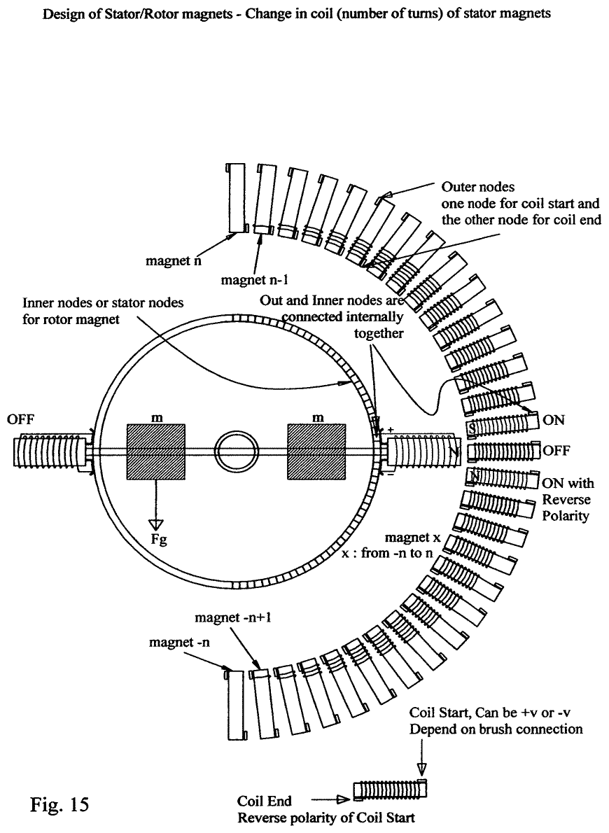

As shown in FIG. 15

Neglecting the gravity force affecting on rotor arm and rotor magnet, because there is another arm with another magnet on the left side that is just exactly equal to the one on the right side.

According to the new law in physics since we want to remove the gravity effect on the mass fixed on the right-side arm only therefore, we will calculate the force needed for that only.

The tangential magnetic force is calculated as below

As shown in FIG. 11

At given rotor arm angle (Θᵣₒₜₒᵣ=Θᵣ)

The stator magnet facing rotor magnet is (magnet ₓ), and its angle is (Θₓ), this magnet is OFF Every stator magnet has a specific angle (Θₓ) where x between (−n to +n), and (Θₓ) value between (−π/2 and +π/2) and (n) is the number of upper or lower stator magnets where total stator magnets is (2n+1), So the angle difference between every stator magnet is (ΔΘ)

As shown in FIG. 18

$$\begin{matrix}Δθ = ( range of {θ}_{x} ) / ( number of stator magnets - 1 ) & ( 10 ) \\ Δθ = \frac{\frac{π}{2} - ( - \frac{π}{2} )}{2 n} \\ Δθ = \frac{π}{2 n} & ( 11 )\end{matrix}$$

So, for example if there are 10 upper stator magnets, n=10

ΔΘ=π/(2*10)=π/20 (radian)

So, in degree ΔΘ=(180°/20)=9 (degree) between every stator magnet.

Now back to FIG. 11.

The upper stator magnet is (magnet ₓ₋₁), and its angle is Θₓ₊₁

Where

Θₓ₊₁=Θₓ+ΔΘ (12)

The lower stator magnet is (magnet ₓ₋₁), and its angle is Θₓ₋₁

Where

Θₓ₋₁=Θₓ−ΔΘ (13)

The angle of rotor magnet is (Θᵣ)

The angle difference between upper stator magnet and rotor magnet is (Θₓ₊₁−Θᵣ)

The angle difference between rotor magnet and lower stator magnet is (Θᵣ−Θₓ₋₁)

The angle from upper magnet to rotor magnet to lower magnet is Phi=φ

Therefore, the angle between upper stator magnet and rotor magnet is (φa).

The angle between rotor magnet and lower stator magnet is (φb).

Where φ=φa+φb

The distance between rotor magnet and upper stator magnet is (da).

The distance between rotor magnet and lower stator magnet is (db).

The upper distance between upper magnet and arm line is (du).

The lower distance between lower magnet and arm line is (dl).

The distance between length of line dx and length of rotor magnet radius r is dc=(dx−r)

After the rotor arm rotates, the distance along horizontal arm line dx will differ for upper distance and lower distance.

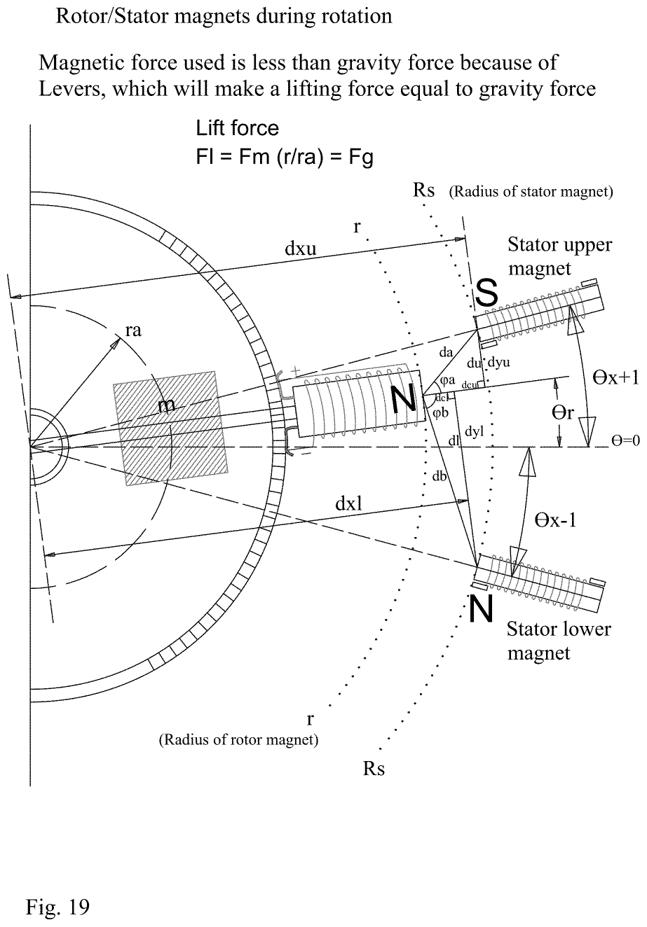

And as explained in FIG. 19

Assuming the arm line is the x-axis and the vertical perpendicular line on x-axis is the y-axis then the x-component distance from center of rotation to upper vertical line which starts from stator upper magnet and makes a perpendicular angle with arm line is

dxu: (dx upper)

the y-component distance from stator upper magnet to arm line

dyu: (dy upper)

The x-component distance from center of rotation to lower vertical line which starts from stator lower magnet to arm line which makes a perpendicular angle with arm line is

dxl: (dx lower) The y-component distance from stator lower magnet to arm line

dyl: (dy lower)

Hence,

Angle between upper stator magnet and rotor arm=(Θₓ₋₁−Θᵣ) (14)

Tan(Θₓ₊₁−Θᵣ)=dyu/dxu (15)

Angle between rotor arm and lower stator magnet=(Θᵣ−Θₓ₋₁) (16)

Tan(Θᵣ−Θₓ₋₁)=dyl/dxl (17)

Since Θₓ₊₁, Θₓ₋₁, r, Rs, are given therefore, for any Or

du=dyu

du=Rs sin(Θₓ₊₁−Θᵣ) (18)

Where Rs is the stator magnet radius (distance from center of rotation to stator magnet)

dl=dyl

dl=Rs sin(Θᵣ−Θₓ₋₁) (19)

The x-Component for upper side dxu

dxu=Rs cos(Θₓ₊₁−Θᵣ) (20)

The distance between dyu line and rotor magnet is dcu (dc upper)

dcu=dxu−r (21)

The x-Component for lower side dxl

dxl=Rs Cos(Θᵣ−Θₓ₋₁) (22)

The distance between dyl line and rotor magnet is dcl (dc lower)

dcl=dxl−r (23)

The distance from rotor magnet to upper stator magnet

da=\sqrt{dcu²+du²} (24)

The distance from rotor magnet to lower stator magnet

db=\sqrt{dcl2+dl²} (25)

Angle between rotor magnet and upper stator magnet=φₐ

Angle between rotor magnet and lower stator magnet=φ_{b}

Tan(φₐ)=du/dcu (26)

Tan(φ_{b})=dl/dcl (27)

Therefore,

$$\begin{matrix}{ϕ}_{a} = {tan}^{- 1} \frac{du}{dcu} & ( 28 ) \\ {ϕ}_{b} = {tan}^{- 1} \frac{dl}{dcl} & ( 29 )\end{matrix}$$

(φₐ & φ_{b}) are important to calculate tangential magnetic force.

φ=φa+φb (30)

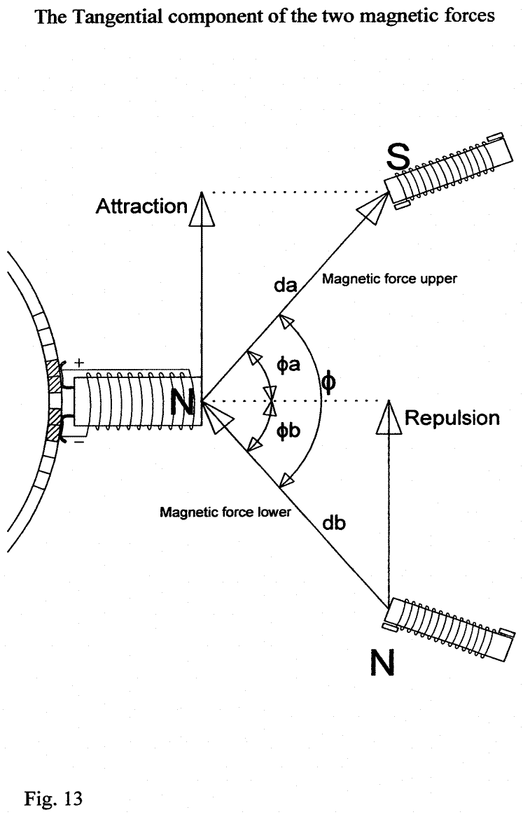

And as shown in FIG. 13.

The magnetic force is then equal to=Total tangential magnetic force on rotor magnet

Fm=Fm1+Fm2 (31)

### i.e. (Fm1 Attraction+Fm2 Repulsion)

Where,

Fm1 is the tangential magnetic attraction force between the rotor magnet and the upper stator magnet, it is in the upper direction.

Fm2 is the tangential magnetic repulsion force between the rotor magnet and the lower stator magnet, it is in the upper direction also.

So, the two forces are in one direction.

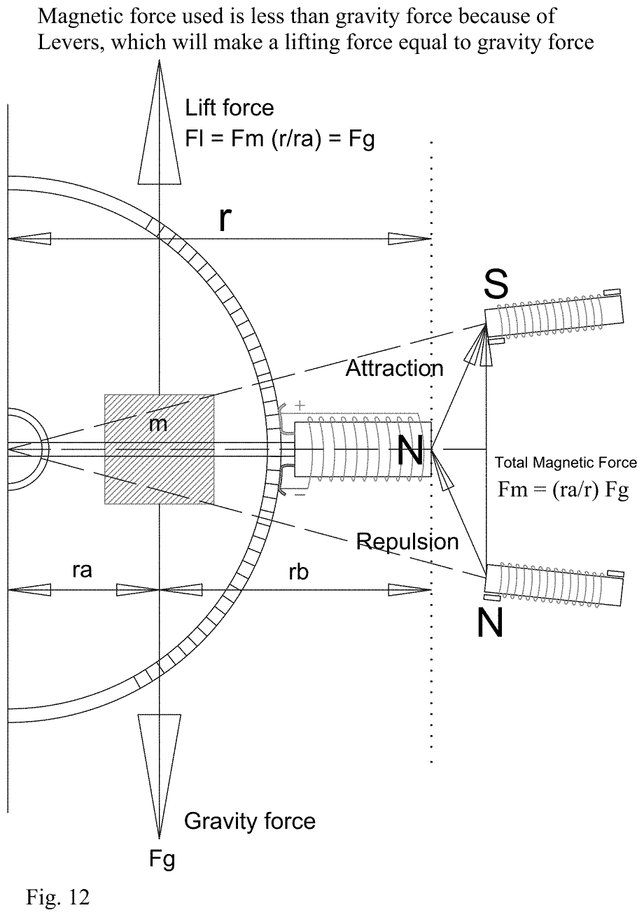

As shown in FIG. 12 & FIG. 13.

The magnetic force needed to lift the mass fixed on the rotor arm is less than the gravity force affecting on mass (Fg=−9.8 m Cos Θ), because the Levers will help to decrease the force needed and it will generate a lifting force (Fl) that is just equal to gravity force (Fg) but reverse in direction.

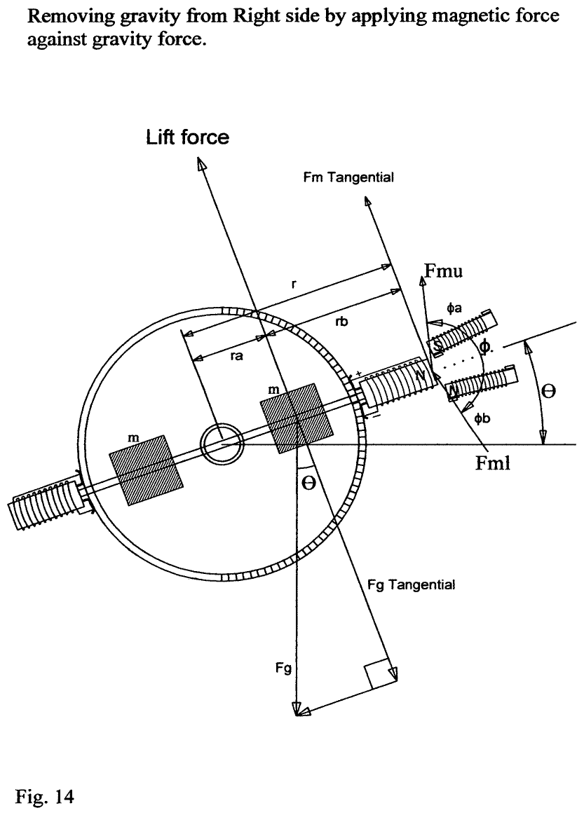

And for more details as shown in FIG. 13 and FIG. 14

For the attraction force and repulsion force each one has a tangential force component to the circular motion that will be added together to form the lifting force needed to remove the gravity effect.

Since the tangential gravity force is (Fg) from formula (3)

Fg=−9.8m cos Θ

And magnetic force=(Fm)

They must have the same Torque from formula (6)

$$r Fm = - ra Fg$$

$$Fm = - \frac{ra}{r} Fg$$

And since (Fg) is negative as shown above therefore (Fm) will be positive so we get

$$Fm = ( \frac{ra}{r} ) 9.8 m cos θ \qquad ( 32 )$$

Since (ra<r) then (Fm<Fg)

From the tangential magnetic force formula (31)

$$\begin{matrix}Fm = Fm 1 + Fm 2 \\ Fm 1 = \frac{( N rotor * S stator )}{{da}^{2}} sin {ϕ}_{a} & ( 33 ) \\ Fm 2 = \frac{( N rotor * N stator )}{{db}^{2}} sin {ϕ}_{b} & ( 34 ) \\ Fm = \frac{( N rotor * S stator )}{{da}^{2}} sin {ϕ}_{a} + \frac{( N rotor * N stator )}{{db}^{2}} sin {ϕ}_{b} & ( 35 )\end{matrix}$$

substitute (32) in (35) we get

$$( \frac{ra}{r} ) 9.8 m cos θ = \frac{( N rotor * S stator )}{{da}^{2}} sin {ϕ}_{a} + \frac{( N rotor * N stator )}{{db}^{2}} sin {ϕ}_{b}$$

Assume

m—Constant

ra—Constant

r—Constant

N rotor—Constant

N stator—Variable

S stator—Variable

Cos Θ—Variable

Rearrange the above formula we get

$$( \frac{ra}{r} ) 9.8 m cos θ = N rotor ( \frac{S stator}{{da}^{2}} sin {ϕ}_{a} + \frac{N stator}{{db}^{2}} sin {ϕ}_{b} )$$

So, as shown in FIG. 19

When φa=0, this will make da=Rs−r and sin pa=0

When φb=0 this will make db=Rs−r and sin pb=0

Now back to FIG. 11.

And since the minimum value for total Fm is when the rotor magnet in middle between two stator running magnets, for example when rotor arm and rotor magnet point at Θ=0, in this case φa=φb=φ/2, because φ=φa+φb

So, in this case suppose the rotor magnet is (N rotor) then the upper stator magnet is (S stator) to generate attraction force and the lower stator magnet is (N stator) to generate repulsion force are equal in magnitude (N stator=S stator).

now we can write for the next formulas (N stator) only to calculate the needed force in every stator magnet because (S stator) has the same magnitude where (N will turn to S) after arm rotation.

Also, in this case (da) will be equal to (db), da=db=d.

The above formula will be written as below

$$Input force = ( \frac{ra}{r} ) 9.8 m cos θ = N rotor ( \frac{S stator}{{d}^{2}} sin \frac{ϕ}{2} + \frac{N stator}{{d}^{2}} sin \frac{ϕ}{2} ) \qquad ( 36 )$$

Re arrange (S stator=N stator) we get

$$( \frac{ra}{r} ) 9.8 m cos θ = N rotor ( \frac{2 N stator}{{d}^{2}} sin \frac{ϕ}{2} )$$

If N rotor is constant then solve for (N stator) we get

$$N stator = ( \frac{9.8 m cos θ ra {d}^{2}}{2 N rotor r sin \frac{ϕ}{2}} )$$

At Θ=0 (Rotor arm in horizontal position)

Cos Θ=Cos 0=1

$$N stator = ( \frac{9.8 m ra {d}^{2}}{2 N rotor r sin \frac{ϕ}{2}} )$$

Each stator magnet is placed at specific angle (Θ) from the horizontal line to the center of circular motion to the stator magnet.

As shown in FIG. 18

But the angle difference between each stator magnet is the same=ΔΘ, so ΔΘ always given.

This means at Θ=0

The rotor arm and rotor magnet are at horizontal line. And it is affected by upper stator magnet and lower stator magnet but not affected by the horizontal stator magnet at (Θ=0) because it is turned OFF.

The upper stator magnet at angle=ΔΘ

The lower stator magnet at angle=−ΔΘ

At this point both upper and lower have the same magnetic strength.

So, the above formula can be written as below

$$( N stator ) or ( S stator ) = ( \frac{9.8 m cos θ ra {d}^{2}}{2 N rotor r sin \frac{ϕ}{2}} ) \qquad ( 37 )$$

The (cos Θ) factor is added to calculate the strength of every stator magnet along the right-side circular motion except for the stator magnet at horizontal position (because of sin

$$\frac{ϕ}{2}$$

is the tangential component for upper/lower magnetic force).

And since the stator magnets will have the maximum value at Θ=0 (horizontal stator magnet), because when the rotor arm will move in upward direction above horizontal position this will decrease the need of a strong stator magnet because the tangential force needed to make lift force will decrease.

As shown in FIG. 15, the number of turns change for every stator magnet.

But for the formula above (37) it will find the strength of the upper and lower stator magnets when the rotor arm and rotor magnet points at horizontal position (Θ=0) so in that case (cos 0=1) but still this will find only the strength for the stator upper magnet at (Θ=+ΔΘ) and stator lower magnet at (Θ=−ΔΘ) but not the stator magnet at horizontal position.

For stator magnet at Θ=0, then a factor which is (cos ΔΘ) is added to denominator.

$$( N stator ) or ( S stator ) = ( \frac{9.8 m cos ⊖ ra {d}^{2}}{2 N rotor r sin \frac{ϕ}{2} cos Δ ⊖} ) \qquad ( 38 )$$

Since Θ represent the rotor arm angle therefore, the denominator factor (Cos ΔΘ) is added to help calculate the stator magnet strength and (number of coil turns) at horizontal position because for example, if Y=A Cos(Θ), and suppose the value of A at Θ=0 is unknown, But the value of Y at Θ=ΔΘ is known and suppose it is equal to Y1, So Y1=A Cos(ΔΘ).

Hence A=Y1/Cos (ΔΘ) which is the maximum value of Y at Θ=0.

Therefore, if Θ=0 this means the rotor arm at horizontal position, but the magnets that is running now is the upper magnet at (Θ=ΔΘ) and the lower magnet at (Θ=−ΔΘ).

So, the stator magnet strength for example (S stator) at Θ=ΔΘ is equal to

$$( N stator ) or ( S stator ) = ( \frac{9.8 m cos Δ ⊖ ra {d}^{2}}{2 N rotor r sin \frac{ϕ}{2} cos Δ ⊖} )$$

$$( N stator ) or ( S stator ) = ( \frac{9.8 m ra {d}^{2}}{2 N rotor r sin \frac{ϕ}{2}} )$$

Therefore, the stator magnet strength at Θ=0 is equal to the formula (38) but with cos(Θ)=1

$$( N stator ) or ( S stator ) = ( \frac{9.8 m cos ⊖ ra {d}^{2}}{2 N rotor r sin \frac{ϕ}{2} cos Δ ⊖} ) \qquad$$

Hence,

For (Stator magnet x), the magnetic strength will be calculated as below

$$( N stator ) or ( S stator ) = ( \frac{g m cos ϰ Δ ⊖ ra {d}^{2}}{2 N rotor r sin \frac{ϕ}{2} cos Δ ⊖} ) \qquad ( 39 )$$

Where

g: gravitational acceleration

x=(−n to +n), and x values are (−n, −n+1, −n+2, . . . , −3, −2, −1, 0, 1, 2, 3, . . . , n−2, n−1, n) (to calculate the upper stator magnets strength which are the same strength for lower stator magnets)

n: is the number of upper stator magnets and also the number of lower stator magnets

So, total number of stator magnets=2n+1

2n for (upper and lower stator magnets)

+1 for (one horizontal stator magnet at Θ=0 where x=0 also)

this will cover the right-side circular motion with stator magnets form the angle between the range Θ=−π/2 to Θ=+π/2, with steps of ΔΘ for each stator magnet.

As written in formula (11)

ΔΘ=π/(2n)=η/(total number of stator magnets−1)

So, for example if the number of upper stator magnets=10, (n=10) then the number of lower stator magnets=10 also. And added another one stator magnet for horizontal at Θ=0

This will make the total number of stator magnets=10 (upper)+10 (lower)+1 (horizontal)=21

So, if n=10 then 2n+1=21 total number of stator magnets.

The difference angle between every stator magnet is ΔΘ=π/2n=π/20=0.15708 (radian) or ΔΘ=180/20=9 (degree) between every two stator magnets.

Therefore, x=(−n to +n)=(−10 to +10) and the strength of every stator magnet (x) can be calculated from formula (39) using ΔΘ in (radian)

$$( N stator ) or ( S stator ) = ( \frac{g m cos ϰ Δ ⊖ ra {d}^{2}}{2 N rotor r sin \frac{ϕ}{2} cos Δ ⊖} )$$

Also, if Rs=30 cm (Stator magnet radius) and r=29 cm (Rotor magnet radius) then to find (φ/2)

$${ϕ}_{a} = {tan}^{- 1} \frac{d }{d c u}$$

$$du = Rs sin ( {⊖}_{x + 1} - {⊖}_{r} )$$

$$dcu = dxu - r$$

$$dxu = Rs cos ( {⊖}_{x + 1} - {⊖}_{r} )$$

Re arrange we get

$${ϕ}_{a} = {tan}^{- 1} \frac{Rs sin ( {⊖}_{x + 1} - {⊖}_{r} )}{Rs cos ( {⊖}_{x + 1} - {⊖}_{r} ) - r}$$

To find (φ/2) at Θ=0 (horizontal arm state where Θᵣ=Θₓ) this makes φa=φ/2 and (Θₓ₊₁−Θᵣ)=ΔΘ where x=0.

$$\frac{ϕ}{2} = {tan}^{- 1} \frac{R s sin ( Δ ⊖ )}{R s cos ( Δ ⊖ ) - r} \qquad ( 40 )$$

φ/2=1.437 (rad)

φ/2=82.346 (deg)

$$\frac{ϕ}{2} = {tan}^{- 1} \frac{R s sin ( Δ ⊖ )}{R s cos ( Δ ⊖ ) - r}$$

if r≈Rs then

$$\frac{ϕ}{2} \approx {tan}^{- 1} \frac{R s sin ( Δ ⊖ )}{R s cos ( Δ ⊖ ) - Rs} \\ \frac{ϕ}{2} \approx {tan}^{- 1} \frac{Rs sin ( Δ ⊖ )}{Rs ( cos ( Δ ⊖ ) - 1 )} \\ \frac{ϕ}{2} \approx {tan}^{- 1} \frac{sin ( Δ ⊖ )}{cos ( Δ ⊖ ) - 1} \qquad ( 41 )$$

If (φ/2) has a negative value this means the angle value is (φ/2)°+180 or (φ/2)^{rad}+π

Step 06: (Stator Magnet—Number of Coil Turns)

And since the magnetic strength measured in Weber.

Therefore, the magnetic strength (S or N) can be calculated from the below formula

Magnetic field strength=Number of turns*Current=Flux*Reluctance

B=Φ/A

B=μH

μ=μₒμᵣ

H=nI

Where

B: Flux density

H: Field strength

μₒ: absolute permeability

μᵣ: relative permeability

μ: permeability

n: Number of turns (measured in Turn)

I: Current (measured in Ampere)

Φ: Flux (measured in Weber)

Therefore, the number of turns can be calculated form the below formula

$$n = \frac{Φ}{μoμ r IA} \qquad ( 42 )$$

since Φ=(N or S) as flux

substitute formula (39) in (42) we et

$${n}_{x} = \frac{( \frac{ g m cos x Δ ⊖ ra {d}^{2}}{2 N rotor r sin \frac{ϕ}{2} cos Δ ⊖} )}{μoμ r I A} \qquad ( 43 )$$

And ΔΘ=π/(2*number of stator upper magnets)=π/(total number of stators magnets−1)

Therefore, the number of turns (n) for each stator magnet (x) is (nₓ)

where x=−(number of lower magnets) to +(number of upper magnets) (including zero)

here we can write x=−(lm) to +(um), including zero

lm: number of lower magnets

um: number of upper magnets

I: Current of stator magnet

A: Area of cross section for stator magnet

μ: Permeability of stator magnet core=μo μr

x: from (−Im to +um) including zero

r: Rotor radius to the end of rotor magnet.

For every stator magnet there is different number of coil turns.

The number will reach to its maximum value at horizontal stator magnet, where Θ=0.

And it will reach to its minimum value at vertical stator magnets (upper/lower).

As shown in FIG. 15

This will cover the force needed to generate the lifting force to remove gravity effect on the right side, and to allow the left side to fall free in circular motion.

Stator magnets are connected internally with electric nodes of rotor magnet, for when the rotor magnet brush touches a node then the rotor magnet will get electricity from that node as well as the stator magnet which is connected to that node internally so it will turn ON.

Step 07: Torque and Acceleration and Speed Calculation

Up to this point, the mass on the right side has no gravity because it has been shifted theoretically to the center of circular motion by changing the torque on the right-side.

This will give the mass on the left side the ability to free fall in a circular motion and to generate a Torque equal to the tangential gravity force multiplied by radius of circular motion of the mass.

Torque generated=ramg cos Θ (44)

Where

Θ: is the angle of rotor arm on the left side.

ra: is the radius of mass circular motion.

m: is the mass on the left side arm.

This Torque and the increasing speed of rotation (because of free fall in circular motion) can be used to rotate electric generator with the required speed needed to generate electricity.

And since the input force is less than the generated output force because of (Levers), then it is possible to have a renewable energy by the use of the (new law in physics) and with the help of (gravity force and Levers and magnetic force) these factors are very important to maintain the output power.

So, if the mass on the left side enters the right-side at the bottom position it will lose the gravity force and at the same time the mass that will reach the left-side at the top position will start a circular free fall continuing the previous mass acceleration because of momentum, hence the torque generated for free fall on the left side for (z) arms will be

$$Generated Torque = {\sum }_{ϰ = 1}^{ϰ = z / 2} ( mass radius ) {( Total Force on one mass )}_{ϰ} \qquad ( 45 )$$

Because the number of left-side arms equal to the number of right-side arms and since it is needed to calculate the torque on the left-side arms only, then the number of left-side arms=z/2.

Where z=total number of rotor arms.

But as for mass fixed on arms it can fill the circular path

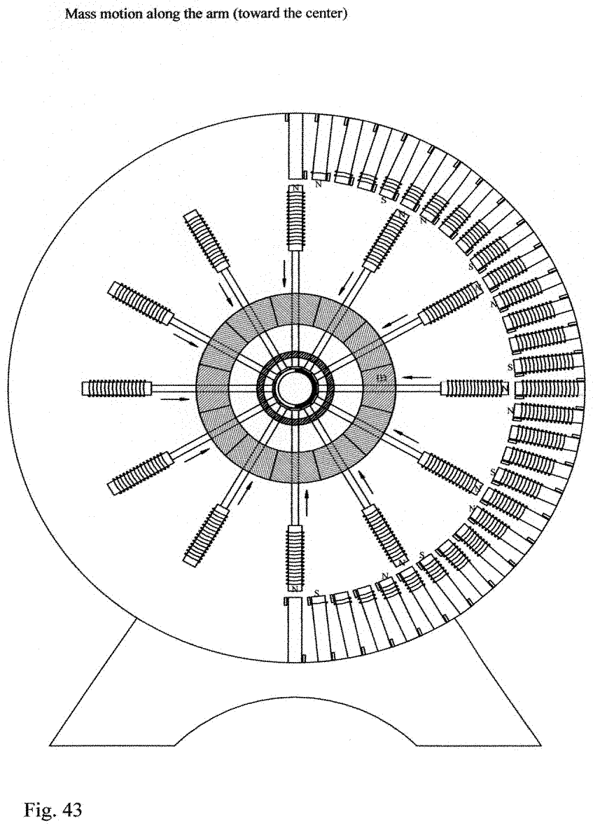

as shown in FIG. 43

Therefore, the total calculation will depend on the left-side circular path because right-side has no effect. So, to calculate the total force it is important to take small slice of mass on the left-side and then calculating the integral over the left-side circular path.

going to FIG. 48

the available facts as below

M: Total mass on left side

dm: small amount of M

S: total length on left side, where S=ra dΘ

ds: small length of S, where dS=ra dΘ

θ: angle for ds, where

$$( \frac{π}{2} \leq ⊖ \leq 3 \frac{π}{2} )$$

F: Total force on left side

dF: small amount of F, where dF=dm g cos Θ

T: Total torque on left side

dT: small amount of T, where dT=ra dF

Converting dm in terms of dΘ therefore it is important to add the following formula.

$$\frac{dm}{M} = \frac{d s}{S}$$

And since

ds=radΘ

and

S=raπ

### So

$$d m = M \frac{d s}{S} = M \frac{rad θ}{ra π} = \frac{M}{π} d θ$$

Therefore, the tangential force (dF) for angle Θ of small mass (dm) is

$$dF = dm g cos θ \\ dF = ( \frac{M}{π} d θ ) g cos θ \\ dF = ( \frac{M g}{π} ) cos θ d θ \qquad ( 46 )$$

Small amount of Torque=dT

$$\begin{matrix}dT = radF & ( 47 ) \\ T = \int dT \\ T = {\int }_{θ = π / 2}^{θ = 3 π / 2} radF & ( 48 ) \\ Generated Torque = {\int }_{π / 2}^{3 π / 2} ra ( \frac{Mg}{π} ) cos θ d θ \\ Generated Torque = ra ( \frac{Mg}{π} ) {\int }_{π / 2}^{3 π / 2} cos θ d θ \\ Generated Torque = {ra ( \frac{Mg}{π} ) [ sin θ ]}_{\frac{π}{2}}^{\frac{3 π}{2}} \\ Generated Torque = ra ( \frac{Mg}{π} ) [ ( - 1 ) - ( + 1 ) ] \\ Generated Torque = ra ( \frac{Mg}{π} ) [ - 2 ] \\ Generated Torque = raM ( \frac{- 2}{π} ) g & \end{matrix}$$

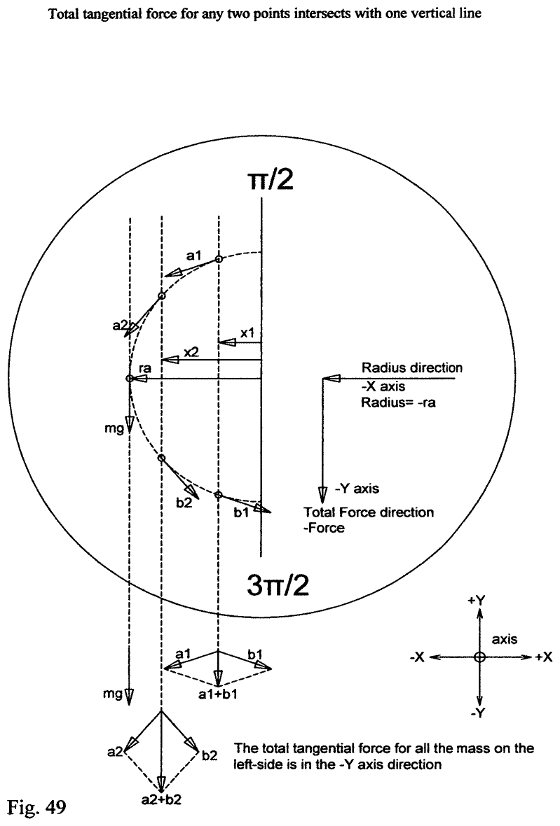

The negative sign is because the total tangential force direction on the left-side is in the (−Y axis) direction as shown in FIG. 49.

And since the radius is perpendicular to the force direction as stated by the Torque definition in physics therefore the direction of radius is in the (−X axis) direction, which makes its value (−ra) So, the Torque formula will be

$$Generated Torque = - raM ( \frac{- 2}{π} ) g \\ Generated Torque = raM ( \frac{2}{π} ) g \qquad ( 49 )$$

Where (2/η)=(0.63661977)

And since the number (1977) above is my date of birth.

So, taking the numbers above up to my date of birth then the final formula to calculate the Generated Torque for any (World Gravity Motor) or “WGM” will be.

Generated Torque=ra(0.6366)gM (50)

The total generated force in (−Y axis) is (F=T/ra)

Generated Force=−(0.6366)gM (51)

So, the linear acceleration for the circular motion due to gravity force is as below

a=−0.6366g (52)

And since on earth surface (g=9.8) or for more accurate (g=9.80665) therefore the linear acceleration for system free of load (without generator connected) having circular motion is

a=−6.24

This number “a=6.24” from now on it will be a new constant in physics, and it represents the acceleration of a free fall body in a circular motion due to earth gravity.

and I will call it “Gravitational acceleration in Circular path” or “Gravitational Circular” or “g_{c}” so, on earth

$$Gravitational acceleration in a Circular path = 6.24 \frac{meter}{{second}^{2}} \qquad ( 53 )$$

The gravitational acceleration in a circular path for any field of acceleration will be

$${g}_{c} = \frac{2}{π} g \qquad ( 54 )$$

Note that this acceleration for one arm having one mass starting rotation from the top position to the bottom position.

Where

g: gravitational acceleration (for any planet or any field of acceleration)

$$earth {g}_{c} = 6.24 \frac{meter}{{second}^{2}}$$

Therefore, the angular acceleration (a) for system free of load will be

$$\begin{matrix}{α}_{c} = \frac{{g}_{c}}{ra} & ( 55 ) \\ α = \frac{6.24}{ra} & \end{matrix}$$

Where:

α: angular acceleration for circular motion

g_{c}: linear acceleration for circular motion

ra: radius of circular motion

Now for the WGM acceleration and speed calculation:

Since the WGM motor has 2 sides (Left and Right) each side have a mass fixed on rotor arm, then there is total mass on the left (M-left) and total mass on the right (M-right), then it is important to calculate the inertia for all system in order to find the acceleration of the motor.

The torque generated on the left side due to gravity force is

Torque=radius*force

Torque=radius*(mass on left side)*(gravitaional acceleration in circular path)

Torque=ra*M_{left}*g_{c}

The torque also equals to

Torque=(Angular acceleration)*(Total Inertia)

Therefore, we can find the angular acceleration as below

$$∴ ( Angular acceleration ) = \frac{Torque}{Total Intertia} \\ ( Angular acceleration ) = \frac{ra * {M}_{left} * {g}_{c}}{( {M}_{left} + {M}_{right} ) {ra}^{2}} \\ α = \frac{{M}_{left}}{{M}_{left} + {M}_{right}} {α}_{c} \qquad ( 55. a )$$

Therefore, the linear acceleration for WGM will be

$$a = \frac{{M}_{left}}{{M}_{left} + {M}_{right}} {g}_{c} \qquad ( 55. b )$$

Since (M_{left}=M_{right}) then

Angular acceleration for WGM having equal mass on both sides and free of load

Angular acceleration=½α_{c}

α_{wgm}=½α_{c} (55.c)

Linear acceleration for WGM having equal mass on both sides and free of load

α_{wgm}=½g_{c} (55.d)

Therefore, to calculate the speed of WGM after time (t seconds) so multiplying the acceleration by time it will give the speed, and to calculate the angular speed then multiplying the angular acceleration by time it will give the angular speed.

Linear speed for WGM free of load after (t seconds) is

v_{wgm}=(½g_{c})*t (55.e)

Angular speed for WGM free of load after (t seconds) is

ω_{wgm}=(½α_{c})*t (55.f)

So, on earth the WGM motor linear acceleration is

$${a}_{wgm} = ( \frac{1}{2} {g}_{c} ) = ( \frac{1}{2} 6.24 ) \\ {a}_{wgm} = 3.12 \frac{m}{{sec}^{2}} \qquad ( 55. g )$$

Also, on earth the WGM motor angular acceleration is

$${α}_{wgm} = ( \frac{1}{2} {α}_{c} ) = ( \frac{1}{2} ⋆ \frac{6.24}{r a} ) \\ {α}_{wgm} = ( \frac{3.12}{r a} ) \frac{m}{{sec}^{2}} \qquad ( 55. h )$$

So, these are the acceleration and speed calculations for WGM free of load i.e. there is no load connected to WGM motor by gears or belt or chain or other way.

now the input force is Fm so from formula (6) the total input force required is

$$Fm = - \frac{ra}{r} Generated Force$$

$$Fm = - \frac{r a}{r} ( - 0.6366 ) gM$$

$$Fm = \frac{ra}{r} {g}_{c} M$$

The amount of magnetic force required

$$Fm = \frac{r a}{r} ( 6.2 \; 4 ) M \\ Fm = \frac{ra}{r} ( 6.24 ) {M}_{left} \\ Fm = 6.24 \frac{ra}{r} {M}_{left} \qquad ( 56 )$$

From now on assuming the work on even number of the rotor arm.

Now for the torque calculations on the right side of circular motion, from formula (45)

$$Generated Torque = {\sum }_{x = 1}^{x = z / 2} ( mass radius ) {( Total Force on one mass )}_{x}$$

And since (Total Force on one mass)=Gravity force−Lift force=zero=0

Then the Torque generated on the right side=0

And since the total force on the right side=0 then

The total work on the right-side to lift the mass from bottom position to the top position

Work=∫_{-π/2}^{π/2}(ra)(Total force on mass)dΘ

Work=∫_{-π/2}^{π/2}(ra)(Gravity force−Lift force)dΘ

And because (Gravity force=Lift force) then (Gravity force−Lift force)=(zero)

Work=∫_{-π/2}^{π/2}ra(zero)dθ=0

This means the work done on the right side to lift the mass from bottom position where (Θ=−π/2) to the top position where (Θ=π/2) is completely zero.

This is just like the work done in the empty space of universe to move the mass from position A to position B, it need just the initial pushing force and the mass will move in universe through very long distance without any added force, because the initial force or initial energy will be converted to kinetic energy which will stay with the mass through all universe. or from position A to position B.

For our case the right-side will act just like the space of universe, and since the mass already has kinetic energy from the left-side circular motion, then the mass will reach to right side starting from bottom position to the top position without any added work.

So, the right-side will be just like the space of universe that has no effect on the mass along the right-side of circular motion. Therefore, there will be no work on the right side.

The speed calculations: (another method)

The first method to calculate the speed it was by multiplying the time with Gravitational acceleration in Circular path or “g_{c}=6.24” if the system has one mass on one side.

And if the system has equal mass on both sides then the acceleration will be

$$a = \frac{{g}_{c}}{2}$$

Now there is another method

To explain it, suppose the WGM is not connected to any load. And z=2 (two rotor arms)

Where z is the number of arms.

So, when the mass at the top position it has a potential energy

Potential energy=mgh

And as soon as it goes down to bottom position the potential energy will be converted to kinetic energy.

Kinetic energy=½mv²

Where

m: mass

v: speed

g: acceleration=9.8 {for earth gravitational acceleration}

h: height=2*mass radius=2 ra

and since the potential energy will be converted to kinetic energy

therefore, at the bottom position

Kinetic energy=potential energy

½mv²=mgh

½mv²=mg(2ra)

v²=g(4ra)

v=\sqrt{4gra} (57)

v=\sqrt{4*9.8ra}

v=\sqrt{39.2ra}

This is the speed for one mass falling down with system have only one arm

And since the system have two arms so there are two mass (M-left) and (M-right)

Therefore, the above formulas need more factors.

At the start, when the left rotor arm at the top position this means the right rotor arm at the bottom position, So the potential energy for the left mass is

Potential Energy=m_{left}gh

Potential Energy=mₗgh

For easier ml=M-left and mr=M-right

When the left mass falls down the potential energy will be converted to kinetic energy for both mass (left and right)

Total Kinetic Energy=mₗgh

½(mₗ+mᵣ)v₁²=mₗgh

Where

v1: is the speed for the first appearing of the rotor arm at the top position going down to bottom.

$${{v}_{1}}^{2} = \frac{{m}_{l}}{{m}_{l} + {m}_{r}} 2 gh$$

If ml=mr then

$${v}_{1} = \sqrt{\frac{{m}_{l}}{{m}_{l} + {m}_{r}} 2 gh} = \sqrt{\frac{1}{2} 2 gh} = \sqrt{gh} \qquad ( 58 )$$

This will be the speed for the first appearing of the mass on the top position for the left-side after falling down in circular motion.

After falling down, at this point

The left-side mass at bottom position and right-side mass at top position.

The mass at the top position now has a (potential energy+previous kinetic energy) because both masses are moving at the same speed. (Two arms are connected together).

So, the new speed for the new mass on the top position after falling down to bottom position in circular motion will be calculated as below

New kinetic energy=Potential energy+Initial kinetic energy

$$\frac{1}{2} ( {m}_{l} + {m}_{r} ) {{v}_{2}}^{2} = {m}_{r} gh + \frac{1}{2} ( {m}_{l} + {m}_{r} ) {{v}_{1}}^{2}$$

$$\frac{1}{2} {{v}_{2}}^{2} = \frac{{m}_{r}}{( {m}_{l} + {m}_{r} )} gh + \frac{1}{2} \frac{( {m}_{l} + {m}_{r} )}{( {m}_{l} + {m}_{r} )} {{v}_{1}}^{2}$$

$${{v}_{2}}^{2} = \frac{{m}_{r}}{( {m}_{l} + {m}_{r} )} 2 gh + {{v}_{1}}^{2}$$

$${{v}_{2}}^{2} = \frac{{m}_{r}}{{m}_{l} + {m}_{r}} 2 gh + \frac{{m}_{l}}{{m}_{l} + {m}_{r}} 2 gh$$

Since mr=ml=m

$${{v}_{2}}^{2} = 2 [ \frac{m}{m + m} 2 gh ]$$

$${v}_{2} = \sqrt{2 [ \frac{1}{2} 2 gh ]} = \sqrt{2 gh}$$

So, for two arms system, every appearing of a new arm at the top position going down to the bottom position the speed will be the square root of the number of appearing multiplied by acceleration multiplied by the height.

v_{β}=\sqrt{βgh} (59)

Where

β: number of appearing of mass at top position (1, 2, 3, . . . )

g: 9.8 on Earth

h: height=2*ra

Then the speed at bottom position will be “v_{β}”

Now for the instantaneous speed where angle equal to Θ.

Kinetic Energy+Potential Energy=Constant

KE+PE=Constant

At the top position

KE+PE=mg(2ra)

where

(2 ra) equals to double length of the mass radius which is equal to the height.

Energy at the bottom

KE+PE=½(2m)v₁² (60)

Energy at height (h)

KE+PE=½(2m)v₂²+mgh (61)

Therefore, substitute (60) into (61) we get

mv₁²=mv₂²+mgh

Solving for v2

mv₂²=mv₁²−mgh

Divide by m for both side

v₂²=v₁²−gh

Where

h=ra+ra sin Θ (62)

substitute value of h from (62) we get

v₂²=v₁²−g(ra+ra sin Θ)

v₂²=v₁²−gra(1+sin Θ)

Substitute value of v1 from (58)

$${v}_{2}^{2} = \frac{{m}_{r}}{( {m}_{l} + {m}_{r} )} 2 gh - g ra ( 1 + sinθ )$$

$${v}_{2}^{2} = \frac{1}{2} 2 g ( 2 ra ) - g ra ( 1 + sinθ )$$

v₂²=g(2ra)−gra(1+sin Θ)

v₂=\sqrt{2gra−gra(1+sin Θ)}

Therefore, for β number of appearing at the top position, the speed will be

v=\sqrt{β(2gra)−gra(1+sin Θ)} (63)

v=\sqrt{(appearing)*2g(mass radius)}

Hence

v=\sqrt{β2*9.8ra}

v=\sqrt{19.6βra} (64)

### Where

β: number for the appearing of arm at the top position

ra: mass radius

So, to explain the idea of the new method to calculate the speed then for example, if there are two arms (z=2) and it is important to calculate the speed and time for the first appearing and second and third (β=1, 0=2, 0=3), assuming mass radius is one meter (ra=1), and every mass fixed on arm has a mass of=1 Kg. Also Torque calculation is needed.

From formula (64)

v=\sqrt{19.60βra}

Solution:

For β=1 (first appearing for the first arm on top position)

from the above formula (64), the speed when it will reach bottom position

β=1, z=2, ra=1

v=\sqrt{19.6(1)(1)}

v=4.4271887242357310647984509622058

v≈15.9 Km/h

The time needed for first arm to reach bottom position

$$t 1 = distance / ( speed average )$$

$$t 1 = \frac{( radius * pi )}{( \frac{Initial speed + Final speed}{2} )}$$

$$t 1 = \frac{( 1 * π )}{( \frac{0 + 4.4271887242357310647984509622058 }{2} )}$$

$$t 1 = π / 2.2135943621178655323992254811029$$

$$t 1 = 1.4192268951137287477762215243315 sec$$

For β=2 (second appearing, this will be the second arm starts from top position)

The speed when it will reach to bottom position from the above formula

β=2, z=2, ra=1

v=\sqrt{19.6(2)(1)}

v=6.2609903369994111499456862724476 m/sec

v≈22.5 Km/h

The time needed for second arm to reach bottom position

$$t 2 = \frac{π}{( \frac{\begin{matrix}4.4271887242357310647984509622058 + \\ 6.2609903369994111499456862724476\end{matrix}}{2} )}$$

t2=0.58786302804076450741131408801278 sec

For β=3 (third appearing, this will be the first arm back again to the top position)

The speed when it will reach down to the bottom position from the above formula

v=\sqrt{19.6(3)(1)}

v=7.6681158050723255883975769592112 m/sec

v≈27.6 Km/h

The time needed for first arm reach bottom position again.

$$t 3 = \frac{π}{\frac{\begin{matrix}6.2609903369994111499456862724476 + \\ 7.6681158050723255883975769592112\end{matrix}}{2}}$$

$$t 3 = 0.45108316665071093417102730505054 sec$$

So, total time after 3 appearing

time=t1+t2+t3

time=2.4581730898052041893585629173948 sec

So, we get the total time and the final speed as below

Total time=2.4581730898052041893585629173948 sec

Final speed=7.6681158050723255883975769592112 m/sec

This means after 2.458 second the WGM speed will be 7.668 m/sec or 27.6 Km/h which is a very high speed for less than three seconds. (assuming a WGM free of load)

To make sure the above (speed) result is correct, we will use the new constant in physics and the first method to calculate the speed.

From formula (55.d)

$$a = \frac{{g}_{c}}{2} \frac{meter}{{second}^{2}}$$

and since the acceleration value used for the second method to calculate the speed; formula (64) was “g=9.8” then the same value of (g) will be used for the above formula (55.d) so this will make the “Gravitational acceleration in Circular path” denoted as “g_{c}” and

$${g}_{c} = \frac{π}{2} g$$

$${g}_{c} = 6.2388737692022971621402435242026$$

$$a = \frac{v}{t}$$

$$v = a * total time$$

Hence.

$$v = \frac{6.2388737692022971621402435242026}{2} * 2.4581730898052041893585629173948$$

$$v = 7.6681158050723255883975769592112 m / sec$$

Which is exactly the same final speed value from the second method used to calculate the speed.

And this proves that the new constant in physics “g_{c}” is correct 100%.

That is why I used in the above example the full precision for the numbers and fractions to prove that the new constant is correct.

And for much easier calculations

$$v = \frac{{g}_{c}}{2} * total time$$

$$v = 3.12 * 2.458$$

$$v = 7.668 m / sec$$

Which is the same value for speed v=7.668 m/sec found using the second method.

Note that the above calculations neglecting friction force.

And for the absolute value of Torque from formula (49)

$$Generated Torque = ra M ( \frac{2}{π} g )$$

$$Generated Torque = ( 1 ) ( 1 ) ( \frac{2}{π} 9.8 )$$

$$GT = 6.24 Nm$$

Another example to explain the speed using the first method, if we want to know for how long time it will take WGM free of load to reach a very high speed of (220 Km/h) or (136 Mile/h) which is the maximum speed of the cars, so calculate the time required?

Solution:

$$a = \frac{v}{t}$$

$$t = \frac{v}{a}$$

$$ι = \frac{( \frac{2.20}{3.6} )}{3.12} = 19.58 sec$$

This means that in less than 20 seconds WGM speed will reach to (220 Km/h) which is dangerously high speed in a very short time.

So, theoretically to reach to the speed of light the time required is

$$t = \frac{speed of light}{\frac{{g}_{c}}{2}}$$

$$t = \frac{299792458}{3.12} \\ t = 96087326.28 sec$$

Which is equal in years

t=3.047 year

Theoretically we need (3-year) and (17-day)

And of course, the motor will blast before it reaches to this speed.

And if it will be able practically to reach to the speed of light, the motor will disappear from our universe and it will appear in the imaginary universe where (j=\sqrt{−1}) or the motor will be converted into heat and the iron starts to melt.

Therefore, this “World Gravity Motor” can reach to the highest possible speed.

Acceleration calculation: (another method)

As for the acceleration it is the rate of change of velocity with respect to time.

$$acceleration = \frac{Δ velocity}{Δ time}$$

$$acceleration = \frac{velocity 2 - velocity 1}{time per cycle 2}$$

$$acceleration = \frac{\begin{matrix}velocity for current appearing - \\ velocity for previous appearing\end{matrix}}{time for current appearance}$$

$$acceleration = \frac{\begin{matrix}velocity for current appearing - \\ velocity for previous appearing\end{matrix}}{\frac{distance}{average speed}}$$

Velocity from formula (59)

For z=2 (two arms), g=9.8, ra=1, β=current appearing of the mass at top position.

$$acceleration = \frac{( \sqrt{β g 2 ra} - \sqrt{( β - 1 ) g 2 ra} )}{( \frac{π ra}{( \frac{\sqrt{β g 2 ra} + \sqrt{( β - 1 ) g 2 ra}}{2} )} )}$$

$$acceleration = \frac{( β g 2 ra ) - ( ( β - 1 ) g 2 ra )}{2 π ra}$$

$$acceleration = \frac{( β g 2 ra ) - ( β g 2 ra ) + ( g 2 ra )}{2 π ra}$$

$$acceleration = \frac{g 2 ra}{π 2 ra}$$

$$acceleration = \frac{g}{π}$$

And since

$${g}_{c} = \frac{2}{π} g$$

### Therefore,

$$acceleration of WGM = \frac{{g}_{c}}{2}$$

Which is the same formula (55.d) for the new constant in physics.

And since g=9.8 on earth so gc=6.24.

Therefore,

$${a}_{wgm} = \frac{6.24}{2} = 3.12 \frac{m}{{sec}^{2}}$$

Which is the same formula (55.g)

Step 08: (Inner Stator Nodes Design)

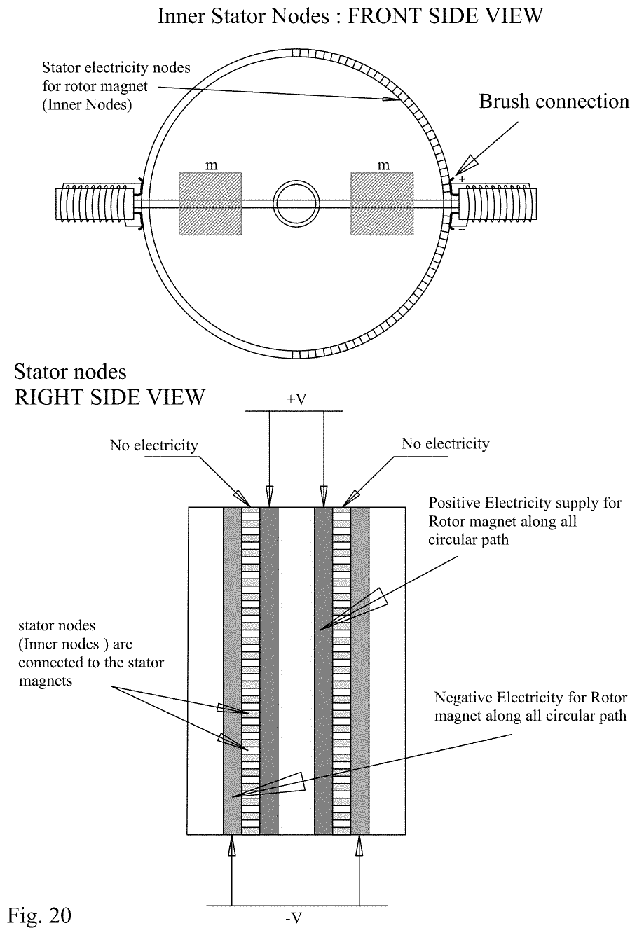

As shown in FIG. 20.

For the front side view, it shows that there are inner nodes on the right side only.

And from the right-side view, it shows the combination of inner nodes.

Every node has zero voltage.

There are two circular positive lines near to the middle to provide positive voltage along the right side of circular path.

There are two circular negative lines near to the outer side to provide negative voltage along the right side of circular path.

There are nodes between every positive voltage line and negative voltage line.

There is isolation material to separate between positive lines and negative lines and nodes.

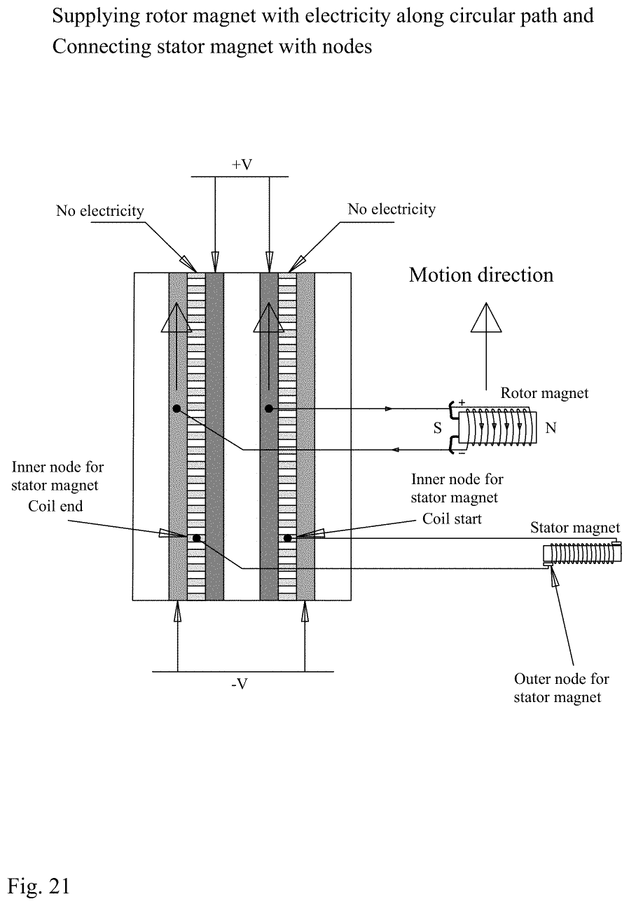

From FIG. 21.

The rotor magnet first brush touches the positive line and the second brush touches the negative line. this will provide the input power needed for rotor magnet coil to run (turn ON) along the right-side of circular motion. The direction of motion is upward as denoted by arrows. the rotor magnet will run along the right-side of circular path because the voltage lines will supply the power needed.

The figure also shows how every stator magnet is connected internally to two specific nodes. Start of the coil is connected to the right-side node and the end of the coil is connected to the left-side node. And since every inner node has no voltage till now this means every stator magnet has no voltage till now. Because every stator magnet is connected to two specific inner nodes which has no voltage.

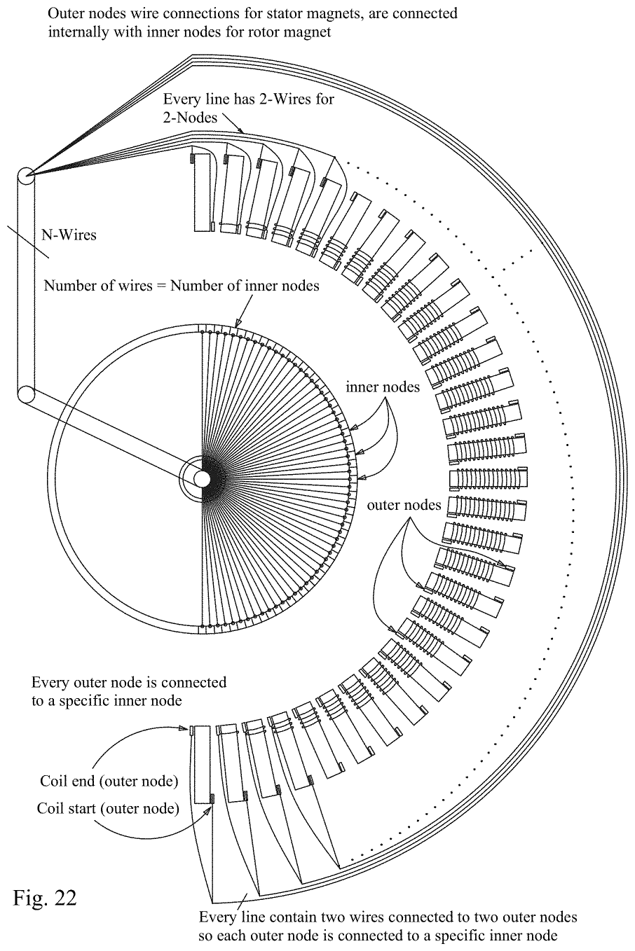

Going to FIG. 22.

This figure explains how each stator magnet is connected internally to a specific inner node.

Since the stator magnets nodes are (Outer nodes) and rotor magnet nodes are (Inner nodes)

For outer nodes (Stator magnet nodes) every stator magnet has two nodes

First node of stator magnet is connected to the start of stator magnet coil.

Second node of stator magnet is connected the end of stator magnet coil.

For inner nodes (Rotor magnet nodes)

There are two inner nodes for each row as explained in FIG. (21) before.

So, if there is (2n+1) number of stator magnets on the right-side of circular motion.

This means there are two times (2n+1) inner nodes for the rotor magnet.

(2n+1) on the right (start of coil) and (2n+1) on the left (end of coil)

Each inner node on the right is connected to a specific outer node (start of stator magnet coil)

Each inner node on the left is connected to a specific outer node (end of stator magnet coil)

Therefore, till now all of stator magnets has no electricity, and they are connected to inner nodes, and every stator magnet has different number of coils turns as shown in FIG. 22.

The Side View (Wire Connection)

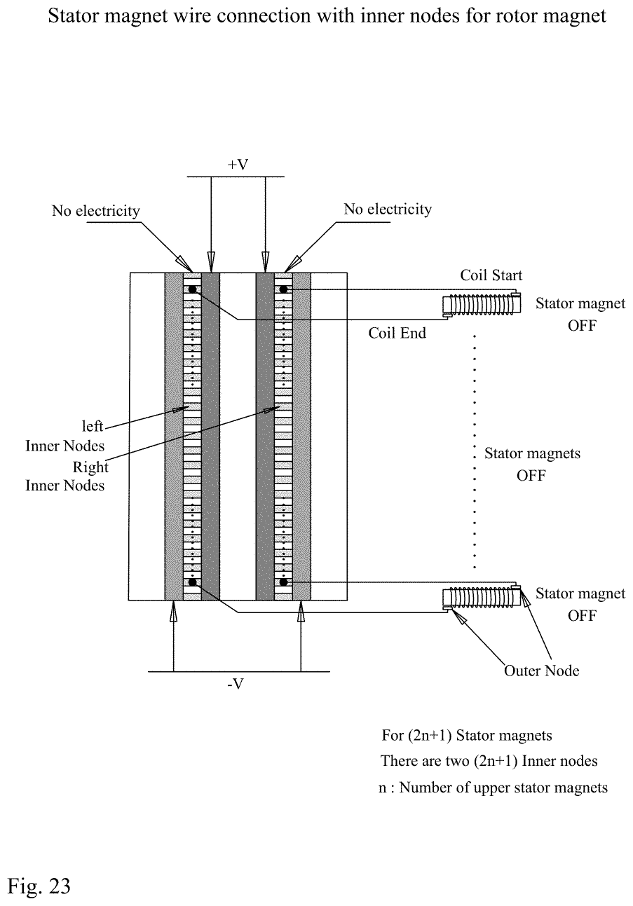

As shown in FIG. 23.

It shows the diagram of how the wire connections are made for every stator magnet with inner nodes. And it shows how the start of stator magnet coil is connected to right inner nodes and how the end of stator magnet coil is connected to left inner nodes.

Therefore, if it is required to give specific stator magnet any polarity then the right-side inner node (start of stator magnet coil) can be connected to positive voltage line or negative voltage line as required. and at the same time the left-side inner node (end of stator magnet coil) can be connected to reverse polarity of the right-side node. then the stator magnet will start to run (Turn ON) according to the required polarity.

And removing the connection will turn the stator magnet back to stop (Turn OFF)

And for more details about current direction and node connection

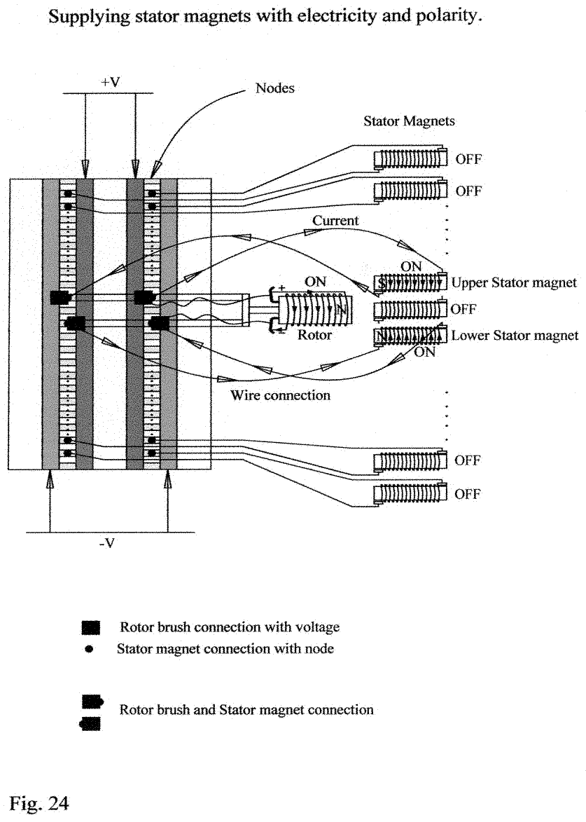

As shown in FIG. 24.

It displays the wire connection diagram as the rotor magnet move upward from the bottom position to the top position.

There are two rows of connection, every row contains two connections.

The upper row connections to connect the upper stator magnet (coil start and coil end) with required voltage polarity to run the upper stator magnet to generate attraction magnetic force. Therefore, the upper first connection node on the right will be connected to +V by rotor brush and the upper second connection node on the left will be connected to −V by another rotor brush. as shown in the figure. the electric current direction starts from +V to the node on the right side so the current will enter through the wire connection to the stator magnet coil from start point then to the magnet coil then it will go out from the end point return back to wire connection then to the Inner node on the left side then to −V. this will complete the electric circuit for the upper magnet. And it will generate a magnetic polarity to make attraction force with rotor magnet.

The lower row connections to connect the lower stator magnet coil start and coil end with required voltage polarity to run the lower magnet to generate repulsion magnetic force. Therefore, the lower first connection node on the right will be connected to −V by rotor brush and the lower second connection node on the left will be connected to +V by another rotor brush. as shown in the figure. the electric current direction starts from +V to the inner node on the left side so the current will enter through the wire connection to the stator magnet coil end point then to the magnet coil then it will go out from the magnet coil start point to wire connection then to the inner node on the right side then to −V. this will complete the electric circuit for the lower stator magnet. And it will generate a reverse magnetic polarity compared with upper stator magnet to the required generate magnetic force.

The middle row has no connection for stator magnet. Therefore, the middle stator magnet or the stator magnet in front of rotor magnet will stop (turn OFF)

And for the rotor magnet itself it will be connected to the same voltage polarity through the voltage line along the right-side of circular motion. as shown in the figure. This will keep the rotor magnet to have the same magnetic polarity along the right-side of circular motion.

Therefore, when the rotor magnet moves in upward direction it will stop (turn OFF) the previous stator magnets. and it will run (turn ON) the next stator magnets along the right-side of circular motion.

Since it is important to have two forces to effect on rotor magnet:
1—Attraction force: between rotor magnet and upper stator magnet, to pull rotor magnet in upward direction
2—Repulsion force: between rotor magnet and lower stator magnet, to push rotor magnet in upward direction

The two forces (Attraction magnetic force+Repulsion magnetic force) will be added together to generate the total magnetic force affecting on the rotor magnet, therefore the total magnetic force

Fm=Attraction(First magnetic force Fm1)+Repulsion(Second magnetic force Fm2)

Fm=Fm1(tangential component)+Fm2(tangential component).

For better view to the wire connection

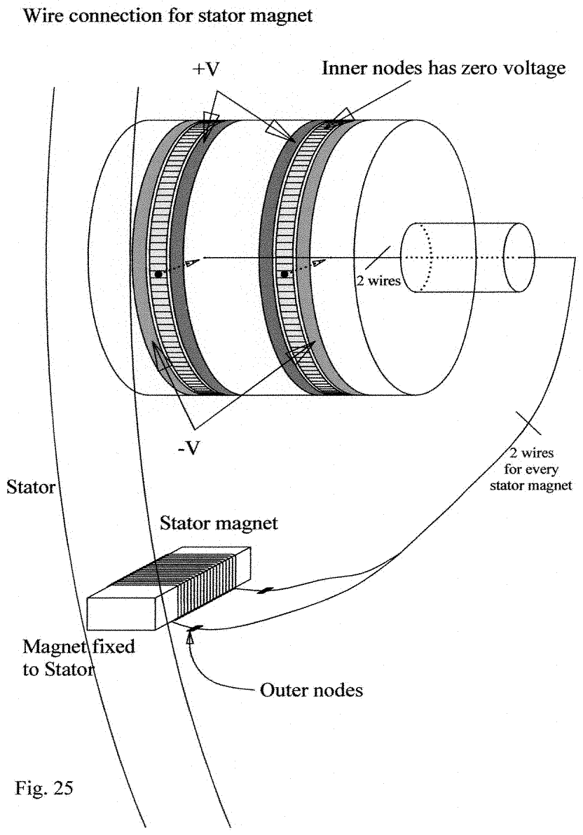

As shown in FIG. 25.

It shows how every two inner nodes are connected to one stator magnet.

And the inner nodes have no voltage and it will receive input voltage from the lines of voltage where it depends on the polarity required for every stator magnet.

For better view of special brush connection

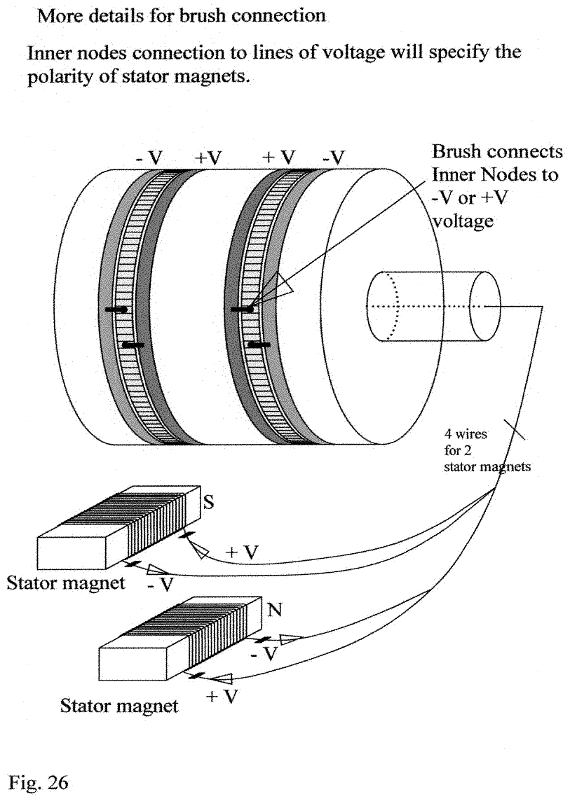

As shown in FIG. 26.

It shows how the upper two brushes connect the upper stator magnet to +V/−V, and how the lower two brushes connect the lower stator magnet to −V/+V. the in between nodes which are not connected to any brush are the (middle inner nodes).

it is possible to make more than one pair of nodes to be (connected/disconnected) for upper or lower or middle stator magnets. that will depend on the design required and the power need and stability of attraction and repulsion forces.

Now the electric connection for rotor magnet

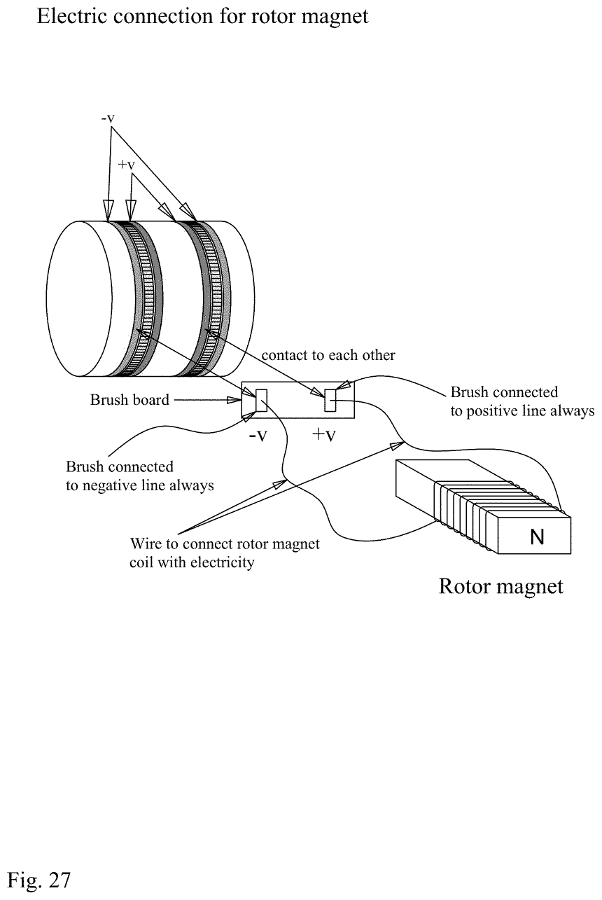

As shown in FIG. 27.

The rotor magnet coil start point is connected to a brush connected to positive line of voltage, and the coil end point is connected to another brush connected to negative line of voltage.

This will keep the magnetic polarity of rotor magnet to be constant along the circular path of right-side.

The brushes are fixed to a brush board that can hold all brushes together.

For more details about the brush board and brushes

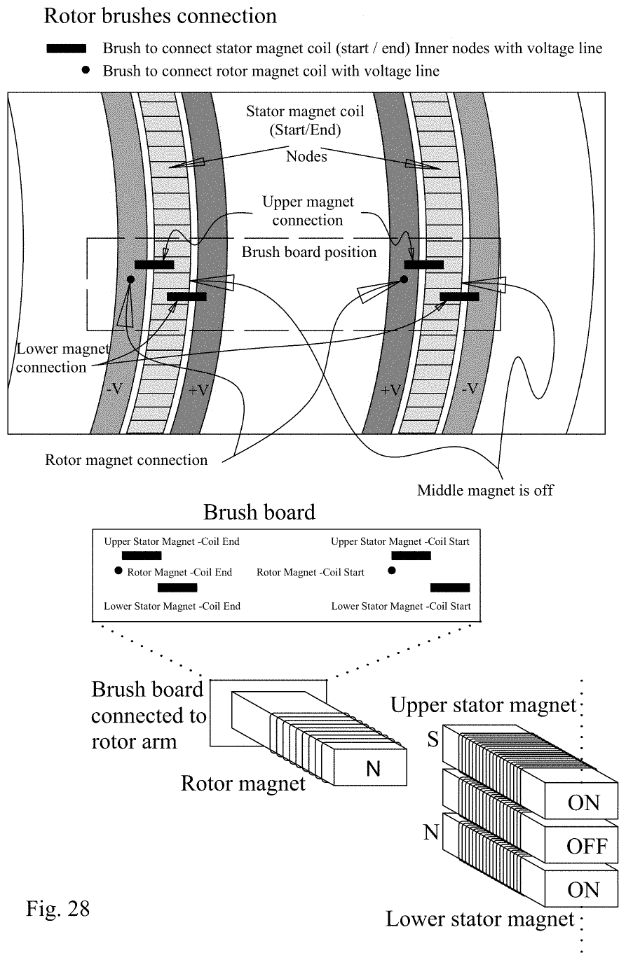

As shown in FIG. 28.

The figure shows how the brush board is connected to the beginning of rotor arm

And how it is placed on top of inner nodes.

It shows also the details of brush board.

Rows of brush board:
1—The upper row contains two brushes for upper stator magnet
   a. Upper right-side brush to connect upper stator magnet coil start point to Voltage.
   b. Upper left-side brush to connect upper stator magnet coil end point to reverse Voltage of upper right-side. So, if the right-side voltage +V then the left-side will be −V, and vice versa.
2—The middle row contains two brushes for rotor magnet
   a. No brush for stator magnet, that's why the middle stator magnet stop (Turn OFF)
   b. Two brushes for rotor magnet
      i. Right-side brush to connect rotor magnet coil start point to Voltage.
      ii. Left-side brush to connect rotor magnet coil end point to reverse Voltage of right-side, So, if the right-side voltage +V then the left-side will be −V, and vice versa.
3—The lower row contains two brushes for stator magnet
   a. Lower right-side brush to connect lower stator magnet coil start point to negative Voltage (reverse to the upper right-side brush voltage).
   b. Lower left-side brush to connect lower stator magnet coil end point to reverse Voltage of lower right-side. So, if the right-side voltage −V then the left-side will be +V, and vice versa.

The figure shows also the three stator magnets with upper magnet run (turn ON) and middle magnet stop (turn OFF) and lower magnet run (turn ON).

The polarity for lower stator magnet always must be reverse to the polarity for the upper stator magnet.

Therefore, every time the rotor magnet moves in upward direction another set of stator magnets will run and generate the magnetic force needed for rotor magnet to keep the right-side torque affecting on the mass equal to zero. Which will shift the mass position theoretically to the center of circular motion. Until the rotor magnet reach to its position on the top. Then there will be no need for any magnetic force and the rotor arm with mass can free fall in a circular motion to generate the required Torque for World Gravity Motor (WGM).

Step 09: (Inner Stator Nodes Radius—Mass Radius—Rotor Arm Radius)

Now it's the time to make improvement for the design to make it more practical for work.

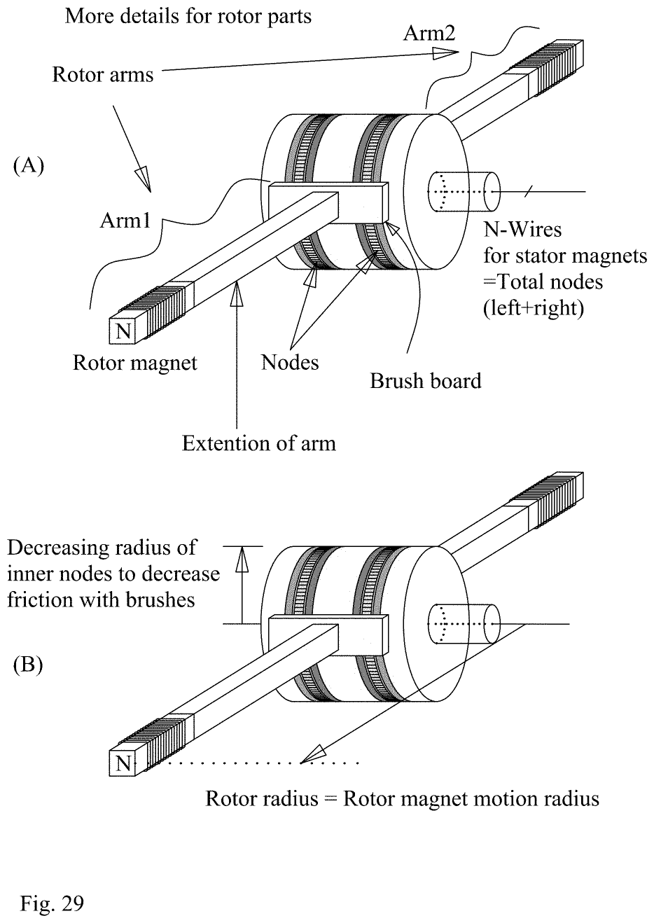

As shown in FIG. 29.

The rotor arm length will be extended. This will help the (Levers) to use less magnetic force in order to generate enough Lift force on the mass.

The upper figure (A) shows how the brush board fixed at the end of rotor arm. and it shows also how fixed brushes on brush board are touching the inner nodes and voltage lines.

It shows also how the number of wires equal to the sum of all nodes on the left and right.

The lower figure (B) shows how the radius of inner nodes is decreased. This will decrease the friction with brushes because of lower speed near the center of rotation and it will give more space for the mass if it is required to move it near the center.

Now to add equal mass on all rotator arms.

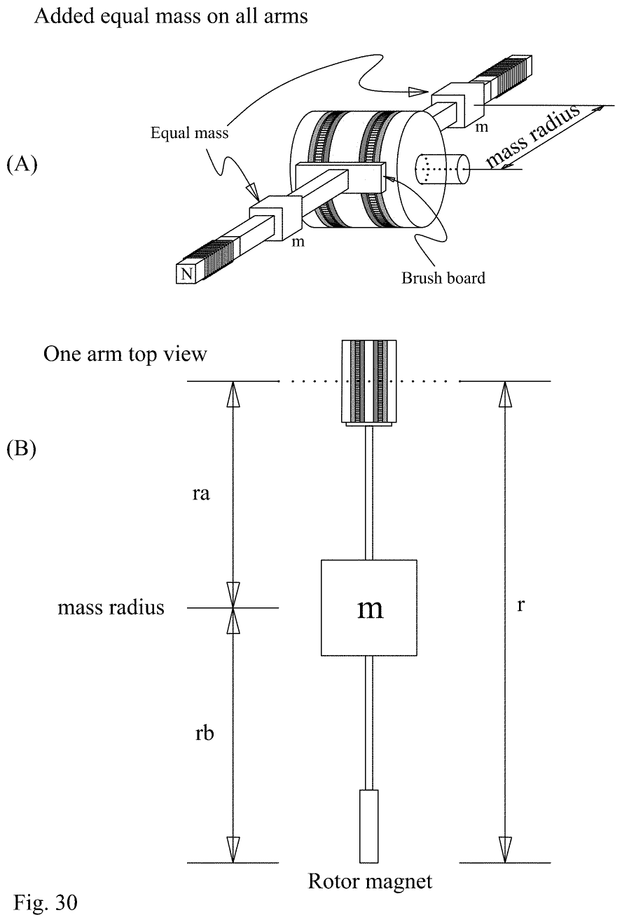

As shown in FIG. 30.

The upper figure (A) shows how equal mass added on both arms at the same distance from the center of rotation denoted as “mass radius” (ra).

The lower figure (B) shows the top view of one arm as an example only with a mass attached to the arm. The radius of the mass=ra, and the radius of the rotor arm including the end of the rotor magnet=r, also shows the remaining distance between (ra) to (r)=rb.

Where

r=ra+rb

This (mass and radius) should be applied to all remaining arms.

So, with fast rotation speed the motor will stay stable with no vibration.

Now for the front-side view

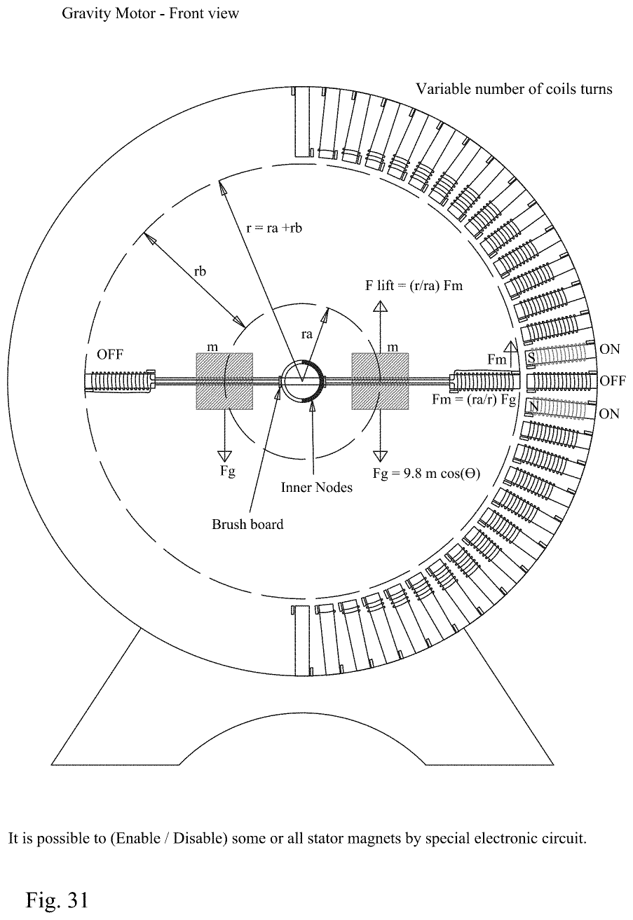

As shown in FIG. 31.

The stator magnets are arranged along the right side with variable number of coil-turn according to the required force to be generated on the rotor arm.

The inner nodes are placed along the right side but near the center of circular motion.

Two arms holding equal two mass on equal distance (ra) from the center of circular motion.

Two brush board are fixed at the beginning of every arm touching the inner nodes to generate the power needed for stator magnets during right-side of circular motion.

Two rotor magnets fixed at the end of every arm; each coil of the magnets is connected to brush board to receive the required voltage.

An attraction and repulsion forces will be generated by stator magnets on the rotor magnet which will produce a force to push rotor magnet. This force will generate a lifting force on the mass against gravity force and it is equal to gravity force which will make the gravity force effect equal to zero so the total torque will be zero on the right-side which will shift the mass theoretically to the center of circular motion.

And for more control over the stator magnets it is possible to (Enable/Disable) some or all stator magnets by a special electronic circuit.

The right arm is fixed with left arm by holders so they will move together at the same time.

And since the right arm will have no gravity.

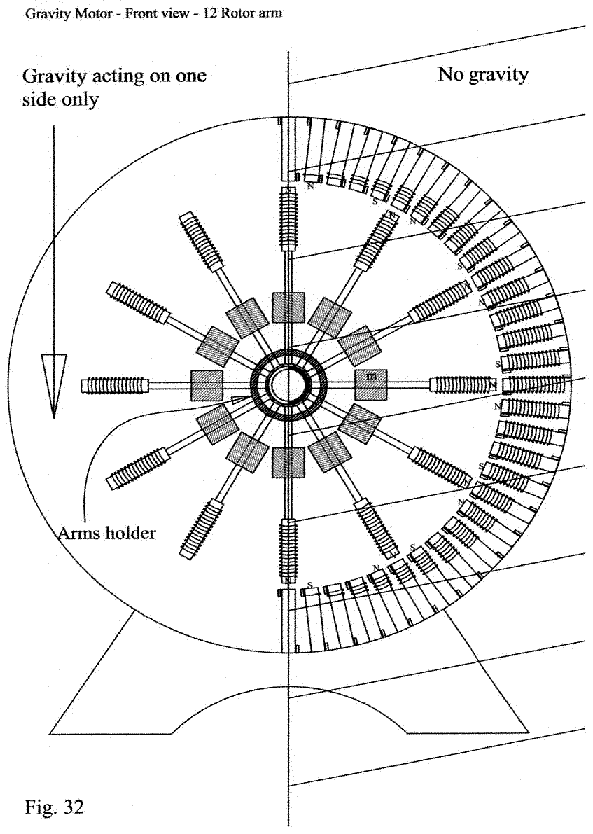

As shown in FIG. 32.

the left arm will fall down in circular motion. Which in turn will move the right arm back to the top position of the circular motion. then because of the angular momentum for every rotor mass, the lower arm will enter the right side and the upper arm will enter the left side. This cycle will repeat itself and the rotation will continue to work.

This will generate a Torque as stated in formula (49)

$$Generated Torque = ra M ( \frac{2}{π} g )$$

Step 10: (More Designs)

There are several designs can be made for stator and rotor magnets

Stator magnets with variable number of coil turns

Stator magnets with variable current

Rotor magnet with variable current

For the first design, the number of coils turns for every stator magnet must change along the right-side of circular motion as shown in FIG. 15. This will change the magnetic force of every stator magnet and it will generate the Torque necessary along the right-side of circular path.

From formula (43)

$${n}_{x} = \frac{( \frac{ gm cos x {Δθrad}^{2}}{2 N rotor r sin \frac{ϕ}{2} cos Δθ} )}{μ0 μ r IA}$$

Where

I: is the current of stator magnets

A: is the cross section of stator magnets

For the second design, it is possible to keep the number of coils turns constant but changing the current for every stator magnet on the right-side of circular motion. this also will change the magnetic force for every stator magnet and it will generate the Torque necessary along the circular path.

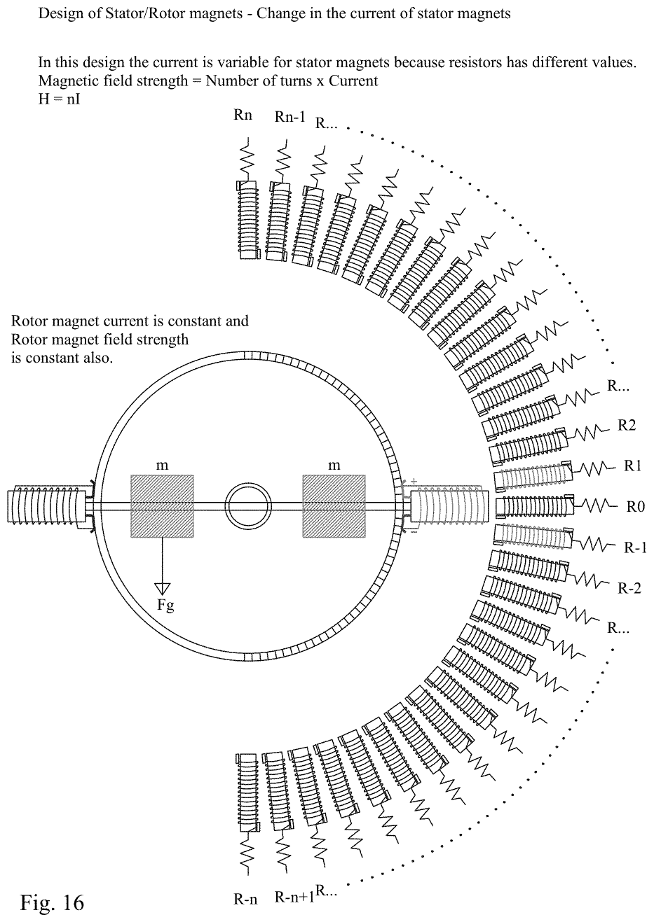

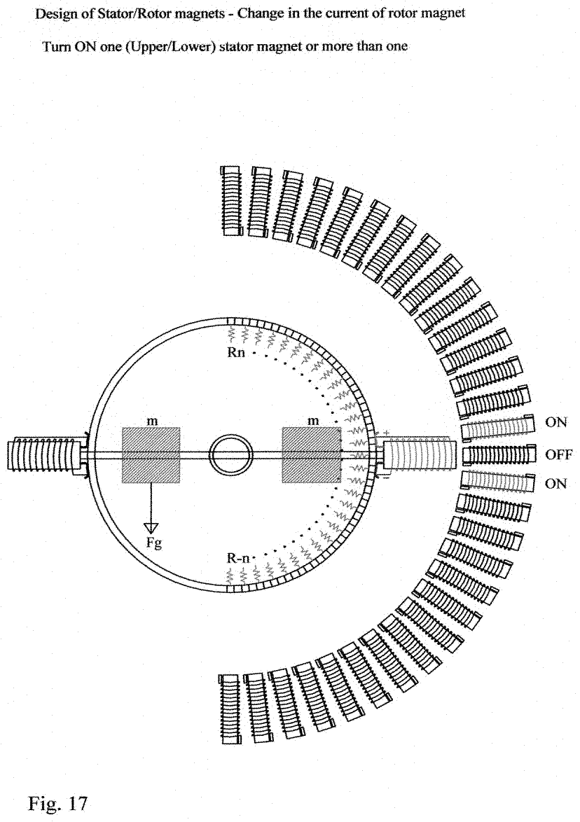

As shown in FIG. 16.

Every stator magnet has the same number of coil turns, but with a different current because every magnet has different resistor connected to the electric circuit of the magnet.

Equation (43) can be rearranged to find the current needed for every stator magnet

$${I}_{x} stator = \frac{( \frac{gm cos x Δ {θrad}^{2}}{2 N roto r sin \frac{ϕ}{2} cos Δ θ} )}{μ o μ r n A} \qquad ( 65 )$$

Where

x=(−number of lower magnets to zero to +number of upper magnets)

n: number of coil turns (constant for all stator magnets)

g: gravitational acceleration, on Earth=9.8

m: mass

For third design, it is possible to keep the number of coils turns constant and the current also constant for every stator magnet on the right-side but changing the rotor magnet input current along the right-side circular motion through every inner node. this also will change the magnetic force for every position of rotor magnet and it will generate the Torque necessary along the circular path.

As shown in FIG. 17.

Every inner node of rotor magnet will have different current because of different resistor connected to the electric circuit.

Equation (39) can be rearranged to find the current needed for every inner node

$${N}_{x} rotor or {S}_{x} rotor = ( \frac{gm cos x {Δθrad}^{2}}{2 n μ o μ r {I}_{x} Stator Ar sin \frac{ϕ}{2} cos Δθ} ) \qquad ( 66 )$$

Where

x=(−number of lower magnets to zero to +number of upper magnets)

A: Cross section for stator magnet.

g: 9.8

n: number of stator magnet turns

From the above formula, it is important to find the value of (N rotor) or (S rotor) as required by design for every position of x then substitute each value of (N rotor) or (S rotor) in the formula below to find the current needed for every inner node.

$${I}_{x} rotor = \frac{{N}_{x} rotor}{μ o μ rAn} \qquad ( 66. a )$$

Where

A: cross section area of rotor magnet

n: number of coil turns for rotor magnet

μo: absolute permeability

μr: relative permeability of rotor magnet core

The calculations for stator magnet have been explained before. Just to know that for this last design, the stator magnets field strength is constant, the only value to change is the rotor magnet field strength.

Now there are main designs for rotor and stator magnets.

So, there are three main designs for (ROTOR MAGNET).
1—Gravity motor—based on brush for rotor electric magnet.
2—Gravity motor—based on brushless rotor electric magnet.
3—Gravity motor—based on brushless rotor permanent magnet.

And also, there are three main designs for (FIELD STRENGTH)
1—Field strength—based on change of Stator magnet coils turns.
2—Field strength—based on change of Stator magnet electric current.
3—Field strength—based on change of Rotor magnet electric current.

Step 11: (Generating Electricity and Renewable Energy)

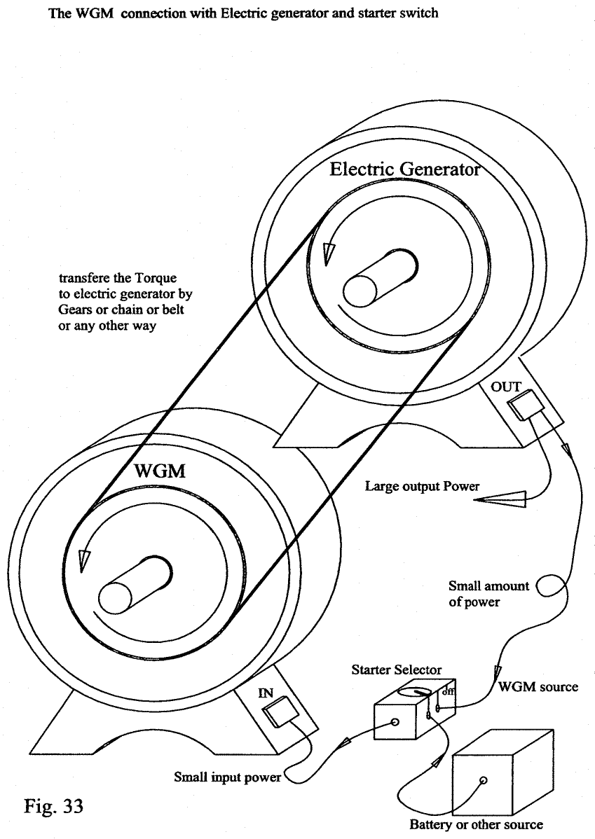

As shown in FIG. 33.

The WGM will be connected to electric generator through gears or belt or chain or another way.

To start, the starter selector switch must be pointing to (battery or any other input source) This will provide the WGM the input power to operate at start level and to generate the required Torque to drive the electric generator which will produce the required electricity, this will take some time until the rotation speed (RPM) of WGM and electric generator will reach to the required speed.

When the building up voltage of electric generator reaches to the required output voltage. It will be the time to change the input power of WGM from the (battery or any input source) to the electric generator. Therefor the starter switch must be changed to electric generator (WGM Source) and it can be changed automatically by (Automatic switch).

At this point the WGM is taking the required input power from the Electric Generator. Which is a small amount of electricity compared to the generated output power of Electric Generator. This will keep the WGM driving the electric generator which will keep generating the required electricity to WGM. the electricity generator will continue to work unless the starter switch will point to OFF position.

And since the output power of electric generator is much larger than the required input power by WGM to run, the remaining large output power of electric generator can then be used for all that benefits people.

At switch OFF position the input power to WGM will stop which will decrease the speed of WGM until it will stop completely.

Step 12: (for the Block Diagram for (Input/Output) Power)

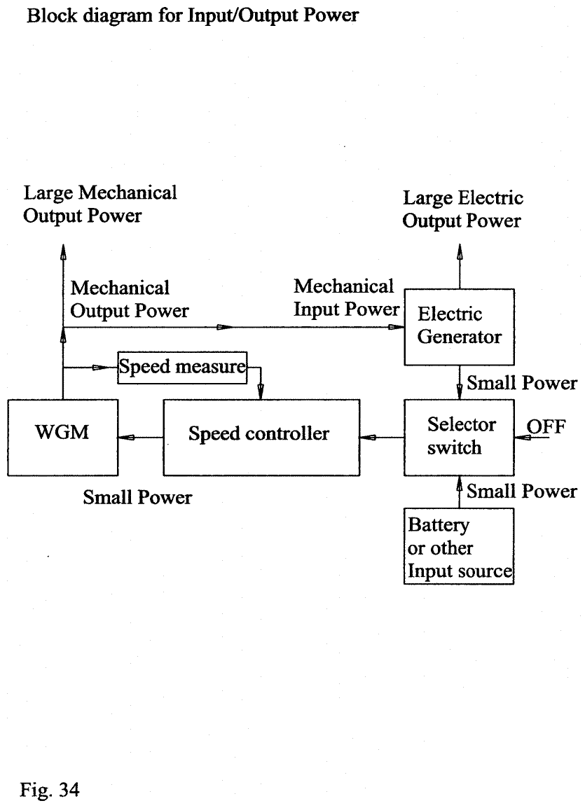

As shown in FIG. 34.

From the block diagram the input selector switch has three input states
Battery or other input source
Electric generator
OFF

The output of the selector switch will go to the speed controller which controls the amount of power enters to WGM and also it controls the Torque and other factors. It also has a speed measurement device which always read the speed of WGM.

When a speed measurement device read the speed of WGM then it will feed this information to the speed controller. The speed controller is a special (Electric and Digital) device that can be programmed for the settings required to control the speed of gravity motor as well as to maintain the speed required by controlling the amount of power and polarity sent to gravity motor, then after that the speed controller will keep controlling the speed of WGM. Then the output of speed controller will enter to WGM to run. The WGM output power is mechanical, so it is possible to use the mechanical output power directly (and/or) if it is required to generate electricity the WGM will be connected to electric generator to produce electricity.

The electric generator has two outputs,
first output will provide the input power for WGM
second output power will provide electricity for services needed.

Therefore, it is possible to get a clean and reliable renewable energy.

Step 13: (Physical Location/Theoretical Location) of MASS

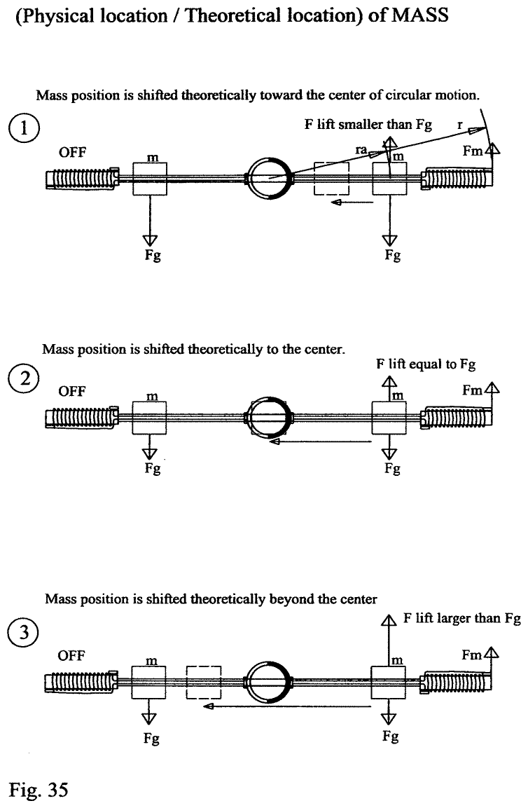

As shown in FIG. 35.

The location of the mass on arm will affect the input power calculations as well as the output power.

So, for the input power calculations

And from the formula

$$f m = - \frac{r a}{r} fg$$

Where

fm: input magnetic force

ra: mass radius

r: magnet radius (at the end of arm)

fg: gravity force (it has a negative value)

The magnetic force needed to remove gravity effect on the right side depend on two factors the first factor is (ra) which is equal to the distance from the center of circular motion to the position of the mass previously described as the (mass radius) and the second factor is (r) which is the radius of magnets at the end of rotor arm.

So, if ra<r, the input force fm is less than fg.

This will generate a lifting force (Fl)

$$fl = \frac{r}{ra} fm$$

This is the force that is against gravity force (fg)

Therefore, taking the possibilities for WGM:
1—If the Lifting force is zero, this means the MASS location at (ra), and the Output force=0 because the force on the left side of circular motion is equal to the force on the right side of circular motion, this can be used to stop the motor as well as to decrease the speed.
2—If the Lifting force is less than Gravity force (Fl<Fg), This means the MASS theoretical location between center of circular motion and Mass radius (ra), this can be used when it is required to decrease the acceleration of WGM as well as to decrease the output Torque.
3—If the lifting force is equal to Gravity force (Fl=Fg), This means the MASS theoretical location is exactly at the center of circular motion, for all rotor arms on the right side this will give the WGM the ability to rotate and to increase the speed because there is only a force on the left side, and the force on the right side will disappear because all masses theoretical location shifted to the center of circular motion.
4—If the Lifting force is larger than Gravity force (Fl>Fg), this means the MASS on the right-side its theoretical location is beyond the center of circular motion (the mass on the right-side arms are shifted to the arm on the left-side added with mass on the left side), this case can be used at start up to generate more Torque but it will cost more power.
5—The last state is when the polarity of Rotor magnet reversed, this means that the right-side MASS theoretical location is shifted more to the right side than mass physical location which can make (theoretical mass radius>ra), this can decrease the speed and can stop WGM from rotating and can start the Reverse rotation (clockwise direction).

Therefore, the right-side of circular motion can have a controlled gravity, so it can be zero gravity or positive or negative gravity.

Step 14: (Removing Air Friction)

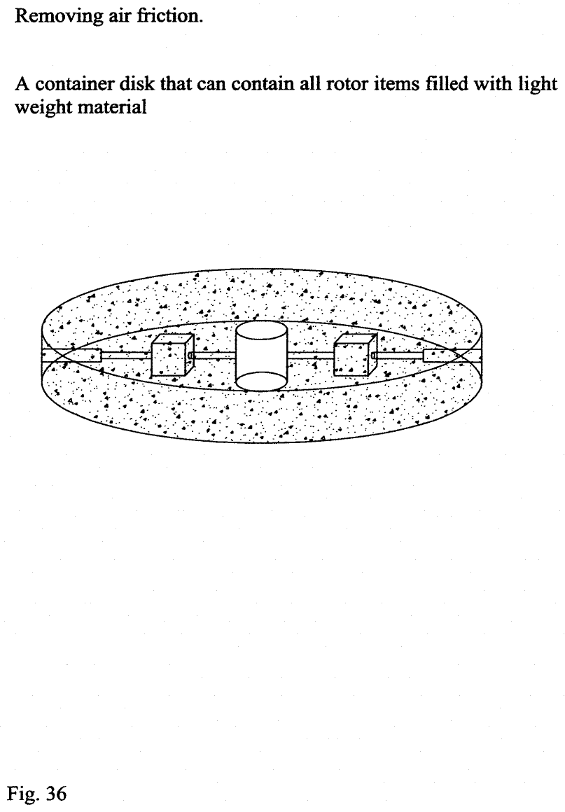

As shown in FIG. 36.

To remove air friction by making a container disk that can contain all rotor items, then filling the container disk with light weight material and use the new solid rotor disk as the rotor part of WGM.

It is possible to remove air friction using another method, by making two solid circular shape covers that fits above all rotor parts and fits upon each other. One cover for the backside and the other one for the front side, and then fixing the two covers together.

This solid material properties are.
1—heat resistance
2—scratch resistance
3—unbreakable
4—Isolation for electricity
5—has no effect on magnetic field
6—light weight

So, in any one of the above two methods the air friction will be reduced greatly.

Step 15: (More Calculations)

Moment of inertia:

It is important to remember now that Electric Generator has a larger mass.

Now since the WGM is connected with Electric Generator by gears or chain or belt or any other way there will be inertia effect against rotation.

Inertia=Inertia of WGM+Inertia of Electric generator (67)

Inertia of WGM=Zmrₐ² (68)

Inertia of Electric Generator=I_{G} (69)

Where

m: mass on arm

ra: mass radius

Z: number of arms

I_{G}: inertia of electric generator

Neglecting inertia of arms for WGM because it can be manufactured from light weight material.

I=Inertia of WGM+Inertia of Generator

I=Zmrₐ²+I_{G} (70)

The angular acceleration of a mechanical system

$$\begin{matrix}Total angular acceleration = \frac{Total Torque}{Total Inertia} & ( 71 ) \\ α = \frac{\sum Tnet}{Inet} & ( 72 ) \\ α = \frac{\sum Tnet}{{I}_{W} + {I}_{G}} & ( 73 )\end{matrix}$$

Now we have only rotational mass, so (mass=0) and (inertia mass≠0)

Let M_{W}=(Z*m)/2=Mass of one side of WGM motor

$$α = \frac{\sum Tnet}{{M}_{W} {r}_{a}^{2} + {I}_{G}} \\ α = \frac{ra * {M}_{W} * {g}_{c}}{2 {M}_{W} {r}_{a}^{2} + {I}_{G}} \qquad ( 74 )$$

This is the linear acceleration for the system.

Where

M_{W}: WGM mass of right-side

The angular acceleration is equal to linear acceleration divided by (ra)

$$α = \frac{A}{{r}_{a}} \qquad ( 75 )$$

So, the linear form will be

$$A = \frac{{ra}^{2} {M}_{W} {g}_{c}}{2 {M}_{W} {r}_{a}^{2} + {I}_{G}} \qquad ( 75. a )$$

Also, for acceleration in terms of angular acceleration from torque formula where

$$\begin{matrix}Torque = Angular acceleration * Inertia & \\ T = α 1 & \\ α = \frac{Generated Torque}{Total Inertia} & ( 76 ) \\ α = \frac{{r}_{a} ( \frac{2}{π} g ) {M}_{W}}{{I}_{WGM} + {I}_{G}} & ( 77 )\end{matrix}$$

Where

I_{WGM}: Inertia of WGM

I_{G}: Inertia of Electric Generator (or any load)

So, this formula proves that if the system is free of load (I_{G}=0) then angular acceleration (a) is higher, if there is a load connected to WGM then the angular acceleration (a) is lower.

Rewriting the above formula in terms of angular acceleration

$$α = \frac{{r}_{a} {g}_{c} {M}_{W}}{{I}_{WGM} + {I}_{G}}$$

$$α = \frac{{r}_{a} ( {r}_{a} {α}_{c} ) {M}_{W}}{{I}_{WGM} + {I}_{G}}$$

$$α = \frac{{M}_{W} {r}_{a}^{2} {α}_{c}}{{I}_{WGM} + {I}_{G}}$$

$$α = \frac{\frac{{I}_{WGM}}{2} {α}_{c}}{{I}_{WGM} + {I}_{G}}$$

$$α = \frac{1}{2} * \frac{{I}_{WGM} {α}_{c}}{{I}_{WGM} + {I}_{G}}$$

Angular acceleration for WGM with load connected

$$α = \frac{{α}_{c}}{2} * \frac{{I}_{WGM}}{{I}_{WGM} + {I}_{G}} \\ a = {r}_{a} α \qquad ( 78 )$$

Linear acceleration for WGM with load connected

$$a = \frac{{g}_{c}}{2} * \frac{{I}_{WGM}}{{I}_{WGM} + {I}_{G}} \qquad ( 79 )$$

Now to find the best value for (I_{WGM}) compared with (I_{G}) and for more easier then writing (I_{W}) instead of (I_{WGM})

I_{W}=I_{WGM}

So, for any variable below if it contains sub(W) it means sub (WGM). And sub(C) it means sub(circular) and sub(G) it means sub (Generator or Load).

Hence, we need to take the derivative of angular acceleration with respect to I_{W} or I_{WGM}

In order to find the maximum and minimum values.

$$α = \frac{{r}_{a} {g}_{c} {M}_{W}}{{I}_{WGM} + {I}_{G}} = \frac{{α}_{c}}{2} * \frac{{I}_{W}}{{I}_{W} + {I}_{G}}$$

Where M_{W}=half mass of WGM or mass of the left-side only

So, taking the derivative for an lar acceleration to find the maximum and minimum values.

$$\frac{d α}{{dI}_{W}} = \frac{{α}_{c}}{2} \frac{d}{{dI}_{W}} ( \frac{{I}_{W}}{{I}_{W} + {I}_{G}} )$$

$$\frac{d α}{{dI}_{W}} = \frac{{α}_{c}}{2} \frac{( {I}_{W} + {I}_{G} ) - {I}_{W}}{{( {I}_{W} + {I}_{G} )}^{2}}$$

$$\frac{d α}{{dI}_{W}} = \frac{{α}_{c}}{2} \frac{{I}_{G}}{{( {I}_{W} + {I}_{G} )}^{2}}$$

Now to find the maximum and minimum values the derivative must equal to zero

$$\frac{d α}{{dI}_{W}} = \frac{{α}_{c}}{2} \frac{{I}_{G}}{{( {I}_{W} + {I}_{G} )}^{2}} = 0$$

$$\frac{{α}_{c}}{2} \frac{{I}_{G}}{{( {I}_{W} + {I}_{G} )}^{2}} = 0$$

There are two possibilities:

The first possibility:

$$\frac{{α}_{c}}{2} \frac{{I}_{G}}{{( {I}_{W} + {I}_{G} )}^{2}} * {( {I}_{W} + {I}_{G} )}^{2} = 0 * {( {I}_{W} + {I}_{G} )}^{2} \\ \frac{{α}_{c}}{2} {I}_{G} = 0 \\ {I}_{G} = 0 \qquad ( 80 )$$

This possibility for WGM system free of load (No electrical generator connected with WGM) which will make (a) at its maximum.

This means

$$( α = \frac{{α}_{c}}{2} )$$

The second possibility:

$$\frac{{α}_{c}}{2} \frac{{I}_{G}}{{( {I}_{W} + {I}_{G} )}^{2}} = 0 \\ \frac{{α}_{c}}{2} \frac{{I}_{G}}{{( {I}_{W} + {I}_{G} )}^{2}} * ( {I}_{W} + {I}_{G} ) = 0 * ( {I}_{W} + {I}_{G} ) \\ \frac{{α}_{c}}{2} \frac{{I}_{G}}{( {I}_{W} + {I}_{G} )} = 0 \\ \frac{{α}_{c}}{2} \frac{{I}_{G}}{( {I}_{W} + {I}_{G} )} * \frac{( {I}_{W} - {I}_{G} )}{( {I}_{W} - {I}_{G} )} = 0 * \frac{( {I}_{W} - {I}_{G} )}{( {I}_{W} - {I}_{G} )} \\ \frac{{α}_{c}}{2} \frac{{I}_{G} ( {I}_{W} - {I}_{G} )}{{I}_{W}^{2} - {I}_{G}^{2}} = 0 \\ \frac{{α}_{c}}{2} \frac{{I}_{G} {I}_{W} - {I}_{G}^{2}}{{I}_{W}^{2} - {I}_{G}^{2}} = 0 \\ \frac{{α}_{c}}{2} \frac{{I}_{G} {I}_{W}}{{I}_{W}^{2} - {I}_{G}^{2}} = \frac{{α}_{c}}{2} \frac{{I}_{G}^{2}}{{I}_{W}^{2} - {I}_{G}^{2}} \\ \frac{{I}_{G} {I}_{W}}{{I}_{W}^{2} - {I}_{G}^{2}} = \frac{{I}_{G}^{2}}{{I}_{W}^{2} - {I}_{G}^{2}} \\ \frac{{I}_{G} {I}_{W}}{1} = \frac{{I}_{G}^{2}}{1} \\ {I}_{G} {I}_{W} = {I}_{G}^{2} \\ {I}_{W} = {I}_{G} \qquad ( 81 )$$

And this is to get the best angular acceleration for a system at full load (electrical generator or load connected to WGM) where inertia of load=I_{G} i.e. Inertia of Generator).

$$α = \frac{{α}_{c}}{2} \frac{{I}_{W}}{{I}_{W} + {I}_{G}} = \frac{{α}_{c}}{2} \frac{{I}_{G}}{{I}_{G} + {I}_{G}} = \frac{{α}_{C}}{2} \frac{{I}_{G}}{2 {I}_{G}} = \frac{{α}_{c}}{4}$$

So, if (IW=IG) then we can get quarter of the acceleration for a system free of load.

Therefore, if (IW=IG) then the angular acceleration for an system full of load will be

$$α = \frac{{α}_{c}}{4} \qquad ( 82 )$$

It is possible to drive the same formula (81) from (77) using (ra) as a variable.

$$α = \frac{{r}_{a} ( \frac{2}{π} g ) {M}_{w}}{{I}_{WGM} + {I}_{G}}$$

$$\frac{d α}{{dr}_{a}} = \frac{d}{{dr}_{a}} ( \frac{{r}_{a} ( \frac{2}{π} g ) {M}_{w}}{{I}_{WGM} + {I}_{G}} )$$

$$\frac{d α}{{dr}_{a}} = \frac{d}{{dr}_{a}} ( \frac{{r}_{a} ( \frac{2}{π} g ) {M}_{w}}{2 {M}_{w} {{r}_{a}}^{2} + {I}_{G}} )$$

Where

Z: number of arms

m: one mass fixed on one arm

M_{W}: is the mass on the left-side (this is the side that generate the force)

This means

$$\frac{Z}{2} m = {M}_{w}$$

Where Z=number of rotor arms and (m) is the fixed mass per one arm.

So, the derivative will be

$$\frac{d α}{{dr}_{a}} = \frac{d}{{dr}_{a}} ( \frac{{r}_{a} {g}_{c} {M}_{w}}{2 {M}_{w} {{r}_{a}}^{2} + {I}_{G}} )$$

$$\frac{d α}{{dr}_{a}} = \frac{( 2 {M}_{w} {{r}_{a}}^{2} + {I}_{G} ) {g}_{c} {M}_{w} - {r}_{a} {g}_{c} {M}_{w} ( 4 {M}_{w} {r}_{a} )}{{( 2 {M}_{w} {{r}_{a}}^{2} + {I}_{G} )}^{2}}$$

$$\frac{d α}{{dr}_{a}} = \frac{2 {g}_{c} {{M}_{w}}^{2} {{r}_{a}}^{2} + {I}_{G} {g}_{c} {M}_{w} - 4 {g}_{c} {{M}_{w}}^{2} {{r}_{a}}^{2}}{{( 2 {M}_{w} {{r}_{a}}^{2} + {I}_{G} )}^{2}}$$

To find the (maximum and minimum) the derivative must equal to zero.

$$\frac{{I}_{G} {g}_{c} {M}_{w} - 2 {g}_{c} {{M}_{w}}^{2} {{r}_{a}}^{2}}{{( 2 {M}_{w} {{r}_{a}}^{2} + {I}_{G} )}^{2}} = 0$$

$$\frac{{I}_{G} {g}_{c} {M}_{w} - 2 {g}_{c} {{M}_{w}}^{2} {{r}_{a}}^{2}}{{( 2 {M}_{w} {{r}_{a}}^{2} + {I}_{G} )}^{2}} * {( 2 {M}_{w} {{r}_{a}}^{2} + {I}_{G} )}^{2} = 0 * {( 2 {M}_{w} {{r}_{a}}^{2} + {I}_{G} )}^{2}$$

$${I}_{G} {g}_{c} {M}_{w} - 2 {g}_{c} {{M}_{w}}^{2} {{r}_{a}}^{2} = 0$$

$${I}_{G} {g}_{c} {M}_{w} = 2 {g}_{c} {{M}_{w}}^{2} {{r}_{a}}^{2}$$

$${I}_{G} = 2 {M}_{w} {{r}_{a}}^{2}$$

Where 2M_{W}=full mass of WGM

∴I_{G}=I_{W}

Which is the same as formula (81)

Therefore, it is possible to control mass radius or the mass fixed on arms from the formula below

$$2 {M}_{w} {{r}_{a}}^{2} = {I}_{G} \\ {M}_{w} = \frac{{I}_{G}}{2 {{r}_{a}}^{2}} \qquad ( 83 )$$

And from the formula

$$\frac{Z}{2} m = {M}_{w}$$

So, each mass on every arm will be

$$m = \frac{2}{Z} {M}_{w} \qquad ( 84 )$$

And since (mass) is constant then we can control (mass radius) to adjust for the required inertia.

$${{r}_{a}}^{2} = \frac{{I}_{G}}{2 {M}_{w}} \\ {r}_{a} = \sqrt{\frac{{I}_{G}}{2 {M}_{w}}} \qquad ( 85 )$$

Where

I_{G}: inertia of generator or load.

It is important to give the mass the ability to move toward the center or outward form center.

Now the mass can be pushed outward from center to get more torque at start up.

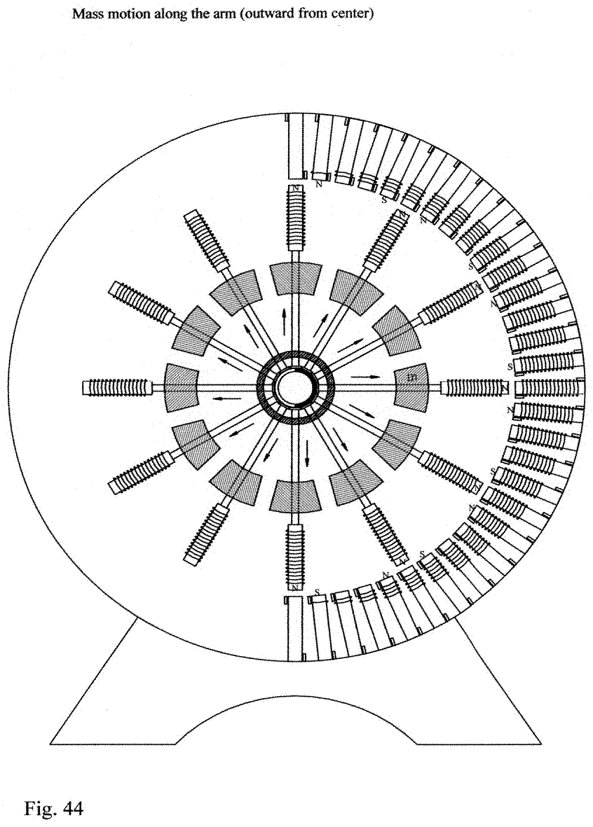

As shown in FIG. 43 and FIG. 44.

In this way the mass movement along the arm will be controlled, and it can be variable length to adjust for the best required torque.

Step 16: (Controlling Mass Motion Along the Arm)

It is important to give the mass the ability to move toward the center or outward form center. if the mass is pushed outward from center at start-up it will build momentum and generates torque.

As shown in FIG. 44.

In this way the mass movement along the arm will be controlled and variable to get the required torque.

mass position along arm can be controlled by special screw passing through the mass for when it rotates in one direction it can make the mass to move closer to center of circular motion and vice versa, this will give more control over the motor speed and torque and inertia.

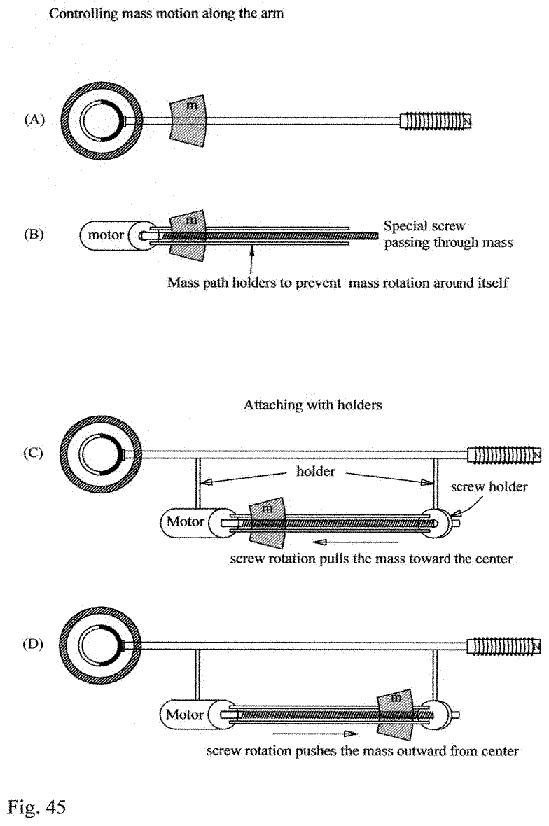

As shown in FIG. 45.

Part (A) shows the rotor arm with a mass fixed on arm and it has no ability to move along the rotor arm.

Part (B) shows a special screw passing through the mass to give the mass the ability to move along the rotor arm, and it has a motor at the beginning to control the rotation of the screw for when the screw rotate in clockwise direction it will pulls the mass toward the center of circular motion. and when it rotates in counter clockwise direction it will pushes the mass outward from center of circular motion. and it has also two path holders to prevent the mass rotation around itself during screw rotation.

It is possible to have more than one screw passing through the mass if the mass is large or if the design needed requires this.

Part (C) shows how the motor and the special screw and path holders and the mass are fixed to rotor arm. It also shows how the rotation of the motor rotates the special screw which will pulls the mass toward the center of circular motion.

Part (D) shows how the rotation of the motor rotates the special screw which will push the mass outward from center of circular motion.

Now to improve the design even more. It is possible to have one motor in the center to control all masses on all arms and to control all special screws by gears.

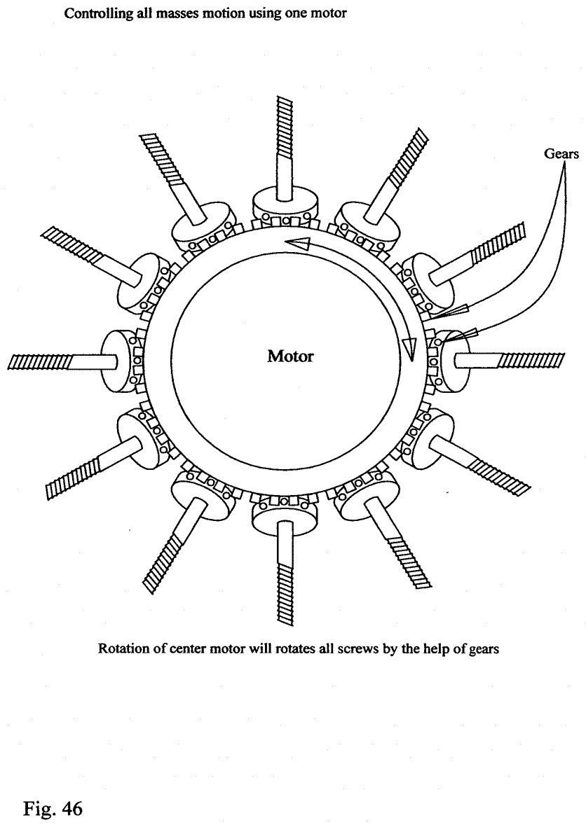

As shown in FIG. 46.

Connecting all screws to one main motor at the center which can move all masses positions at the same time by rotating all screws at the same time.

Now for more details on the movement of mass along the rotor arm

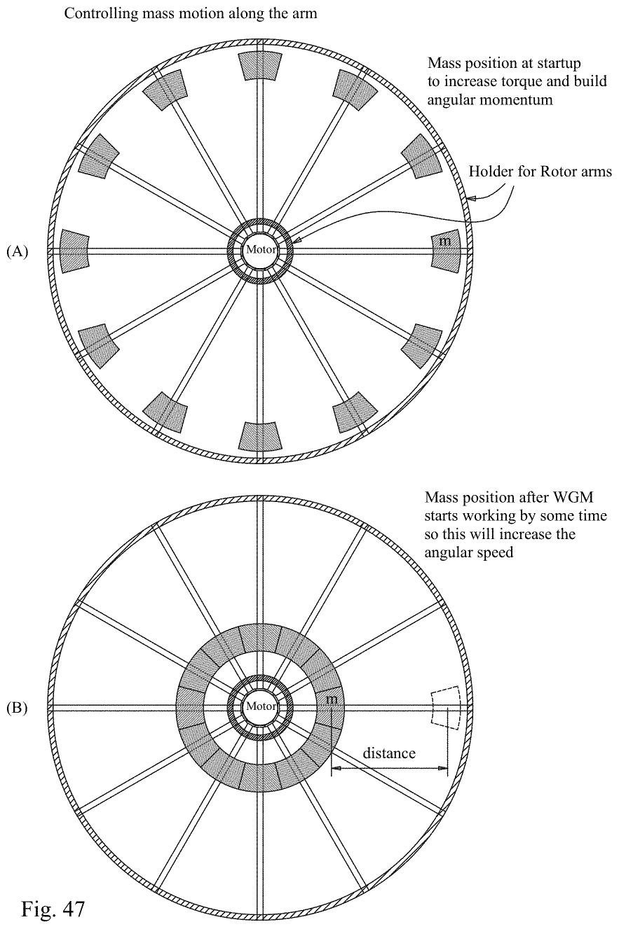

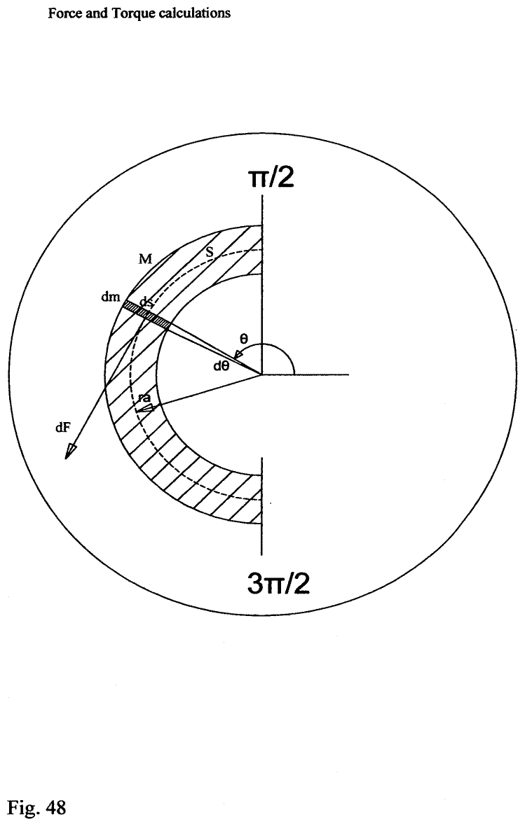

As shown in FIG. 47.

Part (A) shows the mass position at startup, where it is important to increase torque and build angular momentum at start-up.

Then after some time when the WGM start to get acceleration, the “position controller motor” starts rotating to rotate all screws in a clockwise direction which will pull all masses toward the center of circular motion. It is possible to start the middle motor manually or automatically as per the required design.

Part (B) shows the mass position after the “position controller motor” pulls all masses toward the center of circular motion. When it pulls the mass towards the center then because of the angular momentum the angular speed will increase more. Which will make the WGM rotates even faster and faster.

Therefore, another rotor part or rotor arms can hold all the masses and motor and it can be placed on the center and above the previous rotor part or rotating arms that contains all the magnets.

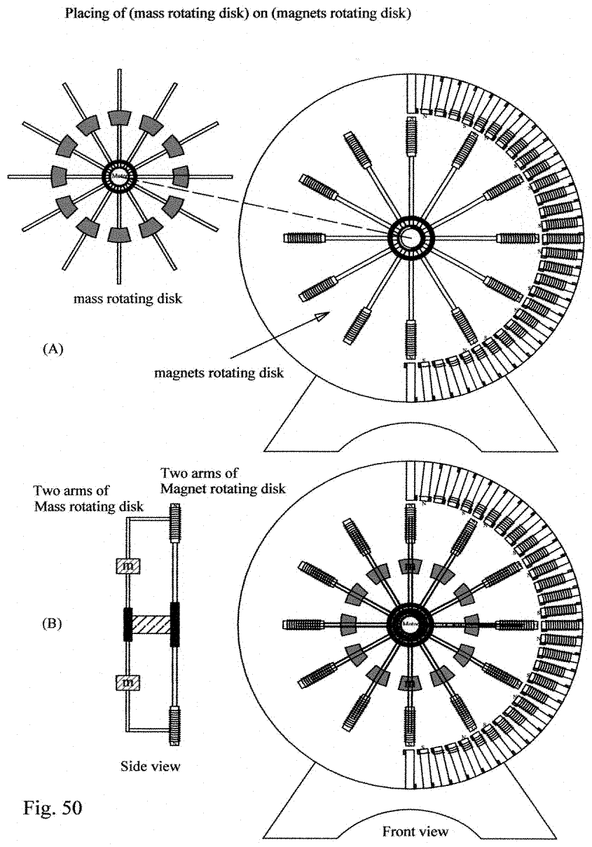

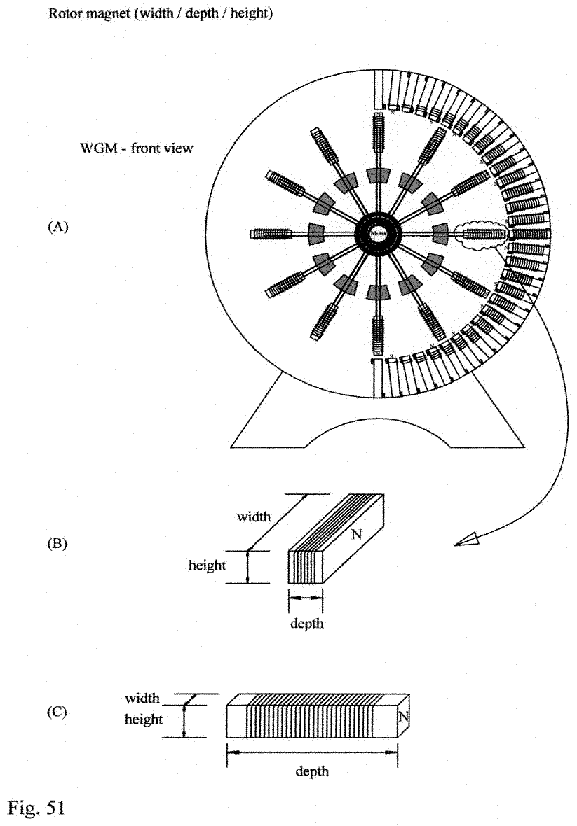

As shown in FIG. 50.

Part (A) shows the mass rotating disk that contains the masses and the other disk magnets rotating disk that contains the magnets.

Part (B) on the right side shows the two rotating disks after attaching them together.

Part (B) on the left side shows the side view for two arms from magnet disk and mass disk.

There is a separation distance between the two disks.

For the size of the rotor and stator magnets, it can be designed as the width more than depth or vice versa.

As shown in FIG. 51.

Part (A) shows the WGM front view

Part (B) shows the side view for rotor magnet which has the width more than the depth, the width of stator magnets must be equal to the width of rotor magnet to get the maximum force.

Part (C) shows the rotor magnet depth more than the width, also the width of stator magnets must be equal to the width of rotor magnet.

Now for the mass and the screws used for the mass rotating disk.

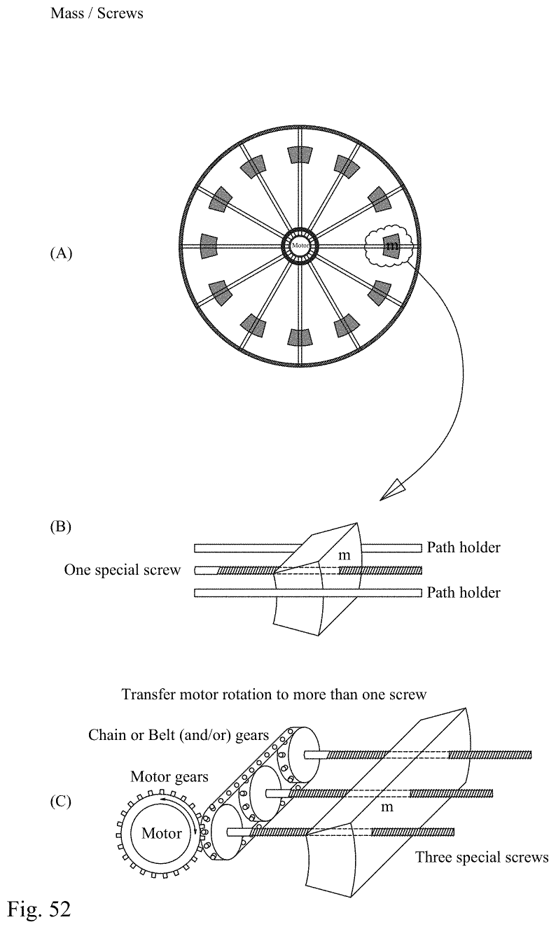

As shown in FIG. 52.

Part (A) shows the mass rotating disk.

Part (B) shows one mass with one screw passing to control the mass position along the arm. And there are path holders to prevent mass rotating around itself when the screw rotates.

Part (C) shows a mass with more width and with more than one screw. And also, it explains how to transfer the rotation of the motor to all the screws by using a belt and/or gears to control the location of the mass along the rotating arm. It is also possible to use one screw and two or more path holders or more than one screw and two or more path holders. As per the design required.

Step 17: (Brushless System)

First Type—Based on Rotor Permanent Magnet:

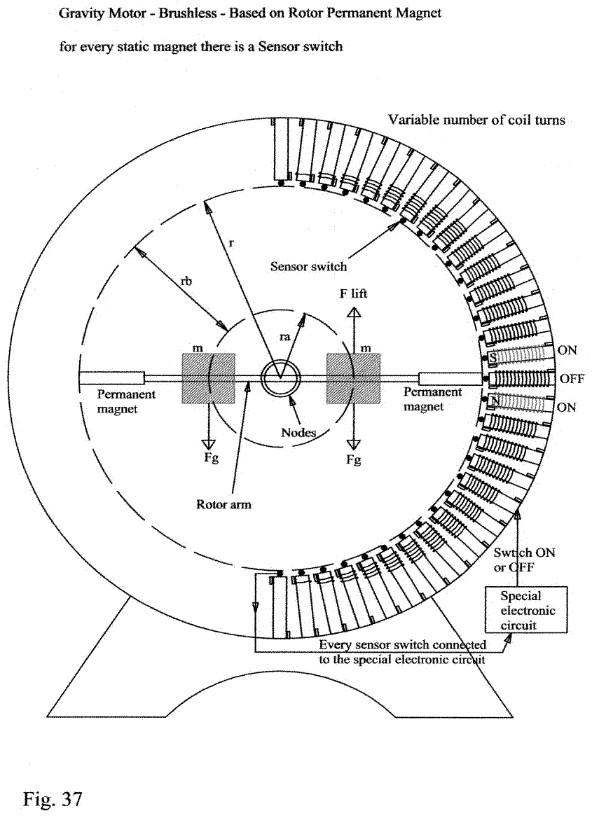

As shown in FIG. 37.

The rotor electric magnet is replaced with a permanent magnet, and a sensor switch is added near every stator magnet for when the rotor magnet nearly faces a stator magnet the sensor switch will send a signal to a special electronic circuit, and the special electronic circuit can (turn ON or turn OFF or increase or decrease or reverse) the voltage of stator magnets, so it will turn the front facing stator magnet (OFF) and it will turn (ON) the upper and lower stator magnets. The lower stator magnet will have an inverse polarity relative to the upper stator magnet. It is possible to turn (ON) only one lower stator magnet or more than one, and it is possible to turn (ON) only one upper stator magnet or more than one, and it is possible to turn (ON) both upper and lower stator magnets as required.

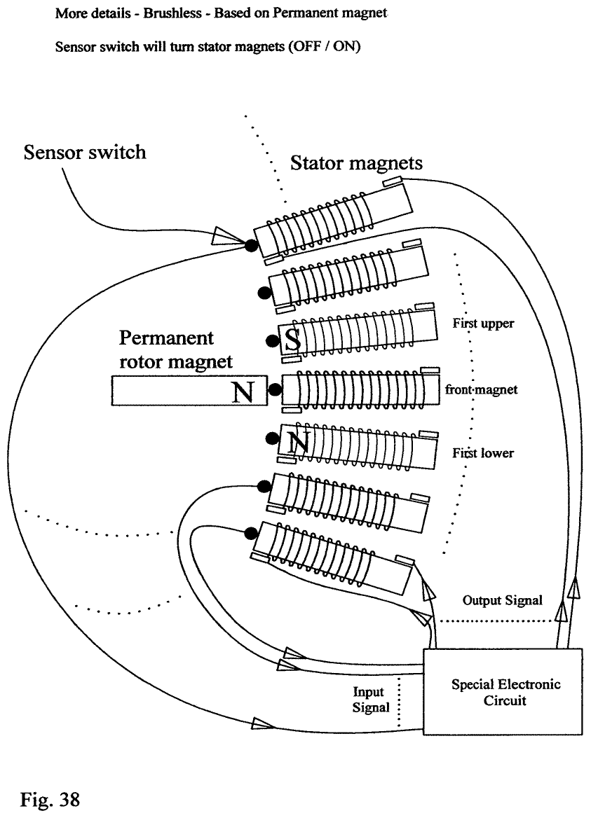

For more details as shown in FIG. 38.

A special electronic circuit will supply every stator magnet with electricity and it will read the input status of every sensor switch. for when a specific sensor switch detects the rotor magnet nearly in front of it. The sensor will send a signal to a special electronic circuit then the special electronic circuit will send output signals and it will turn (OFF) that stator magnet which belongs to that switch. and it will supply the first upper stator magnet relative to front magnet with electricity and the first lower stator magnet relative to front magnet with electricity. So the special electronic circuit can supply (x number of upper magnets) (and/or) (x number of lower magnets) with electricity—that depend on the required design to be manufactured. The lower stator magnet(s) will have an inverse polarity relative to the upper stator magnet(s).

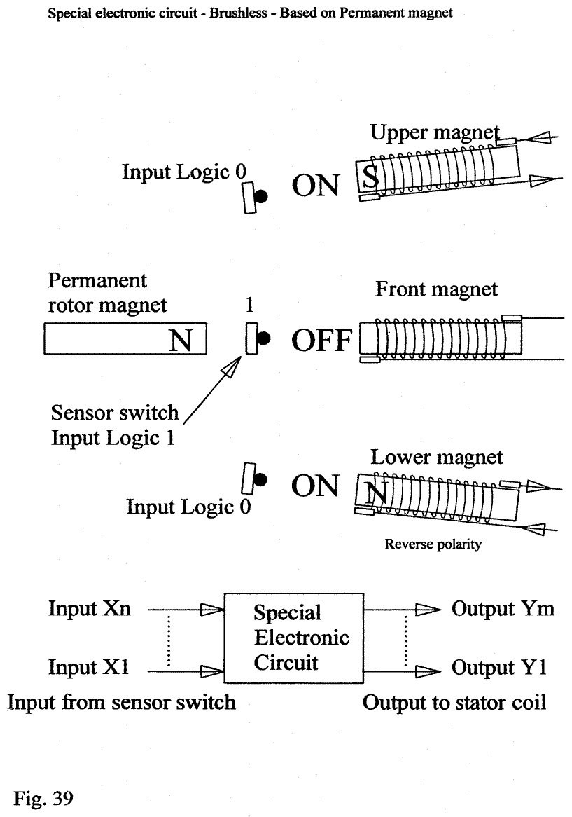

For even more details as shown in FIG. 39.

The special electronic circuit has (Xn) inputs and (Ym) outputs.

Xn inputs come from (sensor switches)

Ym output go to (stator magnets)

Where (m output signals)=2(n input signals)

Because for every (sensor switch) there are two connections for stator coil (Start/End).

When the permanent magnet nearly faces a sensor switch, that switch will send (Logic one) signal to the special electronic circuit and all the remaining sensor switches which are not facing a rotor magnet will send (Logic zero) signal. The electronic circuit will always read the status of all sensor switches and it will send the output to all stator magnets according to the status for every input of (sensor switch) as described above. The sensor switch can be (Magnetic field sensor switch or Laser sensor switch or Light sensor switch or any fast sensor switch).

Supplying the stator magnets with required voltage this will provide the force needed for the rotor magnet along the circular motion to remove the gravity effect along the second-half of circular motion.

For this design the permanent magnet will face variable field strength because all of the stator magnets have different field strength.

Second Type—Based on Rotor Electric Magnet:

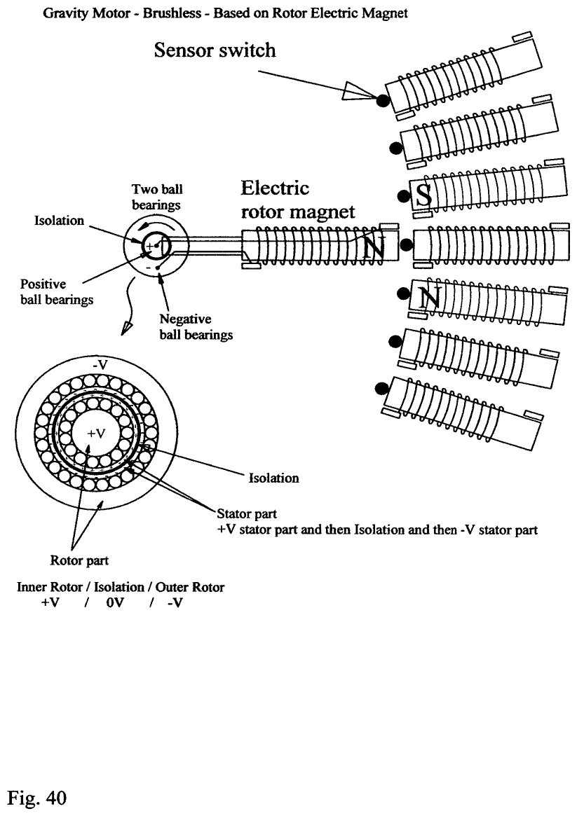

As shown in FIG. 40.

A brushless system—based on rotor electric magnet, so in this case two ball bearings is used. one inside the other and separated by electricity isolation material as shown. Every ball bearing has three parts (Stator part, Middle part, Rotor part).

So, connecting a voltage to the stator part of the ball bearings will cause the voltage to be transferred to the middle part and then the rotor part will receive the same voltage.

Using this principle, the stator part of inner ball bearings is connected to a voltage which will make the rotor part of inner ball bearings to have the same voltage, and the stator part of outer ball bearing is connected to a reverse voltage which will make the rotor part of outer ball bearings to have the same reverse voltage compared to that of the inner ball bearing.

The rotor magnet coil has two nodes (Start and End).

The start node will be connected to the rotor part of the outer ball bearings to get a voltage. and the end node will be connected to the rotor part of the inner ball bearings to get a reverse voltage. in that case the rotor magnet will have electricity along all circular motion without any need for a brush or permanent magnet.

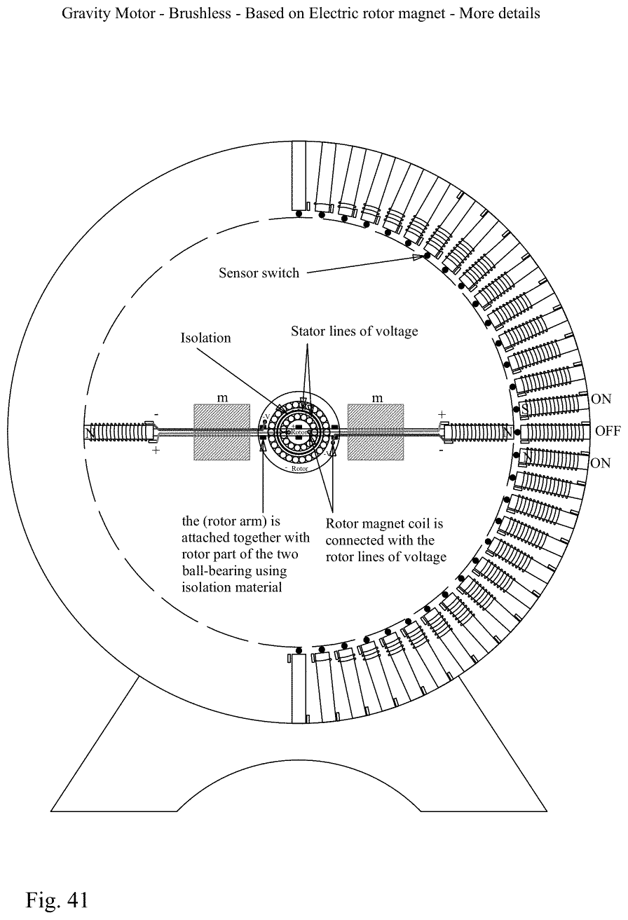

For more details as shown in FIG. 41.

The (inner ball-bearing) is fixed inside the (outer ball-bearing), electricity isolation material between them. the (rotor arm) is attached together with rotor part of the two ball-bearing using isolation material so all will rotate together as one part and the arm will not be affected by voltage of any rotor part of the ball bearings. So, this will remove the gravity effect for the mass along the right-side of circular motion and it will use rotor electric magnet and brushless.

Step 18: (Gain and Power Calculations)

Gain calculations:

For this system there is a force gain, the input force is (Fm) and the output force is (Fg)

$$Force Gain = \frac{Output force}{Input force}$$

$$Force Gain = \frac{Fg}{Fm}$$

$$Force Gain = \frac{Fg}{( \frac{ra}{r} ) Fg}$$

Where

Fg: Generated gravity force=acceleration*mass

ra: mass radius (distance from center of circular motion to mass)

r: rotor magnet radius (distance from center of circular motion to rotor magnet)

$$Force Gain = \frac{r}{ra} \qquad ( 86 )$$

Generated Power Calculations:

Now for power calculations, since the input force is constant then the magnetic force is constant which means the input current is constant therefore, the input power is constant. But the output speed will continue to increase because of gravitational acceleration which will keep the mass to fall down continuously in a circular motion with constant acceleration which will increase the rotational speed continuously with time. this will keep the generated power always to increase with time and it will not stop increasing until we control the output speed using speed controller which in turn will control the generated power.

$$\begin{matrix}Power Generated = \frac{dW}{dt} & ( 87 ) \\ {P}_{g} = \frac{dW}{dt} \\ {P}_{g} = \frac{Fds}{dt} \\ {P}_{g} = Fv & ( 88 )\end{matrix}$$

Now for the generated power calculations for a system free of load

and since the force used is the generated gravity force and velocity for circular path which depends on gravitational acceleration for circular motion then

P_{g}=F_{g}v_{c}

Where

Fg: force due to gravity

v_{c}: linear velocity of circular motion and it is equal to the gravitation acceleration for circular path multiplied by time, for system free of load.

v_{c}=½g_{c}t (89)

Also, it is possible to write the generated power in terms of torque

$${P}_{g} = \frac{{F}_{g} ds}{dt} \\ then \\ {P}_{g} = {F}_{g} \frac{{r}_{a} d θ}{dt} \\ {P}_{g} = {r}_{a} {F}_{g} \frac{d θ}{dt} \\ {P}_{g} = {T}_{g} {ω}_{c} \qquad ( 90 )$$

Where

Tg: is the generated torque

ω_{c}: angular velocity for circular motion and it is equal to angular acceleration for circular motion multiplied by time, for system free of load.

ω_{c}=½α_{c}t (91)

And the values for (g_{c}, α_{c}) can be found from formulas (54, 55) respectively.

So, the generated power after combining formulas (88 and 89) it will be

P_{g}=½F_{g}g_{c}t

P_{g}=½(M_{W}g_{c})g_{c}t

P_{g}=½M_{W}g_{c}²t (92)

For the Power in terms of angular form after combining (90 and 91) it will be

P_{g}=½T_{g}α_{c}t

P_{g}=½(rₐF_{g})α_{c}t

P_{g}=½(rₐ(M_{W}g_{c}))α_{c}t

P_{g}=½(rₐ(M_{W}(rₐα_{c}))α_{c}t

P_{g}=½M_{W}rₐ²α_{c}²t

P_{g}=½I_{W}α_{c}²t (93)

Therefore, from formula (92 or 93) the power generated will increase with time.

So, if the velocity will be constant then this means there is no acceleration then there is no new power generated.

Final generated power=Initial generated power+added generated power (94)

Then from formula (88) the generated power is the generated force times the velocity.

P_{g}=Fv

It is clear that the generated force is equal to (g_{c}) times the mass on the left (M_{W})

F_{g}=M_{W}g_{c} (95)

Then the generated power will be

P_{g}=M_{W}g_{c}v (96)

And in terms of angular velocity

P_{g}=M_{W}g_{c}(rₐω)

P_{g}=M_{W}(rₐα_{c})(rₐω)

P_{g}=α_{c}M_{W}rₐ²ω

P_{g}=α_{c}I_{W}ω (97)

And from formula (90) the generated Torque is

T_{g}=α_{c}I_{W} (98)

If the power is constant for formula (96 and 97) then the (v and ω respectively) are constants. And since it has been increased initially depending upon acceleration which depends on the inertia of the system then from formula (78)

$$α = \frac{{α}_{c}}{2} * \frac{{I}_{WGM}}{{I}_{WGM} + {I}_{G}}$$

And from formula (79)

$$a = \frac{{g}_{c}}{2} * \frac{{I}_{WGM}}{{I}_{WGM} + {I}_{G}}$$

Acceleration for system with load

$$a = \frac{{g}_{c}}{2} \frac{{I}_{W}}{{I}_{W} + {I}_{G}} \qquad ( 99 )$$

Therefore,

Velocity Final=Velocity initial+velocity added (100)

v=vₒ+vₐ (101)

Where (vₐ is the velocity added) depend on the acceleration of the system.

$${v}_{a} = system acceleration * time \\ {v}_{a} = \frac{{g}_{c}}{2} \frac{{I}_{W}}{{I}_{W} + {I}_{G}} * t \qquad ( 102 )$$

For more convenient with angular variables (Vα)

$${v}_{α} = \frac{{r}_{a} {α}_{c}}{2} \frac{{I}_{W}}{{I}_{W} + {I}_{G}} * t \qquad ( 103 )$$

So, formula (96) can be written as below

P_{g}=M_{W}g_{c}v

P_{g}=M_{W}g_{c}(vₒ+vₐ)

If the velocity is increasing with time then the generated power will be

$${P}_{g} = {M}_{W} {g}_{c} ( {v}_{o} + \frac{{g}_{c}}{2} \frac{{I}_{W}}{{I}_{W} + {I}_{G}} * t ) + Q 1 \qquad ( 104 )$$

Where

Q1: this factor is added because of some (plus/minus) values that may depend on the manufactured system and it needs a real measurement for the manufactured system.

Now in terms of angular velocity

ω final=ω initial+ω added (105)

ω=ωₒ+ωₐ (106)

Where (ω_{φ}) depend on the angular acceleration of the system (α).

$$α = \frac{{T}_{g}}{{I}_{W} + {I}_{G}} \qquad ( 107 )$$

Where (Tg) is the generated Torque

$$α = \frac{1}{2} \frac{{α}_{c} {I}_{W}}{{I}_{W} + {I}_{G}} \\ α = \frac{{α}_{c}}{2} \frac{{I}_{W}}{{I}_{W} + {I}_{G}} \qquad ( 108 )$$

Therefore, from (99) and (108)

$$\frac{a}{{g}_{c}} = \frac{α}{{α}_{c}} = \frac{1}{2} \frac{{I}_{W}}{{I}_{W} + {I}_{G}} \qquad ( 109 )$$

Therefore, the final angular velocity will be

$$\begin{matrix}ω = {ω}_{o} + α t & ( 110 ) \\ ω = {ω}_{o} + \frac{{α}_{c}}{2} \frac{{I}_{W}}{{I}_{W} + {I}_{G}} t & ( 111 )\end{matrix}$$

So, the generated power from formula (97) in angular form

$${P}_{g} = {α}_{c} {I}_{W} ω \\ {P}_{g} = {α}_{c} {I}_{W} ( {ω}_{o} + {ω}_{α} ) \\ {P}_{g} = {α}_{c} {I}_{W} ( {ω}_{o} + \frac{{α}_{c}}{2} \frac{{I}_{W}}{{I}_{W} + {I}_{G}} t ) + Q 1 \qquad ( 112 )$$

Where

Q1: this factor is added because of some (plus/minus) values that may depend on the manufactured system and it needs a real measurement for the manufactured system.

Now to calculate the input power:

First of all, we have to find the equivalent circuit to the total stator magnets and rotor magnets.

And since the generated force on the right-side due to gravity is equal to the lifting force on the right-side due to magnets. So, it is possible to draw an equivalent circuit for magnets and the total electrical current used for all of them.

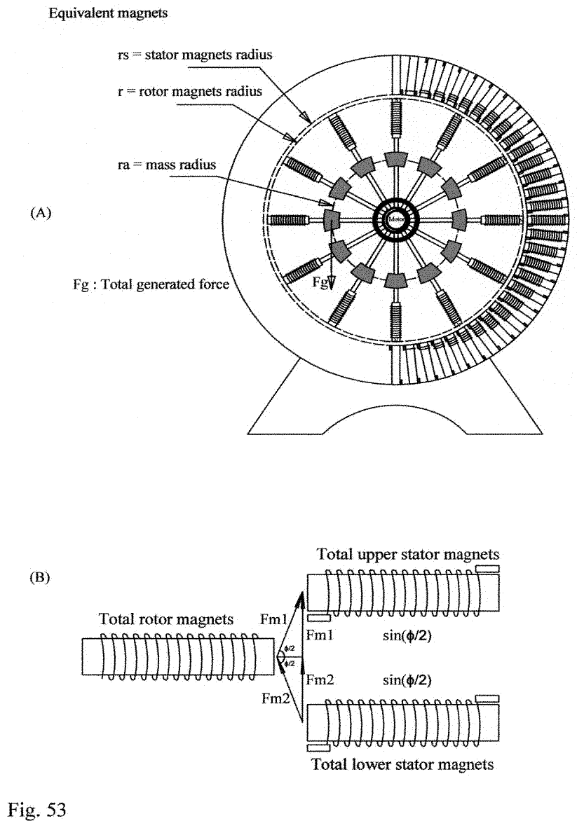

As shown in FIG. 53.

Part (A) shows the WGM motor with stator coils and the rotor coils and the force generated.

Part (B) shows the equivalent circuit for the stator coils and rotor coils.

Knowing that from formula (6) the total generated magnetic force

$${F}_{m} = - \frac{{r}_{a}}{r} {F}_{g}$$

$$Where {F}_{g} = - {g}_{c} {M}_{W}$$

$$Then {F}_{m} = \frac{{r}_{a}}{r} {g}_{c} {M}_{W}$$

And since there are three magnets running (rotor, two stator). So, there are two magnetic forces From formula (31)

Fm=Fm1+Fm2

Fm1: is the total magnetic force between rotor and upper stator magnets

Fm2: is the total magnetic force between rotor and lower stator magnets

And from formula (35)

$$Fm = \frac{( N rotor * S stator )}{{da}^{2}} sin {ϕ}_{a} + \frac{( N rotor * S stator )}{{db}^{2}} sin {ϕ}_{b}$$

Now for the equivalent electrical circuit.

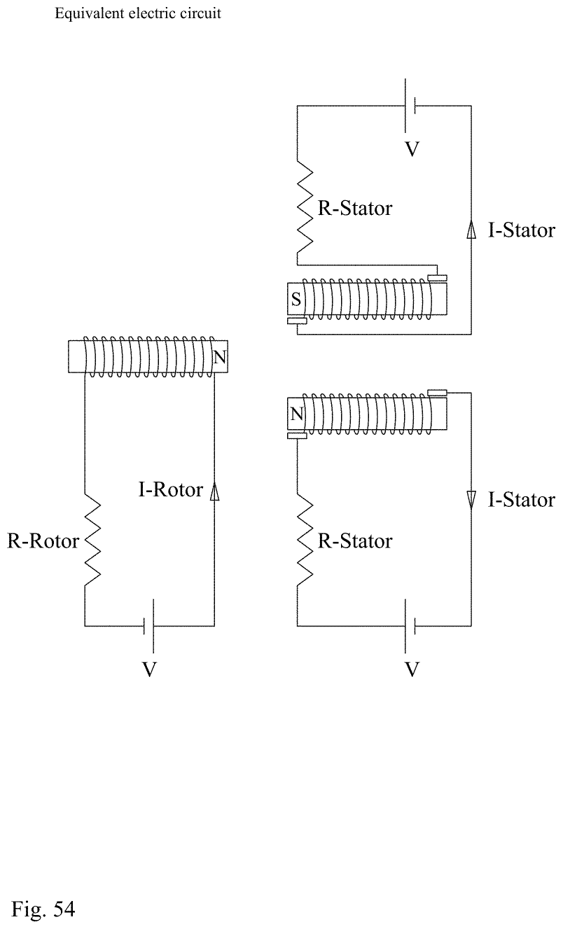

As shown in FIG. 54.

And for easier calculations assuming (Nstator=Sstator=Nrotor=N) and (φa=φb=φ/2) and (da=db=d)

So, the above formula will be

$$Fm = \frac{( {N}^{2} )}{{d}^{2}} sin ( \frac{ϕ}{2} ) + \frac{( {N}^{2} )}{{d}^{2}} sin ( \frac{ϕ}{2} )$$

$$Fm = 2 \frac{( {N}^{2} )}{{d}^{2}} sin ( \frac{ϕ}{2} )$$

Substitute Fm we get

$$\frac{{r}_{a}}{r} {g}_{c} {M}_{W} = 2 \frac{( {N}^{2} )}{{d}^{2}} sin ( \frac{ϕ}{2} )$$

Solving for (N) we get

$$N = d \sqrt{\frac{{r}_{a} {g}_{c} {M}_{W}}{2 r sin ( \frac{ϕ}{2} )}}$$

And since

N=Φ=nI

Where

Φ: Flux in weber

n: number of coil turns

I: current

Then

$$I = \frac{d}{n} \sqrt{\frac{{r}_{a} {g}_{c} {M}_{W}}{2 r sin ( \frac{ϕ}{2} )}} \qquad ( 113 )$$

Therefore, the power for one equivalent magnet will be

Pₘ=I²R (114)

Where

Pm: power for one magnet

I: is the current.

R: is the resistor.

Therefore, for 3 magnets the estimated power consumed will be

P=3I²R+Q2 (115)

Where

Q2: this factor is added because of some (plus/minus) values that may depend on the manufactured system and it needs a real measurement for the manufactured system.

Now to find the output power

$$\begin{matrix}Output power = generated power - consumed power & ( 116 ) \\ P = {P}_{g} - {P}_{m} & ( 117 ) \\ P = ( {M}_{W} {g}_{c} ( {v}_{o} + {g}_{c} * \frac{{I}_{W}}{{I}_{W} + {I}_{G}} * t ) + Q 1 ) - ( 3 {I}^{2} R + Q 2 ) & \end{matrix}$$

Substitute value of I from (113)

$$P = ( {M}_{W} {g}_{c} ( {v}_{o} + \frac{{g}_{2}}{2} \frac{{I}_{W}}{{I}_{W} + {I}_{G}} * t ) + Q 1 ) - ( 3 {( \frac{d}{n} \sqrt{\frac{{r}_{a} {g}_{c} {M}_{W}}{2 r sin ( \frac{ϕ}{2} )}} )}^{2} R + Q 2 )$$

Where

d: distance between (stator magnet radius and rotor magnet radius)

n: is the number of coil turns.

ra: mass radius

r: rotor magnet radius

R: resistor

Q1: added factor as stated in formula (104)

Q2: added factor as stated in formula (115)

$$P = ( {M}_{W} {g}_{c} ( {v}_{o} + \frac{{g}_{c}}{2} \frac{{I}_{W}}{{I}_{W} + {I}_{G}} * t ) ) - ( 3 {( \frac{d}{n} \sqrt{\frac{{r}_{a} {g}_{c} {M}_{W}}{2 r sin ( \frac{ϕ}{2} )}} )}^{2} R ) + Q \qquad ( 118 )$$

Where

Q: is equal to Q1−Q2

Therefore, with time the generated power will exceeds the consumed power and there will be output generated power much larger than the input consumed power which will give the system the ability to continue to supply itself with the required power. And to generate the required power for the benefit of people.

Now to calculate the time required to start getting output power from the system.

Solving formula (118) for (t) where output power is equal to (zero) because the generated power is equal to the consumed power. Assuming no load to the system.

$$( {M}_{W} {g}_{c} ( {v}_{o} + \frac{{g}_{c}}{2} * \frac{{I}_{W}}{{I}_{W} + {I}_{G}} * t ) ) = ( 3 {( \frac{d}{n} \sqrt{\frac{{r}_{a} {g}_{c} {M}_{W}}{2 r sin ( \frac{ϕ}{2} )}} )}^{2} R ) + Q \\ {M}_{W} \frac{{g}_{c}^{2}}{2} * \frac{{I}_{W}}{{I}_{W} + {I}_{G}} * t = ( 3 {( \frac{d}{n} )}^{2} \frac{{r}_{a} {g}_{c} {M}_{W}}{2 r sin ( \frac{ϕ}{2} )} R ) - {M}_{W} {g}_{c} {v}_{o} + Q \\ t = \frac{( 3 {( \frac{d}{n} )}^{2} \frac{{r}_{a} {g}_{c} {M}_{W}}{2 r sin ( \frac{ϕ}{2} )} R ) - {M}_{W} {g}_{c} {v}_{o} + Q}{{M}_{W} \frac{{g}_{c}^{2}}{2} * \frac{{I}_{W}}{{I}_{W} + {I}_{G}}} \\ t = \frac{{g}_{c} {M}_{W} ( ( \frac{3}{2} {( \frac{d}{n} )}^{2} \frac{{r}_{a}}{r sin ( \frac{ϕ}{2} )} R ) - {v}_{o} ) + Q}{{M}_{W} \frac{{g}_{c}^{2}}{2} * \frac{{I}_{W}}{{I}_{W} + {I}_{G}}} \qquad ( 119 )$$

So, this will be the estimate time required before start getting output power

Step 19: (Increasing the Generated Torque)

To increase the output generated torque the system output must be connected to a larger gear using chain or belt or gears to get more torque, and since the speed will continue to increase then it will be possible to get the required large output torque and power. then taking small amount of power to feedback the input with power required to continue operating the system.

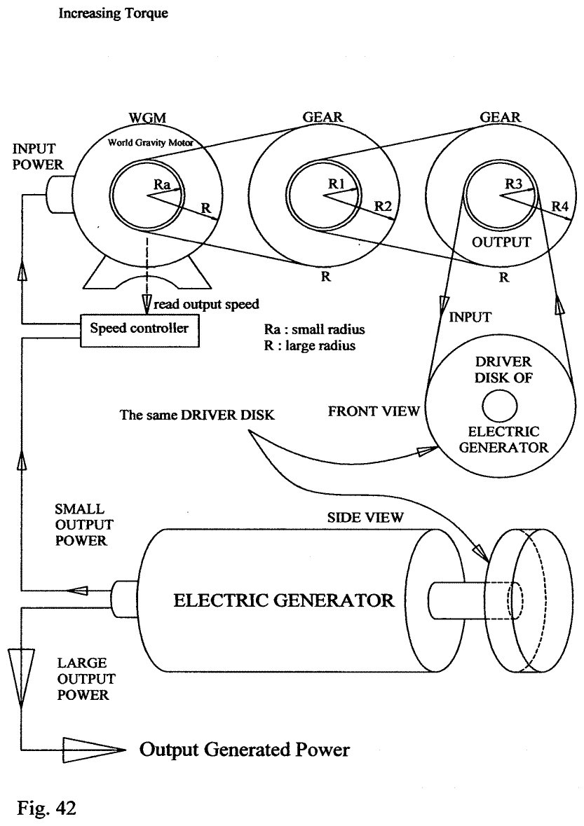

As shown in FIG. 42.

The electric generator will generate the required small amount of power for the operation of (WGM), the output power will be sent to (Speed controller) the speed controller will read the output speed of (WGM) to check if it has less or more speed than the required speed. According to that information the speed controller will decide to increase or decrease the input power of (WGM). The output of (WGM) is connected to larger gears by chain or belt or gears as shown in the figure to get larger torque. The output of the gear will be connected to the driving disk of the electric generator which will provide the generator with the torque required to run and to produce large amount of power. Small amount of this power will be sent back again to the speed controller to repeat the cycle of generating the power. The other Large amount of the generated power will be connected to the load required (for example a city) to give the people the required electricity they need. And as stated in the FIG. 42.

Step 20: (WGM Array)

Now it is the time to divide the WGM from one large motor into several smaller WGM motors or array of motors.

Assuming that the total Inertia is still the same as for the large WGM.

So, if there are (J) WGMs then the total inertia will be

Total Inertia of J WGMs=Inertia of one large WGM (120)

And since for full load the inertia of one large WGM must equal to inertia of electric generator From formula (81)

I_{W}=I_{G}

Therefore,

JI_{wgm}=I_{W} (121)

Where (I_{wgm}=Inertia of one small WGM, and I_{W}=Inertia of one Large WGM) now from formula (99)

$$a = \frac{{g}_{c}}{2} \frac{{I}_{W}}{{I}_{W} + {I}_{G}}$$

Substitute (121) into (99), the linear format for acceleration will be

$$a = \frac{{g}_{c}}{2} \frac{{JI}_{wgm}}{{JI}_{wgm} + {I}_{G}} \qquad ( 122 )$$

And the angular format for acceleration

$$α = \frac{{α}_{c}}{2} \frac{{JI}_{wgm}}{{JI}_{wgm} + {I}_{G}} \qquad ( 123 )$$

Now to find the mass for every WGM

$${I}_{wgm} = \frac{{I}_{W}}{J}$$

Since inertia of one WGM is (I_{wgm}=M_{wgm} rₐ²) and (J I_{wgm}=I_{G})

Where (M_{wgm}=Mass of one small WGM), therefore

JM_{wgm}rₐ²=I_{G}

Then the mass for every WGM using (ra) as mass radius will be

$${M}_{wgm} = \frac{{I}_{G}}{{Jr}_{a}^{2}} \qquad ( 124 )$$

So, if the WGM has (Z) arms then the mass per arm will be

$$m = \frac{{M}_{wgm}}{Z} \qquad ( 125 )$$

And if it is required to change mass radius to get the required inertia, then solving formula (124) for (ra)

$${r}_{a} = \sqrt{\frac{{I}_{G}}{{JM}_{wgm}}} \qquad ( 126 )$$

Where

ra: mass radius of WGM.

I: inertia of Electric Generator or load.

Mwgm: mass of rotor part for one WGM.

J: number of WGM in array.

And for more accurate result for the mass per arm, the inertia of one WGM is

I_{wgm}=Iₘₐₛₛₑₛ+Iₐᵣₘₛ (127)

Therefore, the inertia of rotating masses

$$\begin{matrix}{I}_{masses} = {I}_{wgm} - {I}_{arms} & ( 128 ) \\ Mass per arm = \frac{{I}_{wgm} - {I}_{arms}}{{Zr}_{a}^{2}} & ( 129 )\end{matrix}$$

Where Z is the number of arms

Types of array:

There are more than three types to divide one large WGM into array of small WGMs.

One-dimensional array

Two-dimensional array

Three-dimensional array

More than Three-dimensional array

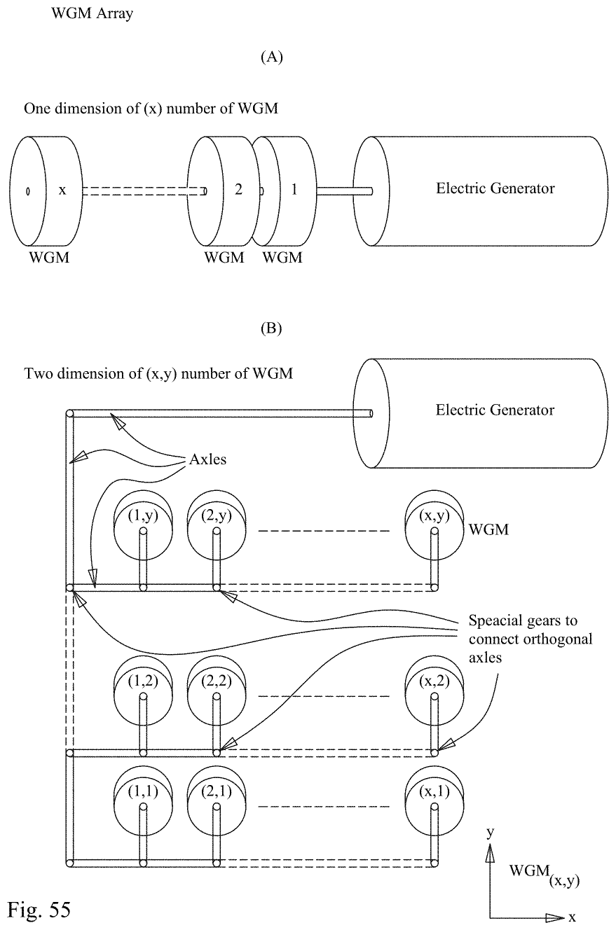

As shown in FIG. 55.

Part (A) shows one-dimensional array of small WGMs connected to one Electric Generator.

Part (B) shows two-dimensional array of small WGMs connected to one Electric Generator.

One Dimensional Array:

the output of all WGMs are connected to one axle and they are facing each other and the output is connected to electrical generator. This type of array will be easier for installation.

Two-Dimensional Array:

the WGMs are placed along (y) rows and (x) columns, they are not facing each other. in every row the output of each WGM (axle) is connected to the same row (axle) through special gears that can connect orthogonal axles. Then the output of all row's axles is connected to one main Axle then the main axle is connected to electrical generator.

This type of array will be easier for managing every WGM separately because it will not affect for the work of the entire array of other WGMs.

Three-Dimensional Array:

The three-dimensional array will be (x, y, z) of WGMs. but this needs a special place and care for the 3D array of WGMs. And it can be inside a building that have several floors. And each floor has several rows of rooms and each room have WGM. Then the main output is connected to Electrical Generator to produce electricity needed by gravity force.

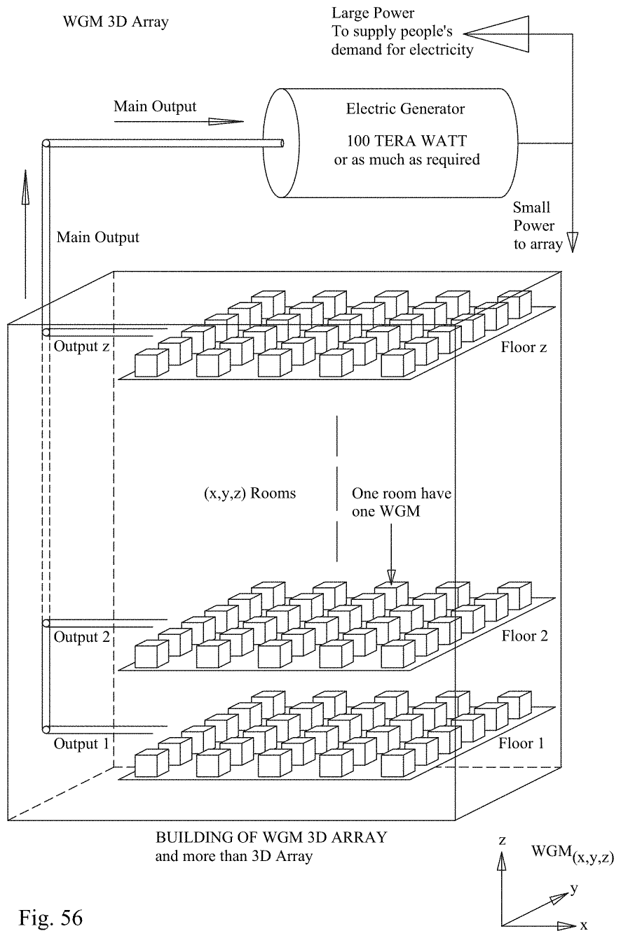

As shown in FIG. 56.

More than Three-Dimensional Array:

For more than 3D Arrays of WGMs then just adding more than one WGM per room. This is just like merging several buildings of WGM 3D Array together into one building. And it is possible to make for every room one-dimensional array of WGMs.

And a lot of array designs can be derived from the mentioned above array types.

All types of the arrays are controlled (Manually and/or Automatically), therefore a special system controller used to control all gravity motors and electric generators (live and/or online) and it can be controlled remotely and by computers also to monitor everything online.

The system controller controls also the position of every mass along every rotor arm for every gravity motor in the system, and it can monitor everything happening and send alerts to the management team and system administrator and for the working team.

Explaining the New Law in Physics:

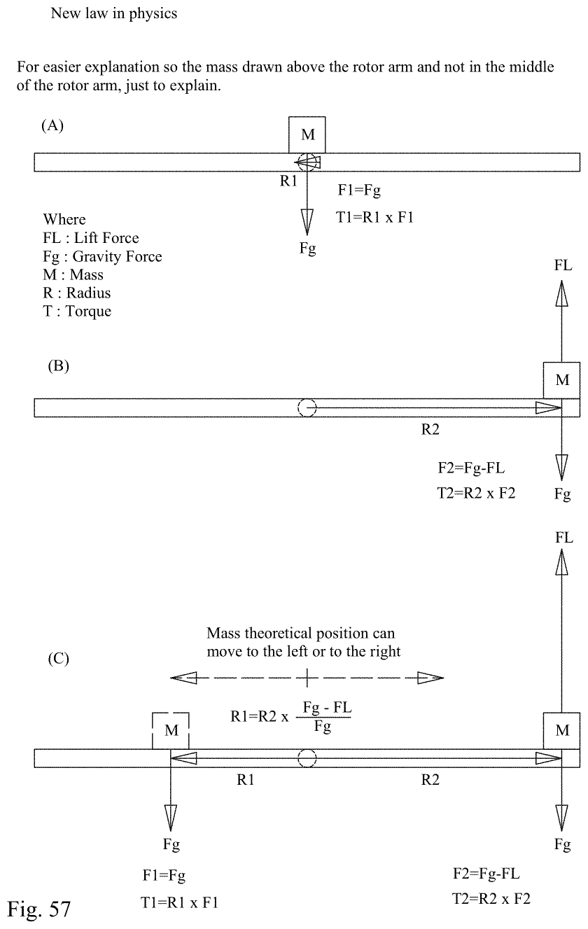

As shown in FIG. 57.

Part (A), shows a rotor arm having center of rotation and a mass (M) fixed at the center of rotor arm, it has a radius R1 and (R1=0), there is a force on the mass equal to F1 and (F1∜0) and F1=Fg (Gravity force), there is a Torque equal to T1.

T1=R1×F1

T1=R1×Fg

T1=0×Fg

T1=0

So, there is zero torque on Mass

Part (B), shows the same rotor arm, but now the mass fixed at the end of rotor arm, it has a radius R2 and (R2≠0), there is a force on the mass equal to F2 and F2 is the sum of two forces F_{g} (Gravity force)−FL (Lift force), where (FL=Fg), there is a Torque equal to T2.

T2=R2×F2

T2=R2×(F_{g}−FL)

Since FL=Fg therefore

T2=R2×(Fg−Fg)

T2=R2x0

T2=0

So, there is zero torque on Mass also.

And since T1=0 and T2=0 therefore T1=T2, and that's why (T1) can be represented as the (Theoretical equivalent) of the Torque (T2) and it is in the same direction of rotation for (T2)

$$R 1 \times F 1 = R 2 \times F 2 \\ R 1 \times Fg = R 2 \times ( Fg - FL ) \\ R 1 = R 2 \times \frac{( Fg - FL )}{Fg} \qquad ( 130 )$$

Part (C) shows the mass theoretical position.

So, if the (Lift force FL) is larger than (Gravity force Fg) or (FL>Fg) this means the mass is shifted theoretically to the left-side by R1 so the force Fg and R1 will generate the same Torque by R2 and (F_{g}−FL).

And if (FL=Fg) this means the mass is shifted theoretically to the center of circular motion because R1=0 so the force Fg and R1 will generate the same Torque also.

And if (FL<Fg) this means the mass is shifted theoretically to the right-side by R1 so the force Fg and R1 will generate the same Torque by R2 and (Fg—FL)

And if (FL<0) so it means (FL is in the direction of Fg) and this means the mass is shifted theoretically far a way to the right-side by radius R1, so the force Fg and R1 will generate the same Torque.

And since the Torque is the radius multiplied by the Force, then as shown in Formula (130) the radius R1 depend on the [{Radius R2} multiplied by the {Force (Fg−FL)/Fg} ] which is the Torque. Therefore, as stated by the new law in physics the position can be changed theoretically by changing the Torque.

Now for the inertia calculation and since the position is changed theoretically so to calculate the inertia then this will lead to a new theory in physics and I will call it the “THEORETICAL EQUIVALENCE THEORY”

Theoretical Equivalence Theory:

“In a field of force affecting on a mass fixed on rotor arm generating a Torque, it is possible to represent The Physical System by Theoretical Equivalent System using the same field of force to be the only force and with equal mass and equal Torque, and vice versa”.

This theory for a field of force affecting on a mass fixed on rotor arm generating a torque. It can represent the values of the physical quantities (Torque, Radius, Inertia, Angular acceleration, Linear acceleration, Angular velocity, Linear velocity) by “Theoretical Equivalent” quantities.

As shown in FIG. 57.

Part (A), shows a physical system having field of force denoted as “F_{f}” and a rotor arm having radius “R” and a mass “M” fixed at “R” distance from the center of rotation and a force denoted as “Fₓ” applied on the mass in a reverse direction to that of the “field of force” so this will make the total force affecting on the mass “F=Ff−FX” and it have a Torque=T, the linear acceleration denoted as “a” and the angular acceleration denoted as “α”, the angular velocity denoted as “ω” and the linear velocity denoted as “v”, and finally the inertia denoted as “I”.

Part (A) also shows another “Theoretical Equivalent System” on the same field of force where this field of force is the only force affecting on this system, so the “Theoretical force=Force of field” denoted as “Fₜₕ=F_{f}” and having “Theoretical Radius=Rₜₕ”, and the same mass so Theoretical mass “Mₜₕ=M” and having a Theoretical Torque “Tₜₕ=T”, and Theoretical acceleration denoted as “aₜₕ”, and Theoretical angular acceleration denoted as “αₜₕ”, and Theoretical angular velocity denoted as “vₜₕ” and Theoretical angular speed denoted as “ωₜₕ”, and finally the Theoretical inertia denoted as “Iₜₕ”.

So, now starting to write The Theoretical Equivalent System formulas

Tₜₕ=T (131)

Tₜₕ=RₜₕFₜₕ (132)

Since by definition the field of force is the only force so the theoretical force=force of field

Fₜₕ=F_{f}

Therefore,

Tₜₕ=RₜₕF_{f} (133)

And since the Torque of physical system equal to

T=RF

And the total applied force is against the force of the field therefore

T=R(F_{f}−Fₓ) (134)

Substitute (132) and (134) into (131) we get

RₜₕF_{f}=R(F_{f}−Fₓ)

Therefore, The Theoretical Equivalent radius is

$${R}_{t h} = R \frac{( {F}_{f} - {F}_{x} )}{{F}_{f}} \qquad ( 135 )$$

And to find the Theoretical equivalent inertia for the mentioned drawing in FIG. 57.

Iₜₕ=MRₜₕ² (136)

Substitute (135) into (136)

$${I}_{th} = {M [ R \frac{( {F}_{f} - {F}_{x} )}{{F}_{f}} ]}^{2} \\ {I}_{t h} = M {{R}^{2} [ \frac{( {F}_{f} - {F}_{x} )}{{F}_{f}} ]}^{2}$$

Theoretical Equivalent Inertia

$$\begin{matrix}{I}_{th} = {I [ \frac{( {F}_{f} - {F}_{x} )}{{F}_{f}} ]}^{2} & ( 137 ) \\ {T}_{th} = {α}_{th} {I}_{th} & ( 138 )\end{matrix}$$

Therefore, substitute (138) into formula (131)

$${α}_{th} {I}_{th} = α I \\ {α}_{th} = α \frac{I}{{I}_{th}} \qquad ( 139 )$$

Substitute (137) into (139) we get

$${α}_{th} = α \frac{I}{{I [ \frac{( {F}_{f} - {F}_{x} )}{{F}_{f}} ]}^{2}}$$

The Theoretical Equivalent Angular acceleration

$${α}_{th} = {α [ \frac{( {F}_{f} - {F}_{x} )}{{F}_{f}} ]}^{- 2} \qquad ( 140 )$$

The Theoretical Equivalent Angular acceleration

$${a}_{th} = {R}_{th} {α}_{th} \\ {a}_{th} = R \frac{( {F}_{f} - {F}_{x} )}{{F}_{f}} {α [ \frac{( {F}_{f} - {F}_{x} )}{{F}_{f}} ]}^{- 2} \\ {a}_{th} = R {α [ \frac{( {F}_{f} - {F}_{x} )}{{F}_{f}} ]}^{- 1} \qquad ( 141 )$$

Since “Rα” is the linear physical acceleration “a” therefore

$${a}_{th} = {a [ \frac{( {F}_{f} - {F}_{x} )}{{F}_{f}} ]}^{- 1} \qquad ( 142 )$$

The Theoretical Equivalent Linear velocity

vₜₕ=aₜₕt (143)

Where velocity is equal to the acceleration multiplied by time

Substitute (142) into (143) we get

$${v}_{th} = {a [ \frac{( {F}_{f} - {F}_{x} )}{{F}_{f}} ]}^{- 1} t$$

And since “a=v/t” therefore

$${v}_{th} = {v [ \frac{( {F}_{f} - {F}_{x} )}{{F}_{f}} ]}^{- 1} \qquad ( 144 )$$

The Theoretical equivalent for angular velocity

ωₜₕ=αₜₕt (145)

Substitute (140) into (145) we get

$${ω}_{th} = {α [ \frac{( {F}_{f} - {F}_{x} )}{{F}_{f}} ]}^{- 2} t$$

And since “α=ω/t” therefore

$${ω}_{th} = {ω [ \frac{( {F}_{f} - {F}_{x} )}{{F}_{f}} ]}^{- 2} \qquad ( 146 )$$

So, this will be The Theoretical Equivalent System for the physical system.

Now for more easier calculations assuming the force applied “Fₓ” is denoted as a percentage of the field of force “F_{f}”

Fₓ=hF_{f} (147)

Where

h: is a percentage value i.e. if the percentage is “50%” so “h” will be (0.5) or “25%” it will be (0.25) or “150%” it will be (1.5) and so on.

Therefore, it is possible to rearrange the theoretical equivalent formulas to the new form

$$[ \frac{( {F}_{f} - {F}_{x} )}{{F}_{f}} ] = [ \frac{( {F}_{f} - h {F}_{f} )}{{F}_{f}} ] = [ \frac{{F}_{f} ( 1 - h )}{{F}_{f}} ] = [ \frac{( 1 - h )}{1} ] \\ ( 1 - h ) = [ \frac{( {F}_{f} - {F}_{x} )}{{F}_{f}} ] \qquad ( 148 )$$

Therefore, to find the new form of The Theoretical Equivalent formulas depend on a percentage value “h” for the field of force “F_{f}” from formula (147), Substitute (148) into theoretical equivalent formulas we get

The Theoretical Equivalent Radius

Rₜₕ=R(1−h) (149)

The Theoretical Equivalent Inertia

Iₜₕ=I(1−h)² (150)

The Theoretical Equivalent Angular acceleration

αₜₕ=α(1−h)⁻² (151)

The Theoretical Equivalent Linear acceleration

aₜₕ=a(1−h)⁻¹ (152)

The Theoretical Equivalent Linear velocity

vₜₕ=v(1−h)⁻¹ (153)

The Theoretical Equivalent Angular velocity

ωₜₕ=ω(1−h)⁻² (154)

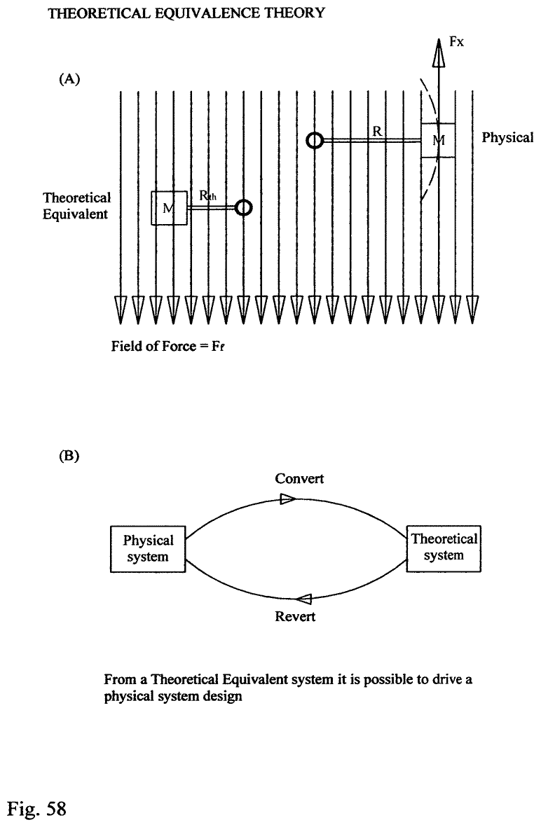

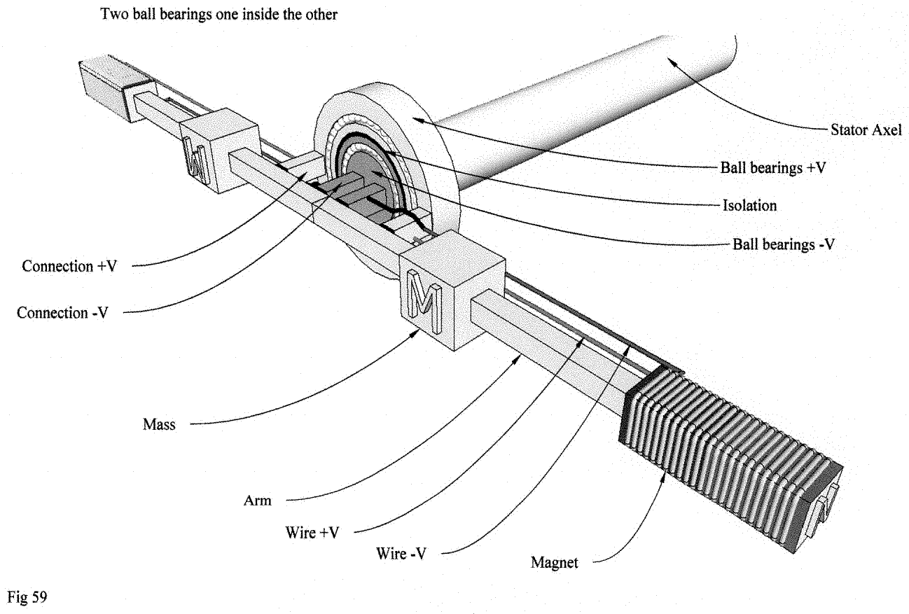

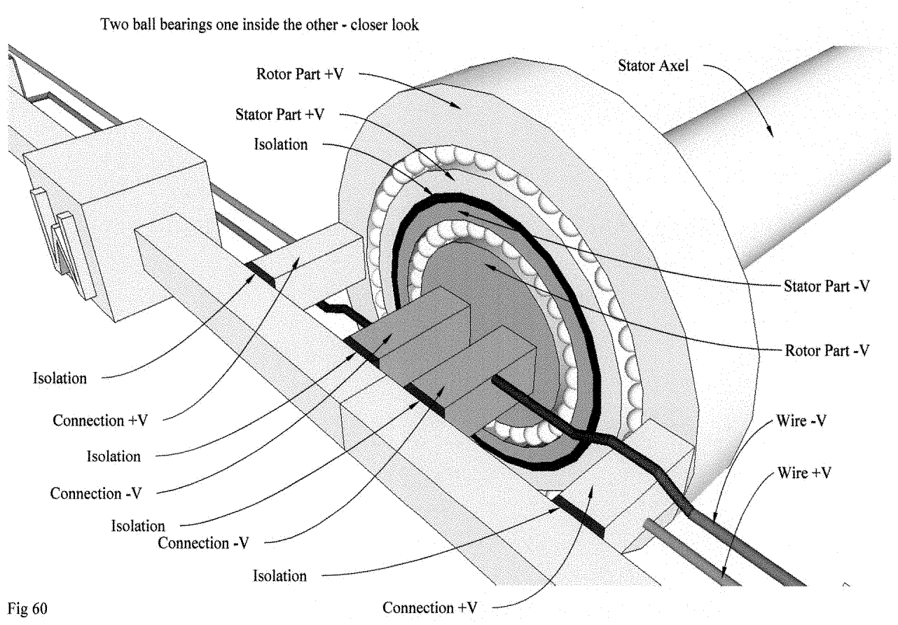

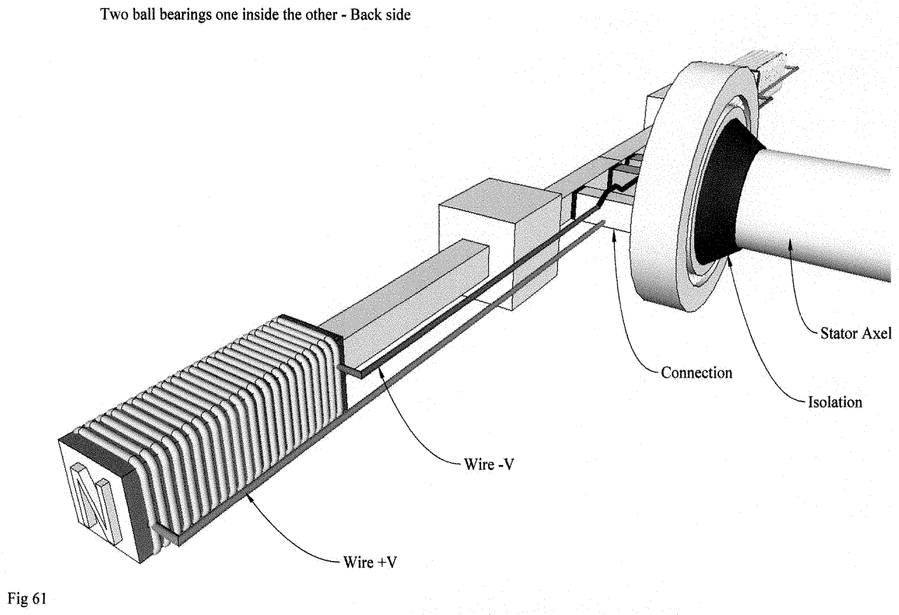

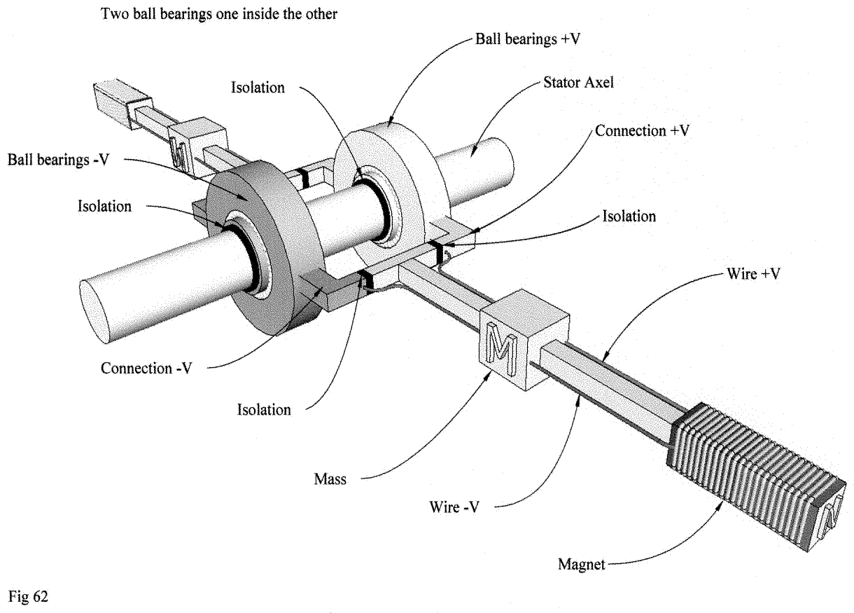

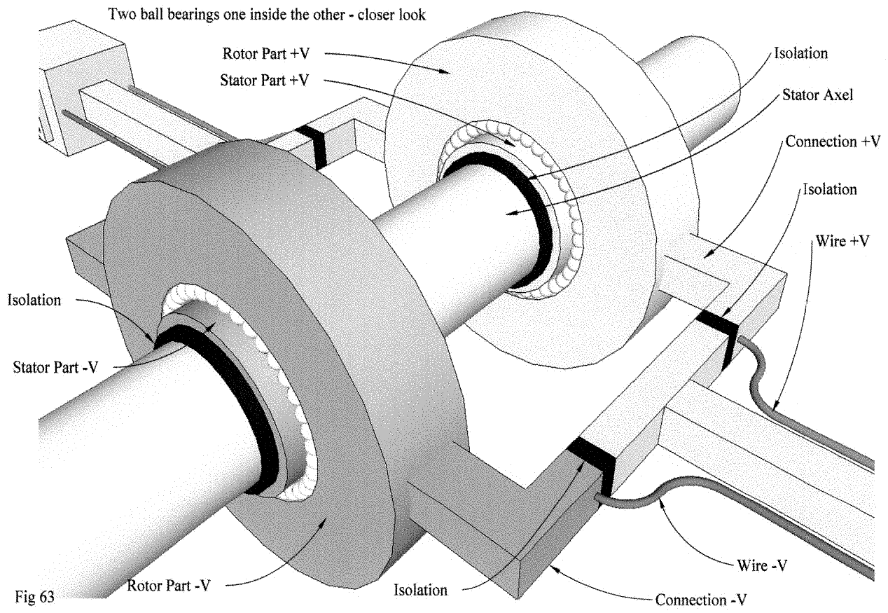

From now on, it will be much easier to draw the theoretical equivalent system with the help of percentage value. And FIG. 58. Part (B), shows how a physical design can be converted to the theoretical equivalent system, and also how it is possible to revert the theoretical equivalent system to Physical System using the formulas (149 to 154) to find (R, I, φ, a, v, ω).

Now if there is no physical system and we make a theoretical system that have field of force and applied force then we can make an equivalent real Physical System that have only field of force as the only force, so for example if the rotor arm in a theoretical system affected by two forces “Force of field” and applied force “Fy” then we use the same method to find the real radius.

$$R = {R}_{th} \frac{{F}_{f} - {F}_{y}}{{F}_{f}}$$

All other factors (I, ω, α, v, a) also can be found using the above method.

So, several theoretical equivalence systems can be derived using more methods, it is possible to use equal Torque and equal Inertia to get different Theoretical Equivalent mass, and so on.

1—A gravity motor comprising:
New law in physics: “In a field of force affecting on a mass fixed on rotor arm generating a torque, it is possible to change the position of the mass or part of that mass (Theoretically) by changing the torque”
New constant in physics: Gravitational acceleration in Circular path denoted as “g_{c}” where
$$( {g}_{c} = \frac{2}{π} g )$$
and (g) is the gravitational acceleration for a field of force
Rotor part: It has a circular motion, the circular motion is divided in to two halves, the first-half of circular motion or left-side of circular motion and the second-half of circular motion or right-side of circular motion, where the first-half contains gravity effect and the second-half contains a controlled gravity effect, the controlled gravity effect can be zero gravity and it can be positive or negative gravity, It contains also one or more than one arm, the arm can start from the center of circular motion and it can end at the end of rotor part (circumference), each arm can hold a mass at a distance from the center of circular motion to generate a torque by gravity for the first-half of circular motion, the rotor part has also a magnet fixed at the end of every arm, the magnets are used for the second-half of circular motion to generate a torque equal in magnitude and reverse in direction to the torque generated by gravity for the second-half of circular motion, so this will change the position of every mass (Theoretically) on the second-half of circular motion because of the new law in physics, and since the sum of both torques will result a zero torque so every mass will be shifted (Theoretically) to the center of circular motion along the second-half of circular motion and this will remove the gravity effect on the second-half of circular motion and it will make an unbalanced forces between the first-half and the second-half of circular motion continuously as much as required, which will make the mass on the first-half of circular motion to keep falling down which will rotate the gravity motor faster and faster, and by controlling the magnet strength and polarity it will be possible to control the gravity effect on the second-half of circular motion, and it will be possible to control the position of the masses (Theoretically), so the mass will be shifted (Theoretically) to the center of circular motion on the second-half of circular motion which will remove the gravity effect whereas it will remain in its position for the first-half of circular motion which will generate a torque by gravity for the first-half of circular motion, the rotor part has also the ability to control the physical position of every mass on the rotor part either by manually positioning the mass or by a positioning motor or more than one positioning motor as desired to control the distance between the center of circular motion and the mass on the rotor part. For when the distance between the center of circular motion and the mass is less than the distance between the center of circular motion and the magnet at the end of the arm this will makes the magnetic force used less than the lift force required to remove the gravity effect which will generate gain in force which will produce a continuous force
Stator part: It contains a fixed magnets along the second-half of circular motion to generate a torque with the help of magnets and Levers so the torque will affect the rotating mass, and as per the new law in physics to shift the mass on the second-half of circular motion to the center of circular motion then an equal torque must be applied on the mass equal to the torque generated by gravity, the generated torque by magnets is against the generated torque by gravity which will shift the mass on the second-half of circular motion (Theoretically) to the center of circular motion as per the new law in physics which will remove the gravity effect on the second-half of circular motion, and this will make the mass or any mass enters the first-half of circular motion to fall down in circular motion with a constant acceleration, and this acceleration in turn has a new constant in physics denoted as “g_{c}” which is the “Gravitational acceleration in Circular path”, where
$$( {g}_{c} = \frac{2}{π} g )$$
and (g) is the gravitational acceleration for a field of force, and on earth the value of g=9.8, so in turn g_{c}=6.24, which is a new constant in physics.
Electric circuit for Rotor magnet: it has three types (first type based on brush to supply rotor magnet with electricity, second type based on brushless system (two ball bearings) to supply rotor magnet with electricity, third type based on non-electric permanent magnet}
Electric circuit for Stator magnet: it has two types (first type based on variable number of coils turns, second type based on constant number of coils turns)
Field strength for rotor magnet: it has two types (first type based on constant field strength; second type based on variable field strength) both types govern by “The resultant total magnetic field”
Field strength for stator magnet: it has two types (first type based on variable field strength; second type based on constant field strength) both types govern by “The resultant total magnetic field”
The resultant total magnetic field: it has two types (first type combines constant field strength for rotor magnets and variable field strength for stator magnets, second type combines variable field strength for rotor magnets and constant field strength for stator magnets)
Positioning motor: it controls the physical position of the mass on the rotor arm, where a special screw passing through the mass and fixed to rotor arm, the special screw direction of rotation is controlled by the positioning motor, they are connected together by gears and/or belt, which will control the physical position of the mass on the rotor arm, for when the positioning motor rotates clockwise or counter clockwise direction this will rotates the special screw in the same direction which in turn shifts the mass toward the center of circular motion or outward from the center of circular motion, and a path holder is fixed on the two sides of the mass along the moving path to prevent the mass rotation around itself when the special screw starts rotating, so at start up the mass can be shifted physically near to the rotor magnet or (circumference of rotor part), then after the gravity motor starts rotating the masses physical position will help to build angular momentum, then by shifting the masses near to center of circular motion this will increase the angular speed of the gravity motor, so if an electric generator was connected to the gravity motor this will increase the speed of rotation for electric generator which will help to increase the output power of electric generator in a faster time
Brush system for rotor magnet: it has a brush board fixed at the beginning of every rotor arm; the brush board contains several brushes to make several connections at the same time. some brushes will connect the rotor magnet with electricity lines along the second-half of circular motion or around the full path of circular motion as desired, and another brushes used to make a connection for the stator magnets with electricity because the start and end of the stator magnet coil is connected with internal nodes near to the center of circular motion for when the brush touches a specific internal node and touches the line of electricity at the same time, this will give the specific internal node electricity which will be sent to the specific stator magnet, so all of the internal nodes are arranged in such a way that when the rotor magnet faces a stator magnet, the lower stator magnet starts to work or the upper stator magnet start to work or both the upper stator magnet and lower stator magnet start to work together, according to the design required, so several designs can be derived.
Brushless system for rotor magnet based on electricity: the center of the rotor part for this system has two ball bearings one inside the other, and there is electricity isolation material between them, every ball bearing has three parts (stator part and middle part and rotor part), the stator part of the inner ball bearing will be connected to voltage line always, this will give the middle part of the ball bearings the same voltage and then the rotor part will receive the same voltage, the stator part of the outer ball bearing will be connected to a reverse voltage to that of the inner ball bearing, this will give the middle part the same reverse voltage and then the rotor part will receive the same reverse voltage to that of the inner ball bearings, so every ball bearings will have a different voltage, one end of the rotor magnet coil will be connected to the rotor part of the inner ball bearing and the other end of the rotor magnet coil will be connected to the rotor part of the outer ball bearing, this will supply the rotor magnet with required voltage to run along the circular path with a constant voltage, so the rotor magnet will have a constant magnetic field strength along the circular motion, And this design uses a “fast sensor switch” fixed near to every stator magnet and it uses also a “special electronic circuit” to (increase/decrease/reverse) the voltage required for (upper and/or lower) stator magnets that will (control/remove) the gravity effect of the mass for the second-half of circular motion
Brushless system for rotor magnet based on non-electric magnet: it uses a permanent magnet for the rotor part faces a variable field strength of stator electric magnets along the second-half of circular motion, it is a special design of rotor permanent magnet that facing variable magnetic field strength of stator magnets along the second-half of circular motion only just to remove the gravity effect, And this design uses a “fast sensor switch” fixed near to every stator magnet and it uses also a “special electronic circuit” to (increase/decrease/reverse) the voltage required for (upper and/or lower) stator magnets that will remove the gravity effect of the mass for the second-half of circular motion
Sensor switch: This is for brushless system, it is fixed near to every stator magnet to detect the position of the rotor magnet along the second-half of circular motion, and it will send a signal to a “special electronic circuit” when the rotor magnet nearly reach to the sensor switch position
Special electronic circuit: This is for brushless system; it will receive the signal from the sensor switch and it will decide which stator magnet to (turn ON/turn OFF/Increase voltage/Decrease voltage/Reverse voltage) according to that signal received and to the design required because several designs can be derived using this technique
Controller part: it contains (Starter switch and speed controller and system controller)
Starter switch: it has three modes (OFF/Batter or input source/WGM Source)
Speed controller: the speed controller will always read the speed of the gravity motor and then decide to increase or decrease the power input and voltage of the gravity motor
System controller it controls all gravity motors and electric generators (Manually and/or Automatically), a system controller controls the system (live and/or online) and it can be controlled remotely also to monitor everything online, the system controller also controls the position of every mass for every gravity motor in the system
Array: there are more than three types (one-dimensional array and two-dimensional array and three-dimensional array and more than three-dimensional array), for one dimensional array, there will be (x) number of gravity motors, all are connected to one main axle and they are facing each other (cascade), and the output is connected to electrical generator, and for the two-dimensional array, it will be (x, y) of gravity motors, the gravity motors are placed along (y) rows and (x) columns, they are not facing each other, For every row the output of every gravity motor (axle) is connected to the same row (axle) through special gears that can connect orthogonal axles together, Then the output of all row's axles is connected to one main Axle then the main axle is connected to electrical generator, and for the three-dimensional array, it will be (x, y, z) of gravity motors, it can be inside a building that have several floors, And every floor has several rows of rooms and every room have a gravity motor, Then the main output is connected to Electrical Generator to produce electricity needed by gravity force, And for more than three-dimensional array then just modifying the 3D array building by adding more than one gravity motor per room, This is just like merging several buildings of 3D Array together into one building, And it is possible to make for every room of three-dimensional array a one-dimensional array of gravity motors or more as required, because several designs can be derived using this technique.

2—The gravity motor of claim 1, wherein generates continuous mechanical power from gravitational force.

3—The gravity motor of claim 1, wherein maintains any level of generated mechanical power by gravitational force.

4—The gravity motor of claim 1, wherein generates mechanical power that when connected to electric generator it produces electricity.

5—The gravity motor of claim 1, wherein maintains any level of generated electrical power by gravitational force.

6—The gravity motor of claim 1, wherein generates mechanical power for when connecting the output gear to a larger gear it will provide more larger amount of torque using gravitational force.

7—The gravity motor of claim 1, wherein generates any required speed for when time increases the gravitational acceleration will increase the generated speed to the required limit.

8—The gravity motor of claim 1, wherein maintains any level of generated speed by gravitational force because the speed controller will control the generated speed by gravity.

9—The gravity motor of claim 1, wherein air friction is removed by two circular shape covers which can fit on each other for the rotor part to remove air friction with rotor parts.

10—The gravity motor of claim 1, wherein removes gravity effect on part of the circular motion path because it uses the new law in physics mentioned in claim 1 to generate mechanical power from gravitational force.

11—The gravity motor of claim 1, wherein can be divided into several smaller motors which can makes an array of one dimension or two or three or more than three dimensions of gravity motors.

12—The gravity motor of claim 1, wherein the mass position on the rotor arm can be controlled manually or by a motor to control the torque and inertia.

13—The gravity motor of claim 1, wherein the stator magnets have a variable number of coil-turn to remove gravity effect.

14—The gravity motor of claim 1, wherein the stator magnets have variable current to remove gravity effect.

15—The gravity motor of claim 1, wherein the rotor magnets has a constant current to remove gravity effect and it can have a variable current to remove gravity effect.

16—The gravity motor of claim 1, wherein the levers helps decrease the input power needed to remove gravity effect.

17—The gravity motor of claim 1, wherein provides a reliable and continuous renewable and clean energy.

18—A system controller comprising:
A controller to control all gravity motors in array, and controlling input power and output power and speed and mass position on every arm.

19—The system controller of claim 18, wherein monitors and controls all gravity motors (Live and/or Online).

20—The system controller of claim 18, wherein controls the position of every mass on every rotor arm for every gravity motor in the system.

21—The system controller of claim 18, wherein send alerts to system administrator and the management team and the working team.

22—The system controller of claim 18, wherein can be used remotely.

23—A “Theoretical Equivalence Theory” comprising:
New theory in physics: “In a field of force affecting on a mass fixed on rotor arm generating a Torque, it is possible to represent The Physical System by Theoretical Equivalent System using the same field of force to be the only force and with equal mass and equal Torque, and vice versa”.
Theoretical Equivalent System: is derived from the physical system in a field of force.
Field of force: the field of force affecting on the physical system and the theoretical equivalent system at the same time, so it will be possible to convert physical system to theoretical equivalent system and vice versa.
Applied force: the summation of the applied forces on the physical system to get one force on the theoretical equivalent system as a “Field of force”.
Torque: the torque of the theoretical equivalent system is equal to the torque of the physical system.
Mass: the mass of the theoretical equivalent system equal to the mass of the physical system.
Inertia: the inertia of the theoretical equivalent system is related to the inertia of the physical system.
Radius: the radius of the theoretical equivalent system is related to the radius of the physical system.
Angular acceleration: the angular acceleration of the theoretical Equivalent System is related to the angular acceleration of the physical system.
Angular velocity: the angular velocity of the theoretical equivalent system is related to the angular velocity of the physical system.
Linear acceleration: the linear acceleration of the theoretical equivalent system is related to the linear acceleration of the physical system.
Linear velocity: the linear velocity of the theoretical equivalent system is related to the linear velocity of the physical system.
Formulas used:
$${T}_{th} = T , {T}_{th} = {α}_{th} {I}_{th} , {α}_{th} = α \frac{I}{{I}_{th}} , {α}_{th} = {α [ \frac{( {F}_{f} - {F}_{x} )}{{F}_{f}} ]}^{- 2} , \\ {a}_{th} = {R}_{th} {α}_{th} , {a}_{th} = {a [ \frac{( {F}_{f} - {F}_{x} )}{{F}_{f}} ]}^{- 1} , {v}_{th} = {a}_{th} t , \\ {v}_{th} = {v [ \frac{( {F}_{f} - {F}_{x} )}{{F}_{f}} ]}^{- 1} , {ω}_{th} = {α}_{th} t , {ω}_{th} = {ω [ \frac{( {F}_{f} - {F}_{x} )}{{F}_{f}} ]}^{- 2} , \\ {F}_{x} = h {F}_{f} , ( 1 - h ) = [ \frac{( {F}_{f} - {F}_{x} )}{{F}_{f}} ] , {R}_{th} = R ( 1 - h ) , {I}_{th} = {I ( 1 - h )}^{2} , \\ {α}_{th} = {α ( 1 - h )}^{- 2} , {a}_{th} = {a ( 1 - h )}^{- 1} , {v}_{th} = {v ( 1 - h )}^{- 1} , \\ {ω}_{th} = {ω ( 1 - h )}^{- 2} ,$$
Where h=percentage of applied force “Fx”

24—The “Theoretical Equivalence Theory” of claim 23, wherein can convert any physical system in a field of force into theoretical equivalent system.

25—The “Theoretical Equivalence Theory” of claim 23, wherein can convert any theoretical system into a real equivalent system.
